(19) United States
(12) Patent Application Publication
(10) Pub. No.: US 2016/0028530 A1
(43) Pub. Date: Jan. 28, 2016

(54) Method and Device for Sending ePHICH, and Method and Device for Receiving ePHICH

(71) Applicant: ZTE CORPORATION, Shenzhen, Guangdong (CN)

(72) Inventors: Yuhong GONG, Shenzhen (CN); Yunfeng SUN, Shenzhen (CN); Bo DAI, Shenzhen (CN); Zhaohua LU, Shenzhen (CN); Zongwei HUANG, Shenzhen (CN)

(21) Appl. No.: 14/773,982

(22) PCT Filed: Oct. 10, 2013
(86) PCT No.: PCT/CN2013/084983

§ 371 Date: Sep. 9, 2015

(30) Foreign Application Priority Data
Jan. 18, 2013 (CN) 201310020134.5

(51) Int. Cl. H04L 5/00; H04L 1/18; H04L 27/26; H04W 72/04

(52) U.S. Cl. CPC H04L 5/0055; H04W 72/0453; H04L 5/0094; H04L 1/1861; H04L 27/26

(57) ABSTRACT

Disclosed are a method and device for sending an enhanced Physical Hybrid Automatic Repeat Request (ARQ) Indicator Channel (ePHICH) and a method and device for receiving the ePHICH. The method for sending the ePHICH includes: a part or all of Resource Elements (RE) of Physical Resource Block (PRB) pairs for sending the ePHICH are divided into N_{ePHICH}^{group} groups of ePHICH REs, wherein each group of ePHICH REs in the N_{ePHICH}^{group} groups of ePHICH REs includes N_{ePHICH}^{seq} ePHICH resources, and both N_{ePHICH}^{group} and N_{ePHICH}^{seq} are positive integers more than or equal to 1; and the ePHICH is sent on the ePHICH resources. By the present disclosure, uplink Acknowledgement/Non-acknowledgement (ACK/NACK) transmission performance is improved.

### TECHNICAL FIELD

The present disclosure relates to the field of communication, and including a method and device for sending an enhanced Physical Hybrid Automatic Repeat Request (ARQ) Indicator Channel (ePHICH) as well as a method and device for receiving an ePHICH.

### BACKGROUND

A Long Term Evolution (LTE) system is an important plan of the 3^{rd} Generation Partnership Project (3GPP). When a conventional Cyclic Prefix (CP) is applied in the LTE system, a timeslot includes 7 uplink/downlink symbols, and when an extended CP is applied in the LTE system, a timeslot includes 6 uplink/downlink symbols.

In an LTE system, the following physical channels are defined:

a Physical Broadcast Channel (PBCH): information born by the channel includes a frame number of the system, a downlink bandwidth of the system, a cycle of a Physical Hybrid ARQ Indicator Channel (PHICH) and a parameter N_{g} ε{⅙, ½, 1, 2} for determining the number of the channel groups of the PHICHs;

a Physical Multicast Channel (PMCH): mainly configured to support a Multicast Broadcast over Single Frequency Network (MBSFN) service and broadcast multimedia time-frequency information to multiple users, wherein the PMCH may transmit data only in an MBSFN sub-frame and an MBSFN area;

a Physical Downlink Shared Channel (PDSCH), configured to bear downlink transmitted data;

a Physical Downlink Control Channel (PDCCH), configured to bear uplink and downlink scheduling information and uplink power control information, wherein in R8, R9 and R10 of the LTE, PDCCHs are mainly distributed on the first 1 or 2 or 3 or 4 Orthogonal Frequency Division Multiplexing (OFDM) symbols of a sub-frame, and specific distribution is required to be configured according to different sub-frame types and the number of Common Reference Signal or Cell-specific Reference Signal (CRS) ports. As shown in Table 1, Table 1 shows the numbers of OFDM symbols occupied by PDCCHs configured according to different sub-frame types and the number of the CRS ports under the conditions that the number (N_{RB}^{DL}) of downlink Resource Blocks (RB)s is more than 10 and not more than 10 respectively;

TABLE 1
Numbers of Symbols Occupied by PDCCH

| | The number of | |
|---|---|---|
| | OFDM symbols | |
| | occupied by | The number of OFDM |
| | PDCCH under | symbols occupied by |
| | the condition of | PDCCH under the |
| Sub-frame | N_{RB}^{DL} >10 | condition of N_{RB}^{DL} ≦10 |
| Sub-frame 1 and | 1, 2 | 2 |
| sub-frame 6 in sub-frame | | |
| type 2 | | |
| MBSFN sub-frame on a | 1, 2 | 2 |
| carrier supporting a | | |
| PDSCH, CRS being | | |
| configured to occupy port | | |
| 1 or 2 | | |
| MBSFN sub-frame on a | 2 | 2 |
| carrier supporting a | | |
| PDSCH, CRS being | | |
| configured to occupy port 4 | | |
| Sub-frame on a carrier not | 0 | 0 |
| supporting PDSCH | | |
| transmission | | |
| Non-MBSFN sub-frame | 1, 2, 3 | 2, 3 |
| (except sub-frame 6 in | | |
| sub-frame structure type | | |
| 2) configured to be a | | |
| Position Reference Signal | | |
| (PRS) | | |
| All other conditions | 1, 2, 3 | 2, 3, 4 |

a Physical Control Format Indicator Channel (PCFICH): information born by the PCFICH is configured to indicate the number of OFDM symbols for transmitting a PDCCH in a sub-frame, and is sent on the first OFDM symbol of the sub-frame, and a frequency position of the PCFICH is determined by the downlink bandwidth of the system and a cell Identity (ID);

a PHICH: configured to bear Acknowledgement/Non-acknowledgement (ACK/NACK) feedback information of the uplink transmitted data, wherein the number and time-frequency positions of the PHICHs may be determined by a system message and the cell ID in a PBCH of a downlink carrier where the PHICHs are located; and

a Physical Uplink Shared Channel (PUSCH), configured to bear the uplink transmitted data.

In LTE, a CRS is adopted for pilot measurement and demodulation, that is, the CRS is applied to perform channel estimation for all users. When such a CRS is adopted, a sender needs to additionally notify a receiver a specific pre-processing manner adopted for sent data, and pilot overhead is higher. In addition, in Multi-User Multi-Input Multi-Output (MU-MIMO), the same CRS is applied for multiple terminals, and the achievement of pilot orthogonality is impossible, so that it is impossible to estimate interference. In Long Term Evolution-Advanced (LTE-A), in order to reduce the pilot overhead, two kinds of reference signals are defined respectively: a Demodulation Reference Signal (DMRS) and a Channel State Information Reference Signal (CSI-RS), wherein the DMRS is configured for the demodulation of a PDSCH. The CSI-RS for measuring the Channel State Information (CSI) is configured to report information such as a Channel Quality Indicator (CQI), a Precoding Matrix Indicator (PMI) and a Rank Indicator (RI).

FIG. 1 is a diagram of a Physical Resource Block (PRB) of an LTE system according to a related art. As shown in FIG. 1, a Resource Element (RE) is a subcarrier in an OFDM symbol, and a downlink RB comprises 12 continuous subcarriers and 7 (6 in case of an extended CP) continuous OFDM symbols. An RB is 180 kHz in the frequency domain, and is a time length of a timeslot in the time domain. During resource allocation, two RBs (also called a PRB pair) on a sub-frame (corresponding to two timeslots) are taken as a basic unit to perform the resource allocation. FIG. 2 is a diagram of a PRB pair of an LTE system according to the related art, and FIG. 2 further shows corresponding resource positions of a PDCCH, a CRS, a DMRS and the like.

In heterogeneous network of the LTE-A, there is a stronger interference between the different types of evolved NodeBs (eNodeB). Considering the interference between a macro eNodeB to a pico, a resource muting method is disclosed to solve the problem of interference between different types of eNodeBs. A specific resource muting method may be divided into a sub-frame-based muting method like an Almost Blank Subframe (ABS) muting method and an RE-based muting method like a CRS muting method. By the conventional resource muting method for solving the problem of interference between different types of eNodeBs, not only the resource waste is increased, but also scheduling is greatly limited, and particularly when the ABS configuration of the macro eNodeB is considered, when more picos are distributed, more ABSs are configured by the macro eNodeB, which causes greater influence on the macro eNodeB, increases resource waste and further prolongs a scheduling time delay; and moreover, although interference of different control channel data resources can be reduced under an ABS for a control channel, the problem of interference between a CRS resource and a data resource cannot be solved, and interference between data resources cannot be solved by the CRS muting method. In addition, the conventional methods are poor in backward compatibility, an access time delay is prolonged, and more standardization efforts may be needed.

In an LTE R11 stage, more users may be introduced to send data on an MBSFN sub-frame, which may cause insufficient capacity of a downlink control channel born by two OFDM symbols configured to an MBSFN, it is necessary to develop new resources for transmitting control information on PDSCH resources to ensure backward compatibility for R8/R9/R10 users, and moreover, a Coordinated Multiple Point Transmission and Reception (CoMP) technology is introduced in the R11 stage, and such a CoMP technology may solve the problem of interference between different types of cells in a space division manner, reduce resource overhead, avoid resource waste brought by the muting method and reduce limits to scheduling. However, by a conventional time-domain downlink control channel method, the problem cannot be solved in the space division manner.

In the LTE R11 stage, the PDCCH is enhanced, that is, a part of resources are divided from an original PDSCH area to transmit an enhanced Physical Downlink Control Channel (ePDCCH), therefore, the capacity of a PDCCH and the amount of user equipment which can be scheduled at the same time may be increased. Wherein the ePDCCH is form of an enhanced Control Channel Elements (eCCE), each eCCE is form of multiple enhanced Resource Element Groups (eREG), and each PRB pair allocated to the ePDCCH is divided into 16 eREGs.

In LTE R12, with the introduction of a New Carrier Type (NCT) and a small cell, a conventional PDCCH area will be excluded and physical downlink control signalling is transmitted based on an ePDCCH, which may cause the problem that a PHICH design in the related art cannot be applied to a new frame structure; and in addition, in a low cost Machine Type Communication (MTC), it is necessary to support a small-bandwidth receiving technology, but in the conventional time-domain downlink control channel method, the control channel information is discretely distributed on the full bandwidth, so that small-bandwidth reception cannot be well supported.

Therefore, for the capacity problem and interference problem of a conventional PHICH and the problem of inapplicability in a NCT and a low cost MTC scenario, it is necessary to take an ePHICH into consideration. At present, there are yet no effective solutions to a design problem on an ePHICH.

### SUMMARY

A method and device for sending an ePHICH, and a method and device for receiving an ePHICH are provided in the present disclosure, so as to at least solve a capacity problem and interference problem of a conventional PHICH, the problem of inapplicability in a NCT and a low cost MTC scenario and the problem of requirement on the consideration of an ePHICH in the related art.

According to one aspect of the present disclosure, a method for sending an enhanced Physical Hybrid Automatic Repeat Request (ARQ) Indicator Channel (ePHICH) is provided, comprising: dividing a part or all of Resource Elements (RE) of Physical Resource Block (PRB) pairs for sending the ePHICH into N_{ePHICH}^{group} groups of ePHICH REs, wherein each group of ePHICH REs in the N_{ePHICH}^{group} groups of ePHICH REs comprises N_{ePHICH}^{seq} ePHICH resources, and both N_{ePHICH}^{group} and N_{ePHICH}^{seq} are positive integers more than or equal to 1; and sending the ePHICH on the ePHICH resources.

In an example embodiment, dividing the part or all of the REs of the PRB pairs for sending the ePHICH into the N_{ePHICH}^{group} groups of ePHICH REs comprises: dividing a part or all of RE resources, except RE resources occupied by Demodulation Reference Signals (DMRS), in each PRB pair in the PRB pairs for sending the ePHICH into Np first enhanced Resource Element Groups (eREG) respectively; determining an ePHICH Resource Element Group (REG) in each PRB pair respectively, wherein the ePHICH REG comprises Nx time-domain adjacent or frequency-domain adjacent first eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1.

In an example embodiment, dividing the part or all of the REs of the PRB pairs for sending the ePHICH into the N_{ePHICH}^{group} groups of ePHICH REs comprises: dividing a part or all of RE resources, except RE resources occupied by DMRS, in each PRB pair in the PRB pairs for sending the ePHICH into Np second eREGs respectively; dividing each PRB pair in the PRB pairs for sending the ePHICH into multiple REG areas respectively, wherein each REG area in the multiple REG areas comprises one or more subcarriers on the frequency domain, and comprises one or more Orthogonal Frequency Division Multiplexing (OFDM) symbols on the time domain; determining an ePHICH REG of each REG area in the multiple REG areas respectively, wherein the ePHICH REG comprises Nx time-domain adjacent or frequency-domain adjacent second eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1.

In an example embodiment, dividing the part or all of the REs of the PRB pairs for sending the ePHICH into the N_{ePHICH}^{group} groups of ePHICH REs comprises: dividing a part or all of RE resources, except RE resources occupied by the DMRS, in each PRB pair in the PRB pairs for sending the ePHICH into Np third eREGs respectively, wherein each eREG in the Np third eREGs comprises Nr REs, and N REs in each eREG are configured for ePHICH transmission; determining an ePHICH REG in each PRB pair respectively, wherein the ePHICH REG comprises Nx time-domain adjacent or frequency-domain adjacent third eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1.

In an example embodiment, dividing the part or all of the REs of the PRB pairs for sending the ePHICH into the N_{ePHICH}^{group} groups of ePHICH REs comprises: dividing a part or all of RE resources, except RE resources occupied by DMRS, in each PRB pair in the PRB pairs for sending the ePHICH into Np fourth eREGs respectively, wherein each eREG in the Np fourth eREGs comprises Nr REs, and N REs in each eREG are configured for ePHICH transmission; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent fourth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1.

In an example embodiment, dividing the part or all of the REs of the PRB pairs for sending the ePHICH into the N_{ePHICH}^{group} groups of ePHICH REs comprises: dividing a part or all of RE resources, except RE resources occupied by DMRS, in each PRB pair in the PRB pairs for sending the ePHICH into Np fifth eREGs respectively, wherein M eREGs in the Np fifth eREGs are configured for ePHICH transmission; determining an ePHICH REG in each PRB pair respectively, wherein the ePHICH REG comprises Nx time-domain adjacent or frequency-domain adjacent fifth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1.

In an example embodiment, dividing the part or all of the REs of the PRB pairs for sending the ePHICH into the N_{ePHICH}^{group} groups of ePHICH REs comprises: dividing a part or all of RE resources, except RE resources occupied by the DMRS, in each PRB pair in the PRB pairs for sending the ePHICH into Np sixth eREGs respectively, wherein M eREGs in the Np sixth eREGs are configured for ePHICH transmission; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent sixth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1.

In an example embodiment, dividing the part or all of the REs of the PRB pairs for sending the ePHICH into the N_{ePHICH}^{group} groups of ePHICH REs comprises: dividing a part or all of RE resources, except RE resources occupied by DMRS, in each PRB pair in the PRB pairs for sending the ePHICH into Np seventh eREGs respectively, wherein M eREGs in the Np seventh eREGs are configured for ePHICH transmission, N REs comprised in each eREG in the M eREGs are configured for ePHICH transmission, and each eREG in the M eREGs comprises Nr REs; determining an ePHICH REG in each PRB pair respectively, wherein the ePHICH REG comprises Nx time-domain adjacent or frequency-domain adjacent seventh eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1.

In an example embodiment, dividing the part or all of the REs of the PRB pairs for sending the ePHICH into the N_{ePHICH}^{seq} groups of ePHICH REs comprises: dividing a part or all of RE resources, except RE resources occupied by DMRS, in each PRB pair in the PRB pairs for sending the ePHICH into Np eighth eREGs respectively, wherein M eREGs in the Np eighth eREGs are configured for ePHICH transmission, N REs comprised in each eREG in the M eREGs are configured for ePHICH transmission, and each eREG in the M eREGs comprises Nr REs; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent eighth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1.

In an example embodiment, N_{ePHICH}^{group} is acquired in one of manners as follows: N_{ePHICH}^{group} is preset by a network side and a terminal side; N_{ePHICH}^{group} is notified to the terminal side by the network side through higher-layer signalling; and N_{ePHICH}^{group} is determined through at least one of parameters as follows: a cell Identity (ID), the number of PRBs configured to the ePHICH, a sub-frame type, a sub-frame number and a Cyclic Prefix (CP) length.

In an example embodiment, resource configuration information of the PRB pairs for sending the ePHICH is notified to a terminal side through higher-layer signalling or physical-layer signalling; or the resource configuration information of the PRB pairs for sending the ePHICH is preset on a network side and a terminal side.

In an example embodiment, the resource configuration information comprises sub-frame resource information on the time domain and/or PRB indexes on the frequency domain.

In an example embodiment, the PRB pairs for sending the ePHICH comprise: a part or all of resources in PRB pairs configured for sending the ePHICH or for enhanced Physical Downlink Control Channel (ePDCCH) blind detection.

In an example embodiment, on the PRB pairs for sending the ePHICH, a Physical Downlink Shared Channel (PDSCH)/ePDCCH and the ePHICH are allowed to be multiplexed on the same PRB pairs by a rate matching manner.

In an example embodiment, N_{ePHICH}^{seq} is preset by a network side and a terminal side, an index value corresponding to each ePHICH resource in the N_{ePHICH}^{seq} ePHICH resources is n_{ePHICH}^{seq}, and n_{ePHICH}^{seq} ε[0, N_{ePHICH}^{seq}−1].

In an example embodiment, the N_{ePHICH}^{seq} resources are multiplexed on one group of ePHICH REs through N_{ePHICH}^{seq} different orthogonal sequences, wherein an index of an orthogonal sequence n_{ePHICH}^{seq}, and n_{ePHICH}^{seq} ε[0, N_{ePHICH}^{seq}−1].

In an example embodiment, the orthogonal sequences comprise orthogonal mask sequences.

In an example embodiment, a network side notifies a group index n_{ePHICH}^{group} and an intra-group sequence index n_{ePHICH}^{seq} corresponding to an ePHICH resource to a terminal side through a system message or a higher-layer signalling; or the network side indicates the group index n_{ePHICH}^{group} corresponding to the ePHICH resource to the terminal side through the system message or the higher-layer signalling, and indicates the intra-group sequence index n_{ePHICH}^{seq} to the terminal side through a physical-layer signalling; or the network side notifies the group index n_{ePHICH}^{group} and the intra-group sequence index n_{ePHICH}^{seq} to the terminal side through the physical-layer signalling; or the network side configures values of multiple sets of group index n_{ePHICH}^{group} and intra-group sequence index n_{ePHICH}^{seq} to the terminal side through the higher-layer signalling, and notifies one or more preset sets to the terminal side for ePHICH transmission through the physical-layer signalling.

In an example embodiment, a network side determines values of a group index n_{ePHICH}^{group} and an intra-group sequence index n_{ePHICH}^{seq} an ePHICH resource according to one or more of parameters as follows: a lowest PRB index of a Physical Uplink Shared Channel (PUSCH) responded by the ePHICH, a DRMS domain value in uplink authorization information of a Physical Downlink Control Channel (PDCCH) corresponding to the PUSCH responded by the ePHICH and a sub-frame where the PUSCH responded by the ePHICH is located.

In an example embodiment, dividing all the ePHICH REGs of the PRB pairs for sending the ePHICH into the N_{ePHICH}^{group} groups of ePHICH REs comprises one of: taking each ePHICH REG as one group of ePHICH REs; grouping every Ny REGs at preset positions in each ePHICH PRB pair in all the ePHICH REGs into one group of ePHICH REs; and grouping every Ny REGs belonging to multiple ePHICH PRB pairs at preset positions in all the ePHICH REGs into one group of ePHICH REs.

In an example embodiment, a value of Np is 16 or an integral multiple of 16, and a value of Nx is 2 or 4.

In an example embodiment, a value of N and a selection of the N REs are preset by a network side and a terminal side, or are determined according to at least one of parameters as follows: a sub-frame type, a CP length, the number of Common Reference Signal (CRS) ports and the number of PDCCH symbols.

According to the second aspect of the embodiment, a method for receiving an enhanced Physical Hybrid Automatic Repeat Request (ARQ) Indicator Channel (ePHICH) is provided, comprising: receiving resource indication information, configured by a network side, of Physical Resource Block (PRB) pairs for sending the ePHICH, wherein a part or all of Resource Elements (RE) of the PRB pairs for sending the ePHICH are divided into N_{ePHICH}^{group} groups of ePHICH REs, each group of ePHICH REs in the N_{ePHICH}^{group} groups of ePHICH REs comprises N_{ePHICH}^{seq} ePHICH resources, and both N_{ePHICH}^{group} and N_{ePHICH}^{seq} are positive integers more than or equal to 1; receiving group indexes and intra-group indexes, configured by the network side, of the ePHICH resources; or receiving information for determining the group indexes and the intra-group indexes of the ePHICH resources; determining, according to the group indexes and the intra-group indexes, the ePHICH resources for sending the ePHICH on resources indicated by the resource indication information; and receiving the ePHICH on the ePHICH resources.

In an example embodiment, determining, according to the group indexes and the intra-group indexes, the ePHICH resources for sending the ePHICH on the resources indicated by the resource indication information comprises: dividing a part or all of the REs of the PRB pairs for sending the ePHICH into the N_{ePHICH}^{group} groups of ePHICH REs according to the resource indication information; wherein each group of ePHICH REs in the N_{ePHICH}^{group} groups of ePHICH REs determined according to the resource indication information comprises N_{ePHICH}^{seq} ePHICH resources; and determining the ePHICH resources for sending the ePHICH on the N_{ePHICH}^{group} groups of ePHICH REs according to the group indexes and the intra-group indexes.

In an example embodiment, dividing the part or all of the REs of the PRB pairs for sending the ePHICH into the N_{ePHICH}^{group} groups of ePHICH REs according to the resource indication information comprises: dividing a part or all of RE resources, except RE resources occupied by Demodulation Reference Signals (DMRS), in each PRB pair in the PRB pairs for sending the ePHICH into Np first enhanced Resource Element Groups (eREG) respectively; determining an ePHICH Resource Element Group (REG) in each PRB pair respectively, wherein the ePHICH REG comprises Nx time-domain adjacent or frequency-domain adjacent first eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1.

In an example embodiment, dividing the part or all of the REs of the PRB pairs for sending the ePHICH into the N_{ePHICH}^{group} groups of ePHICH REs according to the resource indication information comprises: dividing a part or all of RE resources, except RE resources occupied by DMRS, in each PRB pair in the PRB pairs for sending the ePHICH into Np second eREGs respectively; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent second eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1.

In an example embodiment, dividing the part or all of the REs of the PRB pairs for sending the ePHICH into the N_{ePHICH}^{group} groups of ePHICH REs according to the resource indication information comprises: dividing a part or all of RE resources, except RE resources occupied by DMRS, in each PRB pair in the PRB pairs for sending the ePHICH into Np third eREGs respectively, wherein each eREG in the Np third eREGs comprises Nr REs, and N REs in each eREG are configured for ePHICH transmission; determining an ePHICH REG in each PRB pair respectively, wherein the ePHICH REG comprises Nx time-domain adjacent or frequency-domain adjacent third eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1.

In an example embodiment, dividing the part or all of the REs of the PRB pairs for sending the ePHICH into the N_{ePHICH}^{group} groups of ePHICH REs according to the resource indication information comprises: dividing a part or all of RE resources, except RE resources occupied by DMRS, in each PRB pair in the PRB pairs for sending the ePHICH into Np fourth eREGs respectively, wherein each eREG in the Np fourth eREGs comprises Nr REs, and N REs in each eREG are configured for ePHICH transmission; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent fourth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1.

In an example embodiment, dividing the part or all of the REs of the PRB pairs for sending the ePHICH into the N_{ePHICH}^{group} groups of ePHICH REs according to the resource indication information comprises: dividing a part or all of RE resources, except RE resources occupied by DMRS, in each PRB pair in the PRB pairs for sending the ePHICH into Np fifth eREGs respectively, wherein M eREGs in the Np fifth eREGs are configured for ePHICH transmission; determining an ePHICH REG in each PRB pair respectively, wherein the ePHICH REG comprises Nx time-domain adjacent or frequency-domain adjacent fifth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1.

In an example embodiment, dividing the part or all of the REs of the PRB pairs for sending the ePHICH into the N_{ePHICH}^{group} groups of ePHICH REs according to the resource indication information comprises: dividing a part or all of RE resources, except RE resources occupied by DMRS, in each PRB pair in the PRB pairs for sending the ePHICH into Np sixth eREGs respectively, wherein M eREGs in the Np sixth eREGs are configured for ePHICH transmission; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent sixth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1.

In an example embodiment, dividing the part or all of the REs of the PRB pairs for sending the ePHICH into the N_{ePHICH}^{group} groups of ePHICH REs according to the resource indication information comprises: dividing a part or all of RE resources, except RE resources occupied by DMRS, in each PRB pair in the PRB pairs for sending the ePHICH into Np seventh eREGs respectively, wherein M eREGs in the Np seventh eREGs are configured for ePHICH transmission, N REs comprised in each eREG in the M eREGs are configured for ePHICH transmission, and each eREG in the M eREGs comprises Nr REs; determining an ePHICH REG in each PRB pair respectively, wherein the ePHICH REG comprises Nx time-domain adjacent or frequency-domain adjacent seventh eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1.

In an example embodiment, dividing the part or all of the REs of the PRB pairs for sending the ePHICH into the N_{ePHICH}^{group} groups of ePHICH REs according to the resource indication information comprises: dividing a part or all of RE resources, except RE resources occupied by DMRS, in each PRB pair in the PRB pairs for sending the ePHICH into Np eighth eREGs respectively, wherein M eREGs in the Np eighth eREGs are configured for ePHICH transmission, N REs comprised in each eREG in the M eREGs are configured for ePHICH transmission, and each eREG in the M eREGs comprises Nr REs; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent eighth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1.

In an example embodiment, N_{ePHICH}^{group} is acquired in one of manners as follows: N_{ePHICH}^{group} is preset by the network side and a terminal side; N_{ePHICH}^{group} is notified to the terminal side by the network side through higher-layer signalling; and N_{ePHICH}^{group} is determined through at least one of parameters as follows: a cell Identity (ID), the number of PRBs configured to the ePHICH, a sub-frame type, a sub-frame number and a Cyclic Prefix (CP) length.

In an example embodiment, resource configuration information of the PRB pairs for sending the ePHICH is notified to a terminal side through higher-layer signalling or physical-layer signalling; or the resource configuration information of the PRB pairs for sending the ePHICH is preset on a network side and a terminal side.

In an example embodiment, the resource configuration information comprises sub-frame resource information on the time domain and/or PRB indexes on the frequency domain.

In an example embodiment, the PRB pairs for sending the ePHICH comprise: a part or all of resources in PRB pairs configured for sending the ePHICH or for enhanced Physical Downlink Control Channel (ePDCCH) blind detection.

In an example embodiment, on the PRB pairs for sending the ePHICH, a Physical Downlink Shared Channel (PDSCH)/ePDCCH and the ePHICH are allowed to be multiplexed on the same PRB pairs by a rate matching manner.

In an example embodiment, N_{ePHICH}^{seq} is preset by a network side and a terminal side, an index value corresponding to each ePHICH resource in the N_{ePHICH}^{seq} ePHICH resources n_{ePHICH}^{seq}, and n_{ePHICH}^{seq} ε[0, N_{ePHICH}^{seq}−1].

In an example embodiment, the N_{ePHICH}^{seq} resources are multiplexed on one group of ePHICH REs through N_{ePHICH}^{seq} ePHICH different orthogonal sequences, wherein an index of an orthogonal sequence is n_{ePHICH}^{seq}, and n_{ePHICH}^{seq} ε[0, N_{ePHICH}^{seq}−1].

In an example embodiment, the orthogonal sequences comprise orthogonal mask sequences.

In an example embodiment, a network side notifies a group index n_{ePHICH}^{group} and an intra-group sequence index n_{ePHICH}^{seq} corresponding to an ePHICH resource to a terminal side through a system message or a higher-layer signalling; or the network side indicates the group index n_{ePHICH}^{group} corresponding to the ePHICH resource to the terminal side through the system message or the higher-layer signalling, and indicates the intra-group sequence index n_{ePHICH}^{seq} to the terminal side through a physical-layer signalling; or the network side notifies the group index n_{ePHICH}^{group} and the intra-group sequence index n_{ePHICH}^{group} to the terminal side through the physical-layer signalling; or the network side configures values of multiple sets of group index n_{ePHICH}^{group} and intra-group sequence index n_{ePHICH}^{seq} to the terminal side through the higher-layer signalling, and notifies one or more preset sets to the terminal side for ePHICH transmission through the physical-layer signalling.

In an example embodiment, a network side determines the values of a group index n_{ePHICH}^{group} and an intra-group sequence index n_{ePHICH}^{seq} of an ePHICH resource according to one or more of parameters as follows: a lowest PRB index of a Physical Uplink Shared Channel (PUSCH) responded by the ePHICH, a DRMS domain value in uplink authorization information of a Physical Downlink Control Channel (PDCCH) corresponding to the PUSCH responded by the ePHICH and a sub-frame where the PUSCH responded by the ePHICH is located.

In an example embodiment, dividing all the ePHICH REGs of the PRB pairs for sending the ePHICH into the N_{ePHICH}^{group} groups of ePHICH REs according to the resource indication information comprises one of: taking each ePHICH REG as one group of ePHICH REs; grouping every Ny REGs at preset positions in each ePHICH PRB pair in all the ePHICH REGs into one group of ePHICH REs; and grouping every Ny REGs belonging to multiple ePHICH PRB pairs at preset positions in all the ePHICH REGs into one group of ePHICH REs.

In an example embodiment, a value of Np is 16 or an integral multiple of 16, and a value of Nx is 2 or 4.

In an example embodiment, wherein a value of N and a selection of the N REs are preset by a network side and a terminal side, or are determined according to at least one of parameters as follows: a sub-frame type, a CP length, the number of Common Reference Signal (CRS) ports and the number of PDCCH symbols.

According to a third aspect of the embodiment, a device for sending an enhanced Physical Hybrid Automatic Repeat Request (ARQ) Indicator Channel (ePHICH) is provided, comprising: a first dividing component, configured to divide a part or all of Resource Elements (RE) of Physical Resource Block (PRB) pairs for sending the ePHICH into N_{ePHICH}^{group} groups of ePHICH REs, wherein each group of ePHICH REs in the N_{ePHICH}^{group} groups of ePHICH REs comprises N_{ePHICH}^{seq} ePHICH group seq resources, and both N_{ePHICH}^{group} and N_{ePHICH}^{seq} are positive integers more than or equal to 1; and a sending component, configured to send the ePHICH on the ePHICH resources.

In an example embodiment, the first dividing component comprises one of component combinations as follows: a first component combination: a second dividing component, configured to divide a part or all of RE resources, except RE resources occupied by Demodulation Reference Signals (DMRS), in each PRB pair in the PRB pairs for sending the ePHICH into Np first enhanced Resource Element Groups (eREG) respectively; a first determining component, configured to determine an ePHICH Resource Element Group (REG) in each PRB pair respectively, wherein the ePHICH REG comprises Nx time-domain adjacent or frequency-domain adjacent first eREGs; a third dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1; a second component combination: a fourth dividing component, configured to divide a part or all of RE resources, except RE resources occupied by DMRS, in each PRB pair in the PRB pairs for sending the ePHICH into Np second eREGs respectively; a fifth dividing component, configured to divide each PRB pair in the PRB pairs for sending the ePHICH into multiple REG areas respectively, wherein each REG area in the multiple REG areas comprises one or more subcarriers on the frequency domain, and comprises one or more Orthogonal Frequency Division Multiplexing (OFDM) symbols on the time domain; a second determining component, configured to determine an ePHICH REG of each REG area in the multiple REG areas respectively, wherein the ePHICH REG comprises Nx time-domain adjacent or frequency-domain adjacent second eREGs; a sixth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1; a third component combination: a seventh dividing component, configured to divide a part or all of RE resources, except RE resources occupied by DMRS, in each PRB pair in the PRB pairs for sending the ePHICH into Np third eREGs respectively, wherein each eREG in the Np third eREGs comprises Nr REs, and N REs in each eREG are configured for ePHICH transmission; a third determining component, configured to determine an ePHICH REG in each PRB pair respectively, wherein the ePHICH REG comprises Nx time-domain adjacent or frequency-domain adjacent third eREGs; an eighth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1; a fourth component combination: a ninth dividing component, configured to divide a part or all of RE resources, except RE resources occupied by DMRS, in each PRB pair in the PRB pairs for sending the ePHICH into Np fourth eREGs respectively, wherein each eREG in the Np fourth eREGs comprises Nr REs, and N REs in each eREG are configured for ePHICH transmission; a tenth dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a fourth determining component, configured to determine an ePHICH REG of each REG area in the multiple REG areas respectively, wherein the ePHICH REG comprises Nx time-domain adjacent or frequency-domain adjacent fourth eREGs; an eleventh dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1; a fifth component combination: a twelfth dividing component, configured to divide a part or all of RE resources, except RE resources occupied by DMRS, in each PRB pair in the PRB pairs for sending the ePHICH into Np fifth eREGs respectively, wherein M eREGs in the Np fifth eREGs are configured for ePHICH transmission; a fifth determining component, configured to determine an ePHICH REG in each PRB pair respectively, wherein the ePHICH REG comprises Nx time-domain adjacent or frequency-domain adjacent fifth eREGs; a thirteenth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1; a sixth component combination: a fourteenth dividing component, configured to divide a part or all of RE resources, except RE resources occupied by DMRS, in each PRB pair in the PRB pairs for sending the ePHICH into Np sixth eREGs respectively, wherein M eREGs in the Np sixth eREGs are configured for ePHICH transmission; a fifteenth dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a sixth determining component, configured to determine an ePHICH REG of each REG area in the multiple REG areas respectively, wherein the ePHICH REG comprises Nx time-domain adjacent or frequency-domain adjacent sixth eREGs; a sixteenth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1; a seventh component combination: a seventeenth dividing component, configured to divide a part or all of RE resources, except RE resources occupied by DMRS, in each PRB pair in the PRB pairs for sending the ePHICH into Np seventh eREGs respectively, wherein M eREGs in the Np seventh eREGs are configured for ePHICH transmission, N REs comprised in each eREG in the M eREGs are configured for ePHICH transmission, and each eREG in the M eREGs comprises Nr REs; a seventh determining component, configured to determine an ePHICH REG in each PRB pair respectively, wherein the ePHICH REG comprises Nx time-domain adjacent or frequency-domain adjacent seventh eREGs; an eighteenth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1; an eighth component combination: a nineteenth dividing component, configured to divide a part or all of RE resources, except RE resources occupied by DMRS, in each PRB pair in the PRB pairs for sending the ePHICH into Np eighth eREGs respectively, wherein M eREGs in the Np eighth eREGs are configured for ePHICH transmission, N REs comprised in each eREG in the M eREGs are configured for ePHICH transmission, and each eREG in the M eREGs comprises Nr REs; a twentieth dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; an eighth determining component, configured to determine an ePHICH REG of each REG area in the multiple REG areas respectively, wherein the ePHICH REG comprises Nx time-domain adjacent or frequency-domain adjacent eighth eREGs; and a twenty-first dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1.

In an example embodiment, N_{ePHICH}^{group} is acquired in one of manners as follows: N_{ePHICH}^{group} is preset by a network side and a terminal side; N_{ePHICH}^{group} is notified to the terminal side by the network side through higher-layer signalling; and N_{ePHICH}^{group} is determined through at least one of parameters as follows: a cell Identity (ID), the number of PRBs configured to the ePHICH, a sub-frame type, a sub-frame number and a Cyclic Prefix (CP) length.

In an example embodiment, resource configuration information of the PRB pairs for sending the ePHICH is notified to a terminal side through higher-layer signalling or physical-layer signalling; or the resource configuration information of the PRB pairs for sending the ePHICH is preset on a network side and a terminal side.

In an example embodiment, the resource configuration information comprises sub-frame resource information on the time domain and/or PRB indexes on the frequency domain.

In an example embodiment, the PRB pairs for sending the ePHICH comprise: a part or all of resources in PRB pairs configured for sending the ePHICH or for enhanced Physical Downlink Control Channel (ePDCCH) blind detection.

In an example embodiment, on the PRB pairs for sending the ePHICH, a Physical Downlink Shared Channel (PDSCH)/ePDCCH and the ePHICH are allowed to be multiplexed on the same PRB pairs by a rate matching manner.

In an example embodiment, N_{ePHICH}^{seq} is preset by a network side and a terminal side, an index value corresponding to each ePHICH resource in the N_{ePHICH}^{seq} ePHICH resources is n_{ePHICH}^{seq}, and n_{ePHICH}^{seq} ε[0, N_{ePHICH}^{seq}−1].

In an example embodiment, the N_{ePHICH}^{seq} ePHICH resources are multiplexed on one group of ePHICH REs through N_{ePHICH}^{seq} different orthogonal sequences, wherein an index of an orthogonal sequence is n_{ePHICH}^{seq} and n_{ePHICH}^{seq} ε[0, N_{ePHICH}^{seq}−1].

In an example embodiment, the orthogonal sequences comprise orthogonal mask sequences.

In an example embodiment, a network side notifies a group index n_{ePHICH}^{group} and an intra-group sequence index n_{ePHICH}^{seq} corresponding to an ePHICH resource to a terminal side through a system message or a higher-layer signalling; or the network side indicates the group index n_{ePHICH}^{group} corresponding to the ePHICH resource to the terminal side through the system message or the higher-layer signalling, and indicates the intra-group sequence n_{ePHICH}^{group} to the terminal side through a physical-layer signalling; or the network side notifies the group index n_{ePHICH}^{group} and the intra-group sequence n_{ePHICH}^{seq} to the terminal side through the physical-layer signalling; or the network side configures values of multiple sets of group index n_{ePHICH}^{group} and intra-group sequence index n_{ePHICH}^{group} to the terminal side through the higher-layer signalling, and notifies one or more preset sets to the terminal side for ePHICH transmission through the physical-layer signalling.

In an example embodiment, a network side determines values of a group index and an intra-group sequence index n_{ePHICH}^{seq} of an ePHICH resource n_{ePHICH}^{group} according to one or more of parameters as follows: a lowest PRB index of a Physical Uplink Shared Channel (PUSCH) responded by the ePHICH, a DRMS domain value in uplink authorization information of a Physical Downlink Control Channel (PDCCH) corresponding to the PUSCH responded by the ePHICH and a sub-frame where the PUSCH responded by the ePHICH is located.

In an example embodiment, the third dividing component, the sixth dividing component, the eighth dividing component, the eleventh dividing component, the thirteenth dividing component, the sixteenth dividing component, the eighteenth dividing component and the twenty-first dividing component are configured to divide all the ePHICH REGs of the PRB pairs for sending the ePHICH into the N_{ePHICH}^{group} groups of ePHICH REs by one of: taking each ePHICH REG as one group of ePHICH REs; grouping every Ny REGs at preset positions in each ePHICH PRB pair in all the ePHICH REGs into one group of ePHICH REs; and grouping every Ny REGs belonging to multiple ePHICH PRB pairs at preset positions in all the ePHICH REGs into one group of ePHICH REs.

In an example embodiment, a value of Np is 16 or an integral multiple of 16, and a value of Nx is 2 or 4.

In an example embodiment, a value of N and a selection of the N REs are preset by a network side and a terminal side, or are determined according to at least one of parameters as follows: a sub-frame type, a CP length, the number of Common Reference Signal (CRS) ports and the number of PDCCH symbols.

According to the fourth aspect of the embodiment, the device for receiving an enhanced Physical Hybrid Automatic Repeat Request (ARQ) Indicator Channel (ePHICH) is provided, comprising: a first receiving component, configured to receive resource indication information, configured by a network side, of Physical Resource Block (PRB) pairs for sending the ePHICH, wherein a part or all of Resource Elements (RE) of the PRB pairs for sending the ePHICH are divided into N_{ePHICH}^{group} groups of ePHICH REs, each group of ePHICH REs in the N_{ePHICH}^{group} groups of ePHICH REs comprises N_{ePHICH}^{seq} resources, and both N_{ePHICH}^{group} and N_{ePHICH}^{group} are positive integers more than or equal to 1; a second receiving component, configured to receive group indexes and intra-group indexes, configured by the network side, of the ePHICH resources; or receive information for determining the group indexes and the intra-group indexes of the ePHICH resources; a ninth determining component, configured to determine, according to the group indexes and the intra-group indexes, the ePHICH resources for sending the ePHICH on resources indicated by the resource indication information; and a third receiving component, configured to receive the ePHICH on the ePHICH resources.

In an example embodiment, the ninth determining component comprises: a twenty-second dividing component, configured to divide a part or all of the REs of the PRB pairs for sending the ePHICH into the N_{ePHICH}^{group} groups of ePHICH REs according to the resource indication information; a tenth determining component, configured to determine, according to the resource indication information, that each group of ePHICH REs in the N_{ePHICH}^{group} groups of ePHICH REs comprises N_{ePHICH}^{seq} ePHICH resources; and an eleventh determining component, configured to determine the ePHICH resources for sending the ePHICH on the N_{ePHICH}^{group} groups of ePHICH REs according to the group indexes and the intra-group indexes.

In an example embodiment, the twenty-second dividing component comprises one of component combinations as follows: a first component combination: a twenty-third dividing component, configured to divide a part or all of RE resources, except RE resources occupied by Demodulation Reference Signals (DMRS), in each PRB pair in the PRB pairs for sending the ePHICH into Np first enhanced Resource Element Groups (eREG) respectively; a twelfth determining component, configured to determine an ePHICH Resource Element Group (REG) in each PRB pair respectively, wherein the ePHICH REG comprises Nx time-domain adjacent or frequency-domain adjacent first eREGs; a twenty-fourth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1; a second component combination: a twenty-fifth dividing component, configured to divide a part or all of RE resources, except RE resources occupied by DMRS, in each PRB pair in the PRB pairs for sending the ePHICH into Np second eREGs respectively; a twenty-sixth dividing component, configured to divide each PRB pair in the PRB pairs for sending the ePHICH into multiple REG areas respectively, wherein each REG area in the multiple REG areas comprises one or more subcarriers on the frequency domain, and comprises one or more Orthogonal Frequency Division Multiplexing (OFDM) symbols on the time domain; a thirteenth determining component, configured to determine an ePHICH REG of each REG area in the multiple REG areas respectively, wherein the ePHICH REG comprises Nx time-domain adjacent or frequency-domain adjacent second eREGs; a twenty-seventh dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1; a third component combination: a twenty-eighth dividing component, configured to divide a part or all of RE resources, except RE resources occupied by DMRS, in each PRB pair in the PRB pairs for sending the ePHICH into Np third eREGs respectively, wherein each eREG in the Np third eREGs comprises Nr REs, and N REs in each eREG are configured for ePHICH transmission; a fourteenth determining component, configured to determine an ePHICH REG in each PRB pair respectively, wherein the ePHICH REG comprises Nx time-domain adjacent or frequency-domain adjacent third eREGs; a twenty-ninth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1; a fourth component combination: a thirtieth dividing component, configured to divide a part or all of RE resources, except RE resources occupied by DMRS, in each PRB pair in the PRB pairs for sending the ePHICH into Np fourth eREGs respectively, wherein each eREG in the Np fourth eREGs comprises Nr REs, and N REs in each eREG are configured for ePHICH transmission; a thirty-first dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a fifteenth determining component, configured to determine an ePHICH REG of each REG area in the multiple REG areas respectively, wherein the ePHICH REG comprises Nx time-domain adjacent or frequency-domain adjacent fourth eREGs; a thirty-second dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1; a fifth component combination: a thirty-third dividing component, configured to divide a part or all of RE resources, except RE resources occupied by DMRS, in each PRB pair in the PRB pairs for sending the ePHICH into Np fifth eREGs respectively, wherein M eREGs in the Np fifth eREGs are configured for ePHICH transmission; a sixteenth determining component, configured to determine an ePHICH REG in each PRB pair respectively, wherein the ePHICH REG comprises Nx time-domain adjacent or frequency-domain adjacent fifth eREGs; a thirty-fourth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1; a sixth component combination: a thirty-fifth dividing component, configured to divide a part or all of RE resources, except RE resources occupied by DMRS, in each PRB pair in the PRB pairs for sending the ePHICH into Np sixth eREGs respectively, wherein M eREGs in the Np sixth eREGs are configured for ePHICH transmission; a thirty-sixth dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a seventeenth determining component, configured to determine an ePHICH REG of each REG area in the multiple REG areas respectively, wherein the ePHICH REG comprises Nx time-domain adjacent or frequency-domain adjacent sixth eREGs; a thirty-seventh dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1; a seventh component combination: a thirty-eighth dividing component, configured to divide a part or all of RE resources, except RE resources occupied by DMRS, in each PRB pair in the PRB pairs for sending the ePHICH into Np seventh eREGs respectively, wherein M eREGs in the Np seventh eREGs are configured for ePHICH transmission, N REs comprised in each eREG in the M eREGs are configured for ePHICH transmission, and each eREG in the M eREGs comprises Nr REs; an eighteenth determining component, configured to determine an ePHICH REG in each PRB pair respectively, wherein the ePHICH REG comprises Nx time-domain adjacent or frequency-domain adjacent seventh eREGs; a thirty-ninth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} ePHICH groups of ePHICH REs comprises one or more ePHICH REGs, M is less than Np, N is less than Nr, all of M, Np, N and Nr are integers more than 1, and Nx is an integer more than or equal to 1; an eighth component combination: a fortieth dividing component, configured to divide a part or all of RE resources, except RE resources occupied by DMRS, in each PRB pair in the PRB pairs for sending the ePHICH into Np eighth eREGs respectively, wherein M eREGs in the Np eighth eREGs are configured for ePHICH transmission, N REs comprised in each eREG in the M eREGs are configured for ePHICH transmission, and each eREG in the M eREGs comprises Nr REs; a forty-first dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a nineteenth determining component, configured to determine an ePHICH REG of each REG area in the multiple REG areas respectively, wherein the ePHICH REG comprises Nx time-domain adjacent or frequency-domain adjacent eighth eREGs; and a forty-second dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1.

In an example embodiment, N_{ePHICH}^{group} is acquired in one of manners as follows: N_{ePHICH}^{group} is preset by the network side and a terminal side; N_{ePHICH}^{group} is notified to the terminal side by the network side through higher-layer signalling; and N_{ePHICH}^{seq} is determined through at least one of parameters as follows: a cell Identity (ID), the number of PRBs configured to the ePHICH, a sub-frame type, a sub-frame number and a Cyclic Prefix (CP) length.

In an example embodiment, resource configuration information of the PRB pairs for sending the ePHICH is notified to a terminal side through higher-layer signalling or physical-layer signalling; or the resource configuration information of the PRB pairs for sending the ePHICH is preset on a network side and a terminal side.

In an example embodiment, the resource configuration information comprises sub-frame resource information on the time domain and/or PRB indexes on the frequency domain.

In an example embodiment, the PRB pairs for sending the ePHICH comprise: a part or all of resources in PRB pairs configured for sending the ePHICH or for enhanced Physical Downlink Control Channel (ePDCCH) blind detection.

In an example embodiment, on the PRB pairs for sending the ePHICH, a Physical Downlink Shared Channel (PDSCH)/ePDCCH and the ePHICH are allowed to be multiplexed on the same PRB pairs by a rate matching manner.

In an example embodiment, N_{ePHICH}^{seq} is preset by a network side and a terminal side, an index value corresponding to each ePHICH resource in the N_{ePHICH}^{seq} ePHICH resources is n_{ePHICH}^{seq}, and n_{ePHICH}^{seq} ε[0, N_{ePHICH}^{seq}−1].

In an example embodiment, the N_{ePHICH}^{seq} resources are multiplexed on one group of ePHICH REs through N_{ePHICH}^{seq} ePHICH different orthogonal sequences, wherein an index of an orthogonal sequence is n_{ePHICH}^{seq} and n_{ePHICH}^{seq} ε[0, N_{ePHICH}^{seq}−1].

In an example embodiment, the orthogonal sequences comprise orthogonal mask sequences.

In an example embodiment, a network side notifies a group index n_{ePHICH}^{group} and an intra-group sequence index n_{ePHICH}^{seq} corresponding to an ePHICH resource to a terminal side through a system message or a higher-layer signalling; or the network side indicates the group index n_{ePHICH}^{group} corresponding to the ePHICH resource to the terminal side through the system message or the higher-layer signalling, and indicates the intra-group sequence index n_{ePHICH}^{seq} to the terminal side through a physical-layer signalling; or the network side notifies the group index n_{ePHICH}^{group} group and the intra-group sequence index n_{ePHICH}^{seq} to the terminal side through the physical-layer signalling; or the network side configures values of multiple sets of group index n_{ePHICH}^{group} and intra-group sequence index n_{ePHICH}^{seq} to the terminal side through the higher-layer signalling, and notifies one or more preset sets to the terminal side for ePHICH transmission through the physical-layer signalling.

In an example embodiment, a network side determines the values of a group index n_{ePHICH}^{group} and an intra-group sequence index n_{ePHICH}^{seq} of an ePHICH resource according to one or more of parameters as follows: a lowest PRB index of a Physical Uplink Shared Channel (PUSCH) responded by the ePHICH, a DRMS domain value in uplink authorization information of a Physical Downlink Control Channel (PDCCH) corresponding to the PUSCH responded by the ePHICH and a sub-frame where the PUSCH responded by the ePHICH is located.

In an example embodiment, the twenty-fourth dividing component, the twenty-seventh dividing component, the twenty-ninth dividing component, the thirty-second dividing component, the thirty-fourth dividing component, the thirty-seventh dividing component, the thirty-ninth dividing component and the forty-second dividing component are configured to divide all the ePHICH REGs of the PRB pairs for sending the ePHICH into the N_{ePHICH}^{group} groups of ePHICH REs according to the resource indication information by one of: taking each ePHICH REG as one group of ePHICH REs; grouping every Ny REGs at preset positions in each ePHICH PRB pair in all the ePHICH REGs into one group of ePHICH REs; and grouping every Ny REGs belonging to multiple ePHICH PRB pairs at preset positions in all the ePHICH REGs into one group of ePHICH REs.

In an example embodiment, Np is 16 or an integral multiple of 16, and Nx is 2 or 4.

In an example embodiment, a value of N and a selection of the N REs are preset by a network side and a terminal side, or are determined according to at least one of parameters as follows: a sub-frame type, a CP length, the number of Common Reference Signal (CRS) ports and the number of PDCCH symbols.

According to the present disclosure, a part or all of the REs of the PRB pairs for sending the ePHICH are divided into the N_{ePHICH}^{group} groups of ePHICH REs, wherein each group of ePHICH REs in the N_{ePHICH}^{group} groups of ePHICH REs includes N_{ePHICH}^{seq} ePHICH resources, and both N_{ePHICH}^{group} and N_{ePHICH}^{seq} are positive integers more than or equal to 1; and then the ePHICH is transmitted on the ePHICH resources. Therefore, the capacity problem and interference problem of the conventional PHICH, the problem of inapplicability in the NCT and the low cost MTC scenario and the problem of requirement on the consideration of the ePHICH in the related art are solved, and the effect of improving uplink ACK/NACK information transmission performance is further achieved.

### BRIEF DESCRIPTION OF THE DRAWINGS

The drawings described here are adopted to provide further understanding of the present disclosure, and form a part of the present disclosure. Schematic embodiments of the present disclosure and description thereof are adopted to explain the present disclosure and not intended to form improper limits to the present disclosure. In the drawings:

FIG. 1 is a diagram of a PRB in a related art;

FIG. 2 is a diagram of a PRB pair in a related art;

FIG. 3 is a flowchart of a method for sending an ePHICH according to an embodiment of the present disclosure;

FIG. 4 is a flowchart of a method for receiving an ePHICH according to an embodiment of the present disclosure;

FIG. 5 is a structure diagram of a device for sending an ePHICH according to an embodiment of the present disclosure;

FIG. 6 is an example structure diagram of the device for sending the ePHICH according to an embodiment of the present disclosure;

FIG. 7 is a structure diagram of a device for receiving an ePHICH according to an embodiment of the present disclosure;

FIG. 8 is an example structure diagram of the device for receiving the ePHICH according to an embodiment of the present disclosure;

FIG. 9 is a diagram of division of eREGs of ePHICH PRB pairs according to an embodiment of the present disclosure;

FIG. 10 is a first diagram of division of an ePHICH PRB pair into two REG areas on the frequency domain according to an embodiment of the present disclosure;

FIG. 11 is a second diagram of division of an ePHICH PRB pair into two REG areas on the time domain according to an embodiment of the present disclosure; and

FIG. 12 is a third diagram of division of an ePHICH PRB pair into two REG areas on the time domain according to an embodiment of the present disclosure.

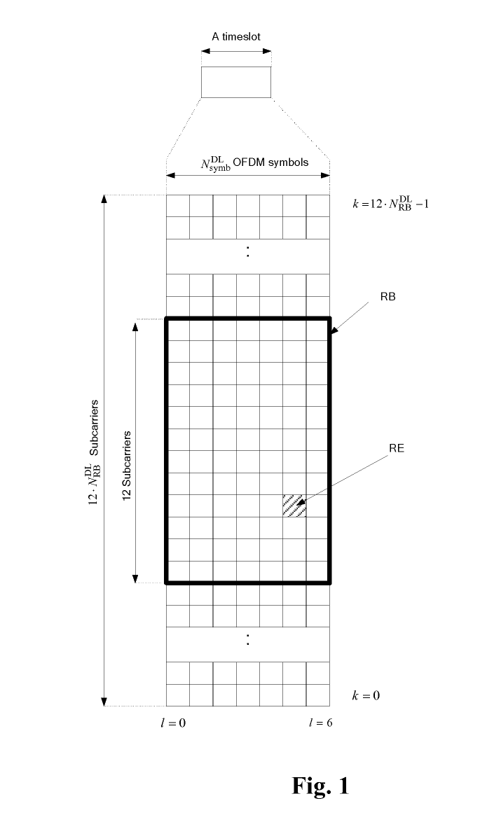

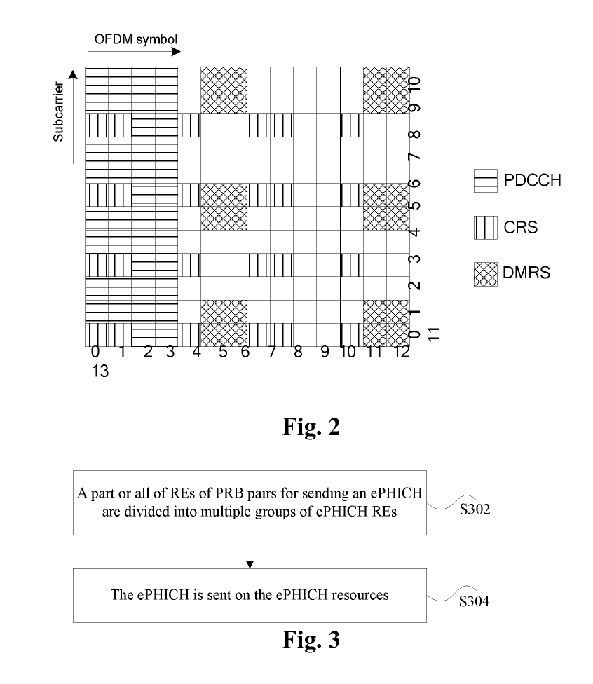

### DETAILED DESCRIPTION OF THE EMBODIMENTS

The present disclosure is described below with reference to the drawings and embodiments in detail. It is important to note that the embodiments in the present disclosure and characteristics in the embodiments can be combined under the condition of no conflicts.

A method for sending an ePHICH is provided in the embodiment, FIG. 3 is a flowchart of a method for sending an ePHICH according to an embodiment of the present disclosure, and as shown in FIG. 3, the method includes the following Step 302 to Step 304.

Step 302: a part or all of REs of PRB pairs for sending the ePHICH are divided into N_{ePHICH}^{group} groups of ePHICH REs, wherein each group of ePHICH REs in the N_{ePHICH}^{group} groups of ePHICH REs includes N_{ePHICH}^{seq} resources, and both N_{ePHICH}^{group} and N_{ePHICH}^{seq} are positive integers more than or equal to 1.

Step 304: the ePHICH is sent on the ePHICH resources.

By the steps, the part or all of the REs of the PRB pairs for sending the ePHICH are divided into the N_{ePHICH}^{group} groups of ePHICH REs, wherein each ePHICH REs in the N_{ePHICH}^{group} groups of ePHICH REs includes N_{ePHICH}^{seq} resources; and then the ePHICH is transmitted on the ePHICH resources. Therefore, the problem of poorer transmission performance of a conventional PHICH in the related art is solved, and the effect of improving uplink ACK/NACK information transmission performance is further achieved.

In an optional implementation manner, PRB pair resources for sending the ePHICH are notified to a terminal side through higher-layer signalling (including a system message or Radio Resource Control (RRC) signalling) or physical-layer signalling, or are determined according to a manner predetermined by a network side and the terminal side. Preferably, the PRB pair resources, configured to the terminal side by the network side, for sending the ePHICH are a part or all of the RE resources of the PRB pairs, configured to the terminal side, for ePDCCH blind detection or the PRB pair resources, configured to the terminal side by the network side, for the ePDCCH blind detection are a part or all of the RE resources of the PRB pairs, configured to the terminal side, for sending the ePHICH. Wherein, the PRB pair resources include sub-frame positions of the PRB pairs on the time domain and PRB position indexes on the frequency domain.

Each PRB pair is form of two PRBs on a sub-frame, wherein the two PRBs may be form of the same frequency-domain subcarriers, and may also be form of different frequency-domain subcarriers, for example, one PRB is form of subcarrier 0 to subcarrier 11 and the other PRB is form of subcarrier 24 to subcarrier 35.

In an optional manner, the number of the PRB pairs for sending the ePHICH is notified through higher-layer signalling phich-Resource or corresponds to a value of a parameter N_{g} of a PHICH by one to one, for example:

TABLE 2
Notification through Higher-layer Signalling

| phich-Resource | oneSixth | half | one | two |
|---|---|---|---|---|
| Number of PRB | 2 | 4 | 8 | 16 |
| pairs for | | | | |
| ePHICH | | | | |

TABLE 3
Determination through the Value of N_{g}

| N_{g} | ⅙ | ½ | 1 | 2 |
|---|---|---|---|---|
| Number of | 2 | 4 | 6 | 16 |
| PRB pairs for | | | | |
| ePHICH | | | | |

Wherein, the number of the PRB pairs for sending the ePHICH refers to the number of the PRB pairs for sending the ePHICH on a single sub-frame for sending the ePHICH.

In an optional manner, the number of the PRB pairs for the ePHICH in Table 2 and Table 3 may also be other values.

During implementation, the part or all of the REs of the PRB pairs for sending the ePHICH are divided into the N_{ePHICH}^{group} groups of ePHICH REs in multiple implemented manners. For example, eight manners are described as follows.

Manner 1: the part or all of the RE resources, except RE resources occupied by DMRS, in each PRB pair in the PRB pairs for sending the ePHICH are divided into Np first eREGs respectively; an ePHICH REG in each PRB pair is determined respectively, wherein the ePHICH REG comprises Nx time-domain adjacent or frequency-domain adjacent first eREGs; and all ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, Np is an integer more than 1, and Nx is an integer more than or equal to 1.

Manner 2: the part or all of the RE resources, except RE resources occupied by the DMRS, in each PRB pair in the PRB pairs for sending the ePHICH are divided into Np second eREGs respectively; each PRB pair in the PRB pairs for sending the ePHICH is divided into multiple REG areas respectively, wherein each REG area in the multiple REG areas includes one or more subcarriers on the frequency domain, and includes one or more OFDM symbols on the time domain; an ePHICH REG of each REG area in the multiple REG areas is determined respectively, wherein the ePHICH REG comprises Nx time-domain adjacent or frequency-domain adjacent second eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, Np is an integer more than 1, and Nx is an integer more than or equal to 1.

Manner 3: the part or all of the RE resources, except RE resources occupied by the DMRS, in each PRB pair in the PRB pairs for sending the ePHICH into Np third eREGs respectively, wherein each eREG in the Np third eREGs includes Nr REs, and N REs in each eREG are configured for ePHICH transmission; an ePHICH REG in each PRB pair is determined respectively, wherein the ePHICH REG comprises Nx time-domain adjacent or frequency-domain adjacent third eREGs; and all the ePHICH REGs of the PRB pairs for sending the ePHICH are divided into the N_{ePHICH}^{group} ePHICH groups of ePHICH REs, wherein each group of ePHICH REs in the N_{ePHICH}^{group} ePHICH groups of ePHICH REs includes one or more ePHICH REGs, N is less than or equal to Nr, Np, Nr and N are all integers more than 1, and Nx is an integer more than or equal to 1.

Manner 4: the part or all of the RE resources, except RE resources occupied by the DMRS, in each PRB pair in the PRB pairs for sending the ePHICH are divided into Np fourth eREGs respectively, wherein each eREG in the Np fourth eREGs includes Nr REs, and N REs in each eREG are configured for ePHICH transmission; each PRB pair in the PRB pairs for sending the ePHICH is divided into multiple REG areas respectively, wherein each REG area in the multiple REG areas includes one or more subcarriers on the frequency domain, and includes one or more OFDM symbols on the time domain; an ePHICH REG of each REG area in the multiple REG areas is determined respectively, wherein the ePHICH REG comprises Nx time-domain adjacent or frequency-domain adjacent fourth eREGs; and all the ePHICH REGs of the PRB pairs for sending the ePHICH are divided into the N_{ePHICH}^{group} ePHICH groups of ePHICH REs, wherein each group of ePHICH REs in the N_{ePHICH}^{group} ePHICH groups of ePHICH REs includes one or more ePHICH REGs, N is less than or equal to Nr, Np, Nr and N are all integers more than 1, and Nx is an integer more than or equal to 1.

Manner 5: the part or all of the RE resources, except RE resources occupied by the DMRS, in each PRB pair in the PRB pairs for sending the ePHICH are divided into Np fifth eREGs respectively, wherein M eREGs in the Np fifth eREGs are configured for ePHICH transmission; an ePHICH REG in each PRB pair is determined respectively, wherein the ePHICH REG comprises Nx time-domain adjacent or frequency-domain adjacent fifth eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, M is less than Np, both M and Np are integers more than 1, and Nx is an integer more than or equal to 1.

Manner 6: the part or all of the RE resources, except RE resources occupied by the DMRS, in each PRB pair in the PRB pairs for sending the ePHICH are divided into Np sixth eREGs respectively, wherein M eREGs in the Np sixth eREGs are configured for ePHICH transmission; each PRB pair in the PRB pairs for sending the ePHICH is divided into multiple REG areas respectively, wherein each REG area in the multiple REG areas includes one or more subcarriers on the frequency domain, and includes one or more OFDM symbols on the time domain; an ePHICH REG of each REG area in the multiple REG areas is determined respectively, wherein the ePHICH REG comprises Nx time-domain adjacent or frequency-domain adjacent sixth eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, M is less than Np, both M and Np are integers more than 1, and Nx is an integer more than or equal to 1.

Manner 7: the part or all of the RE resources, except RE resources occupied by the DMRS, in each PRB pair in the PRB pairs for sending the ePHICH are divided into Np seventh eREGs respectively, wherein M eREGs in the Np seventh eREGs are configured for ePHICH transmission, N REs included in each eREG in the M eREGs are configured for ePHICH transmission, and each eREG in the M eREGs includes Nr REs; an ePHICH REG in each PRB pair is determined respectively, wherein the ePHICH REG comprises Nx time-domain adjacent or frequency-domain adjacent seventh eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, M is less than Np, N is less than Nr, M, Np, N and Nr are all integers more than 1, and Nx is an integer more than or equal to 1.

Manner 8: the part or all of the RE resources, except RE resources occupied by the DMRS, in each PRB pair in the PRB pairs for sending the ePHICH are divided into Np eighth eREGs respectively, wherein M eREGs in the Np eighth eREGs are configured for ePHICH transmission, N REs included in each eREG in the M eREGs are configured for ePHICH transmission, and each eREG in the M eREGs includes Nr REs; each PRB pair in the PRB pairs for sending the ePHICH is divided into multiple REG areas respectively, wherein each REG area in the multiple REG areas includes one or more subcarriers on the frequency domain, and includes one or more OFDM symbols on the time domain; an ePHICH REG of each REG area in the multiple REG areas is determined respectively, wherein the ePHICH REG comprises Nx time-domain adjacent or frequency-domain adjacent eighth eREGs; and all the ePHICH REGs of the PRB pairs for sending the ePHICH are divided into the N_{ePHICH}^{group} ePHICH groups of ePHICH REs, wherein each group of ePHICH REs in the N_{ePHICH}^{group} ePHICH groups of ePHICH REs includes one or more ePHICH REGs, M, Np, N and Nr are all integers more than 1, and Nx is an integer more than or equal to 1.

In an optional implementation manner, N_{ePHICH}^{group} is acquired by one of manners as follows:

Manner 1: N_{ePHICH}^{group} is preset by the network side and the terminal side;

Manner 2: N_{ePHICH}^{group} is notified to the terminal side by the network side through the higher-layer signalling; and

Manner 3: N_{ePHICH}^{group} is determined through at least one of parameters as follows: a cell ID, the number of PRBs configured to the ePHICH, a sub-frame type, a sub-frame number and a CP length.

Preferably, N_{ePHICH}^{group} may be notified through the higher-layer signalling phich-Resource or correspond to the value of the parameter N_{g} of the PHICH one to one, for example:

TABLE 4
Notification through Higher-layer Signalling

| phich-Resource | oneSixth | half | one | two |
|---|---|---|---|---|
| N_{ePHICH}^{group} | 4 | 8 | 16 | 32 |

TABLE 5
Determination through the Value of N_{g}

| N_{g} | ⅙ | ½ | 1 | 2 |
|---|---|---|---|---|
| N_{ePHICH}^{group} | 4 | 8 | 16 | 32 |

Wherein, the values of N_{ePHICH}^{group} in Table 4 and Table 5 may be other values.

The optional embodiment provides multiple manners for acquiring N_{ePHICH}^{group}, so that flexibility in the acquisition of N_{ePHICH}^{group} is improved.

In an optional manner, resource configuration information of the PRB pairs for sending the ePHICH is notified to the terminal side through the higher-layer signalling (for example: the system message or RRC) or physical-layer signalling; or the resource configuration information of the PRB pairs for sending the ePHICH is preset on the network side and the terminal side. More preferably, the resource configuration information includes sub-frame resource information on the time domain and/or PRB indexes on the frequency domain.

As another optional implementation manner, the PRB pairs for sending the ePHICH may include: a part or all of resources in PRB pairs configured for sending the ePHICH or for ePDCCH blind detection, and by the optional implementation mode, a resource utilization rate is increased.

In an optional manner, on the PRB pairs for sending the ePHICH, a PDSCH/ePDCCH is allowed to multiplex the same PRB pairs with the ePHICH by a rate matching manner.

As another optional implementation manner, N_{ePHICH}^{seq} is preset by the network side and the terminal side, an index value corresponding to each N_{ePHICH}^{seq} in the N_{ePHICH}^{seq} orthogonal sequences is n_{ePHICH}^{group}, and n_{ePHICH}^{group} ε[0, N_{ePHICH}^{seq}−1]. In an optional manner, N_{ePHICH}^{seq} ePHICHs are multiplexed on the same group of ePHICH REs through N_{ePHICH}^{seq} different orthogonal sequences, wherein an index number value of an orthogonal sequence is n_{ePHICH}^{seq}, and n_{ePHICH}^{seq} ε[0, N_{ePHICH}^{seq}−1]. More preferably, the orthogonal sequences include orthogonal mask sequences.

In an optional manner, the network side notifies the group index n_{ePHICH}^{group} and the intra-group sequence index n_{ePHICH}^{seq} corresponding to the ePHICH resources to the terminal side through the system message or the higher-layer signalling; or

the network side indicates the group index n_{ePHICH}^{group} corresponding to the ePHICH resource to the terminal side through the system message or the higher-layer signalling, and indicates the intra-group sequence index n_{ePHICH}^{seq} to the terminal side through the physical-layer signalling; or

the network side notifies the group index n_{ePHICH}^{group} and the intra-group sequence index n_{ePHICH}^{seq} to the terminal side through the physical-layer signalling; or

the network side configures values of multiple sets of group index n_{ePHICH}^{group} and intra-group sequence index n_{ePHICH}^{seq} to the terminal side through the higher-layer signalling, and notifies one or more preset sets to the terminal side for ePHICH transmission through the physical-layer signalling.

In an optional manner, the network side determines the values of the group index n_{ePHICH}^{group} and intra-group sequence index n_{ePHICH}^{seq} of the ePHICH resources according to one or more of parameters such as a lowest PRB index of a PUSCH responded to the ePHICH, a DRMS domain value in uplink authorization information of a PDCCH corresponding to the PUSCH responded to the ePHICH and a sub-frame where the PUSCH responded to the ePHICH is located.

During implementation, all the ePHICH REGs of the PRB pairs for sending the ePHICH are divided into the N_{ePHICH}^{group} groups of ePHICH REs in multiple implemented manners. For example, there are three manners described as follows:

Manner 1: each ePHICH REG is taken as one group of ePHICH REs;

Manner 2: every Ny REGs at preset positions in each ePHICH PRB pair in all the ePHICH REGs are divided into a group of ePHICH REs; and

Manner 3: every Ny REGs belonging to multiple ePHICH PRB pairs at preset positions in all the ePHICH REGs are divided into one group of ePHICH REs.

As an optional implementation mode, Np is 16 or an integral multiple of 16, and Nx is 2 or 4.

In an optional manner, the value of N and the selection of the N REs are preset by the network side and the terminal side, or are determined according to at least one of parameters as follows: a sub-frame type, a CP length, the number of CRS ports, and the number of PDCCH symbols.

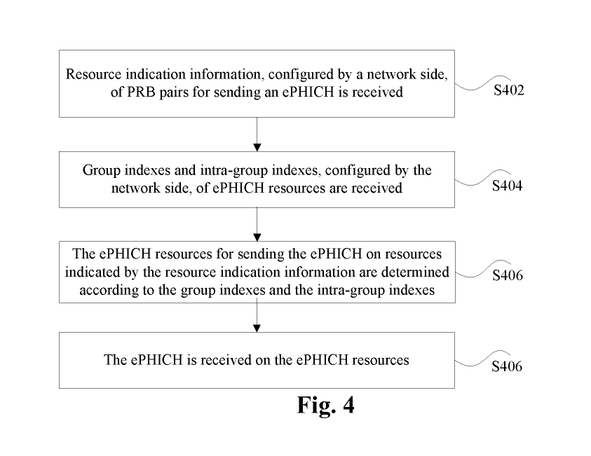

A method for receiving an ePHICH is provided in the embodiment, FIG. 4 is a flowchart of a method for receiving an ePHICH according to an embodiment of the present disclosure, and as shown in FIG. 4, the method includes the following Step 402 to Step 408.

Step 402: resource indication information, configured by a network side, of PRB pairs for sending the ePHICH is received, wherein a part or all of REs of the PRB pairs for sending the ePHICH are divided into N_{ePHICH}^{group} groups of ePHICH REs, each group of ePHICH REs in the N_{ePHICH}^{group} groups of ePHICH REs includes N_{ePHICH}^{seq} ePHICH resources, and both N_{ePHICH}^{group} and N_{ePHICH}^{seq} are positive integers more than or equal to 1.

Step 404: group indexes and intra-group indexes, configured by the network side, of the ePHICH resources; or information for determining the group indexes and the intra-group indexes of the ePHICH resources are received.

Step 406: the ePHICH resources for sending the ePHICH are determined on resources indicated by the resource indication information by virtue of the group indexes and the intra-group indexes.

Step 408: the ePHICH is received on the ePHICH resources.

In an optional implementation manner, the determination of the ePHICH resources for sending the ePHICH on the resources indicated by the resource indication information by virtue of the group indexes and the intra-group indexes may be implemented in multiple manners, for example: the part or all of the REs of the PRB pairs for sending the ePHICH are divided into the N_{ePHICH}^{group} groups of ePHICH REs according to the resource indication information; wherein each group of ePHICH REs in the N_{ePHICH}^{group} groups of ePHICH REs determined according to the resource indication information includes N_{ePHICH}^{seq} resources; and the ePHICH resources for sending the ePHICH on the N_{ePHICH}^{group} groups of ePHICH REs are determined according to the group indexes and the intra-group indexes.

During implementation, the part or all of the REs of the PRB pairs for sending the ePHICH are divided into the N_{ePHICH}^{group} groups of ePHICH REs according to the resource indication information in multiple implemented manners. For example, eight manners are described as follows.

Manner 1: the part or all of the RE resources, except RE resources occupied by DMRS, in each PRB pair in the PRB pairs for sending the ePHICH are divided into Np first eREGs respectively; an ePHICH REG in each PRB pair is determined respectively, wherein the ePHICH REG comprises Nx time-domain adjacent or frequency-domain adjacent first eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, Np is an integer more than 1, and Nx is an integer more than or equal to 1.

Manner 2: the part or all of the RE resources, except RE resources occupied by the DMRS, in each PRB pair in the PRB pairs for sending the ePHICH are divided into Np second eREGs respectively; each PRB pair in the PRB pairs for sending the ePHICH is divided into multiple REG areas respectively, wherein each REG area in the multiple REG areas includes one or more subcarriers on the frequency domain, and includes one or more OFDM symbols on the time domain; an ePHICH REG of each REG area in the multiple REG areas is determined respectively, wherein the ePHICH REG comprises Nx time-domain adjacent or frequency-domain adjacent second eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, Np is an integer more than 1, and Nx is an integer more than or equal to 1.

Manner 3: the part or all of the RE resources, except RE resources occupied by the DMRS, in each PRB pair in the PRB pairs for sending the ePHICH are divided into Np third eREGs respectively, wherein each eREG in the Np third eREGs includes Nr REs, and N REs in each eREG are configured for ePHICH transmission; an ePHICH REG in each PRB pair is determined respectively, wherein the ePHICH REG comprises Nx time-domain adjacent or frequency-domain adjacent third eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, N is less than or equal to Nr, Np, Nr and N are all integers more than 1, and Nx is an integer more than or equal to 1.

Manner 4: the part or all of the RE resources, except RE resources occupied by the DMRS, in each PRB pair in the PRB pairs for sending the ePHICH are divided into Np fourth eREGs respectively, wherein each eREG in the Np fourth eREGs includes Nr REs, and N REs in each eREG are configured for ePHICH transmission; each PRB pair in the PRB pairs for sending the ePHICH is divided into multiple REG areas respectively, wherein each REG area in the multiple REG areas includes one or more subcarriers on the frequency domain, and includes one or more OFDM symbols on the time domain; an ePHICH REG of each REG area in the multiple REG areas is determined respectively, wherein the ePHICH REG comprises Nx time-domain adjacent or frequency-domain adjacent fourth eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, N is less than or equal to Nr, Np, Nr and N are all integers more than 1, and Nx is an integer more than or equal to 1.

Manner 5: the part or all of the RE resources, except RE resources occupied by the DMRS, in each PRB pair in the PRB pairs for sending the ePHICH are divided into Np fifth eREGs respectively, wherein M eREGs in the Np fifth eREGs are configured for ePHICH transmission; an ePHICH REG in each PRB pair is determined respectively, wherein the ePHICH REG comprises Nx time-domain adjacent or frequency-domain adjacent fifth eREGs; and all the ePHICH REGs of the PRB pairs for sending the ePHICH are divided into the N_{ePHICH}^{group} groups of ePHICH REs, wherein each group of ePHICH REs in the N_{ePHICH}^{seq} groups of ePHICH REs includes one or more ePHICH REGs, M is less than Np, both M and Np are integers more than 1, and Nx is an integer more than or equal to 1.

Manner 6: the part or all of the RE resources, except RE resources occupied by the DMRS, in each PRB pair in the PRB pairs for sending the ePHICH are divided into Np sixth eREGs respectively, wherein M eREGs in the Np sixth eREGs are configured for ePHICH transmission; each PRB pair in the PRB pairs for sending the ePHICH is divided into multiple REG areas respectively, wherein each REG area in the multiple REG areas includes one or more subcarriers on the frequency domain, and includes one or more OFDM symbols on the time domain; an ePHICH REG of each REG area in the multiple REG areas is determined respectively, wherein the ePHICH REG comprises Nx time-domain adjacent or frequency-domain adjacent sixth eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, M is less than Np, both M and Np are integers more than 1, and Nx is an integer more than or equal to 1.

Manner 7: the part or all of the RE resources, except RE resources occupied by the DMRS, in each PRB pair in the PRB pairs for sending the ePHICH are divided into Np seventh eREGs respectively, wherein M eREGs in the Np seventh eREGs are configured for ePHICH transmission, N REs included in each eREG in the M eREGs are configured for ePHICH transmission, and each eREG in the M eREGs includes Nr REs; an ePHICH REG in each PRB pair is determined respectively, wherein the ePHICH REGs are Nx time-domain adjacent or frequency-domain adjacent seventh eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} groups of ePHICH REs includes one or more ePHICH REGs, M is less than Np, N is less than Nr, M, Np, N and Nr are all integers more than 1, and Nx is an integer more than or equal to 1.

Manner 8: the part or all of the RE resources, except RE resources occupied by the DMRS, in each PRB pair in the PRB pairs for sending the ePHICH are divided into Np eighth eREGs respectively, wherein M eREGs in the Np eighth eREGs are configured for ePHICH transmission, N REs included in each eREG in the M eREGs are configured for ePHICH transmission, and each eREG in the M eREGs includes Nr REs; each PRB pair in the PRB pairs for sending the ePHICH is divided into multiple REG areas respectively, wherein each REG area in the multiple REG areas includes one or more subcarriers on the frequency domain, and includes one or more OFDM symbols on the time domain; an ePHICH REG of each REG area in the multiple REG areas is determined respectively, wherein the ePHICH REG comprises Nx time-domain adjacent or frequency-domain adjacent eighth eREGs; and all the ePHICH REGs of the PRB pairs for sending the ePHICH are divided into the N_{ePHICH}^{group} groups of ePHICH REs, wherein each group of ePHICH REs in the N_{ePHICH}^{group} ePHICH groups of ePHICH REs includes one or more ePHICH REGs, M is less than Np, N is less than Nr, M, Np, N and Nr are all integers more than 1, and Nx is an integer more than or equal to 1.

As an example implementation manner, N_{ePHICH}^{group} is acquired by one of manners as follows:

Manner 1: N_{ePHICH}^{group} is preset by the network side and the terminal side;

Manner 2: N_{ePHICH}^{group} is notified to the terminal side by the network side through higher-layer signalling; and

Manner 3: N_{ePHICH}^{group} is determined through at least one of parameters as follows: a cell ID, the number of PRBs configured to the ePHICH, a sub-frame type, a sub-frame number and a CP length.

In an example manner, resource configuration information of the PRB pairs for sending the ePHICH is notified to the terminal side through the higher-layer signalling (for example: a system message or RRC) or physical-layer signalling; or the resource configuration information of the PRB pairs for sending the ePHICH is preset on the network side and the terminal side. More preferably, the resource configuration information includes sub-frame resource information on the time domain and/or PRB indexes on the frequency domain.

As another example implementation manner, the PRB pairs for sending the ePHICH may include: a part or all of resources in the PRB pairs configured for sending the ePHICH or for ePDCCH blind detection, and by the example implementation manner, a resource utilization rate is increased.

In an example manner, on the PRB pairs for sending the ePHICH, a PDSCH/ePDCCH is allowed to multiplex the same PRB pairs with the ePHICH by a rate matching manner.

As another example implementation manner, N_{ePHICH}^{seq} is preset by the network side and the terminal side, an the index value corresponding to each N_{ePHICH}^{seq} in N_{ePHICH}^{seq} orthogonal sequences is n_{ePHICH}^{group}, and n_{ePHICH}^{group} ε[0, N_{ePHICH}^{seq}−1]. Preferably, N_{ePHICH}^{seq} ePHICHs are multiplexed on the same group of ePHICH REs through N_{ePHICH}^{seq} different orthogonal sequences, wherein an index number value of an orthogonal sequence is n_{ePHICH}^{seq}, and n_{ePHICH}^{seq} ε[0, N_{ePHICH}^{seq}−1]. More preferably, the orthogonal sequences include orthogonal mask sequences.

In an optional manner, the network side notifies the group index n_{ePHICH}^{group} and the intra-group sequence index n_{ePHICH}^{seq} corresponding to the ePHICH resources to the terminal side through the system message or the higher-layer signalling; or

the network side indicates the group index n_{ePHICH}^{group} corresponding to the ePHICH resource to the terminal side through the system message or the higher-layer signalling, and indicates the intra-group sequence index n_{ePHICH}^{seq} to the terminal side through the physical-layer signalling; or

the network side notifies the group index n_{ePHICH}^{group} and the intra-group sequence index n_{ePHICH}^{seq} to the terminal side through the physical-layer signalling; or

the network side configures values of multiple sets of group index n_{ePHICH}^{group} and intra-group sequence index n_{ePHICH}^{seq} to the terminal side through the higher-layer signalling, and notifies one or more preset sets to the terminal side for ePHICH transmission through the physical-layer signalling.

In an optional embodiment, the network side determines the values of the group index n_{ePHICH}^{group} and the intra-group sequence index n_{ePHICH}^{seq} of the ePHICH resources according to one or more of parameters such as a lowest PRB index of a PUSCH responded to the ePHICH, a DRMS domain value in uplink authorization information of a PDCCH corresponding to the PUSCH responded to the ePHICH and a sub-frame where the PUSCH responded to the ePHICH is located.

During implementation, the division of all of the ePHICH REGs of the PRB pairs for sending the ePHICH into the N_{ePHICH}^{group} groups of ePHICH REs according to the resource indication information may be implemented in multiple manners, including one of:

Manner 1: each ePHICH REG is taken as one group of ePHICH REs;

Manner 2: every Ny REGs at preset positions in each ePHICH PRB pair in all the ePHICH REGs are divided into one group of ePHICH REs; and

Manner 3: every Ny REGs belonging to multiple ePHICH PRB pairs at preset positions in all the ePHICH REGs are divided into one group of ePHICH REs.

As an example implementation mode, Np is 16 or an integral multiple of 16, and Nx is 2 or 4.

In an optional embodiment, the value of N and the selection of the N REs are preset by the network side and the terminal side, or are determined according to at least one of parameters as follows: a sub-frame type, a CP length, the number of CRS ports and the number of PDCCH symbols.

It is important to note that the steps shown in the flowcharts of the drawings may be executed in a computer system, for example, a group of computers, capable of executing instructions, and moreover, although logic sequences are shown in the flowcharts, the shown or described steps may be executed in sequences different from the sequences here under certain circumstances.

In another embodiment, a software for sending an ePHICH is further provided, which is configured to execute the technical solutions described in the abovementioned embodiment and example embodiment.

In another embodiment, a storage medium is further provided, in which the abovementioned software for sending the ePHICH is stored, the storage medium including, but not limited to: a compact disc, floppy disk, a hard disk, an erasable memory and the like.

A device for sending an ePHICH is further provided in the embodiment of the present disclosure. The device for sending the ePHICH may be configured to implement the method for sending the ePHICH and the the example implementation modes, that what has been described will not be repeated here, and components involved in the device for sending the ePHICH are described below. For example, a term “component”, used below, is a combination of software and/or hardware capable of realizing preset functions. The system and method described in the following embodiment are preferably implemented by software, but implementation with hardware or the combination of software and hardware is also possible and conceived.

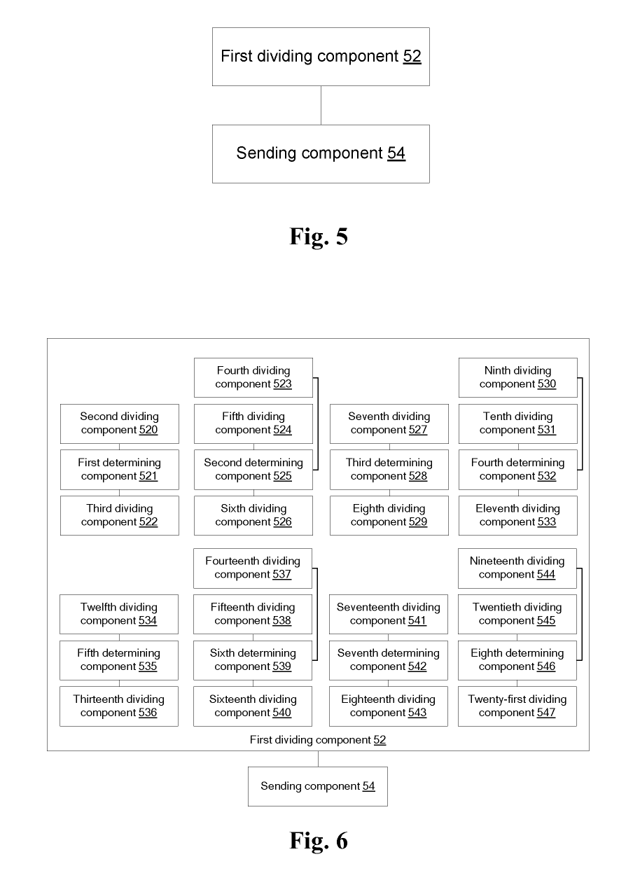

FIG. 5 is a structure diagram of a device for sending an ePHICH according to an embodiment of the present disclosure, and as shown in FIG. 5, the device includes: a first dividing component 52 and a sending component 54. The structure is described below in detail.

The first dividing component 52 is configured to divide a part or all of REs of PRB pairs for sending the ePHICH into N_{ePHICH}^{group} groups of ePHICH REs, wherein each group of ePHICH REs in the N_{ePHICH}^{group} groups of ePHICH REs includes N_{ePHICH}^{seq} ePHICH resources, and both N_{ePHICH}^{group} and N_{ePHICH}^{seq} are positive integers more than or equal to 1; and the sending component 54 is connected to the first dividing component 52, and is configured to send the ePHICH on the ePHICH resources divided by the first dividing component 52.

FIG. 6 is an example structure diagram of the device for sending the ePHICH according to an embodiment of the present disclosure, and as shown in FIG. 6, the structure is described below in detail.

The first dividing component 52 includes one of component combinations as follows:

a first component combination: a second dividing component 520, configured to divide a part or all of the RE resources, except RE resources occupied by the DMRS, in each PRB pair in the PRB pairs for sending the ePHICH into Np first eREGs respectively; a first determining component 521, configured to determine an ePHICH REG in each PRB pair respectively, wherein the ePHICH REG comprises Nx time-domain adjacent or frequency-domain adjacent first eREGs; a third dividing component 522, configured to divide all the ePHICH REGs of the PRB pairs for sending the ePHICH into the N_{ePHICH}^{group} groups of ePHICH REs, wherein each group of ePHICH REs in the N_{ePHICH}^{seq} groups of ePHICH REs includes one or more ePHICH REGs, Np is an integer more than 1, and Nx is an integer more than or equal to 1;

a second component combination: a fourth dividing component 523, configured to divide a part or all of the RE resources, except RE resources occupied by the DMRS, in each PRB pair in the PRB pairs for sending the ePHICH into Np second eREGs respectively; a fifth dividing component 524, configured to divide each PRB pair in the PRB pairs for sending the ePHICH into multiple REG areas respectively, wherein each REG area in the multiple REG areas includes one or more subcarriers on the frequency domain, and includes one or more OFDM symbols on the time domain; a second determining component 525, configured to determine an ePHICH REGs of each REG area in the multiple REG areas respectively, wherein the ePHICH REG comprises Nx time-domain adjacent or frequency-domain adjacent second eREGs; a sixth dividing component 526, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, Np is an integer more than 1, and Nx is an integer more than or equal to 1;

a third component combination: a seventh dividing component 527, configured to divide a part or all of the RE resources, except RE resources occupied by the DMRS, in each PRB pair in the PRB pairs for sending the ePHICH into Np third eREGs respectively, wherein each eREG in the Np third eREGs includes Nr REs, and N REs in each eREG are configured for ePHICH transmission; a third determining component 528, configured to determine an ePHICH REG in each PRB pair respectively, wherein the ePHICH REG comprises Nx time-domain adjacent or frequency-domain adjacent third eREGs; an eighth dividing component 529, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, N is less than or equal to Nr, all of Np, Nr and N are integers more than 1, and Nx is an integer more than or equal to 1;

a fourth component combination: a ninth dividing component 530, configured to divide a part or all of the RE resources, except RE resources occupied by the DMRS, in each PRB pair in the PRB pairs for sending the ePHICH into Np fourth eREGs respectively, wherein each eREG in the Np fourth eREGs includes Nr REs, and N REs in each eREG are configured for ePHICH transmission; a tenth dividing component 531, configured to divide each PRB pair in the PRB pairs for sending the ePHICH into multiple REG areas respectively, wherein each REG area in the multiple REG areas includes one or more subcarriers on the frequency domain, and includes one or more OFDM symbols on the time domain; a fourth determining component 532, configured to determine an ePHICH REG of each REG area in the multiple REG areas respectively, wherein the ePHICH REG comprises Nx time-domain adjacent or frequency-domain adjacent fourth eREGs; an eleventh dividing component 533, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, N is less than or equal to Nr, all of Np, Nr and N are integers more than 1, and Nx is an integer more than or equal to 1;

a fifth component combination: a twelfth dividing component 534, configured to divide a part or all of the RE resources, except RE resources occupied by the DMRS, in each PRB pair in the PRB pairs for sending the ePHICH into Np fifth eREGs respectively, wherein M eREGs in the Np fifth eREGs are configured for ePHICH transmission; a fifth determining component 535, configured to determine an ePHICH REG in each PRB pair respectively, wherein the ePHICH REG comprises Nx time-domain adjacent or frequency-domain adjacent fifth eREGs; a thirteenth dividing component 536, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, M is less than Np, both M and Np are integers more than 1, and Nx is an integer more than or equal to 1;

a sixth component combination: a fourteenth dividing component 537, configured to divide a part or all of the RE resources, except RE resources occupied by the DMRS, in each PRB pair in the PRB pairs for sending the ePHICH into Np sixth eREGs respectively, wherein M eREGs in the Np sixth eREGs are configured for ePHICH transmission; a fifteenth dividing component 538, configured to divide each PRB pair in the PRB pairs for sending the ePHICH into multiple REG areas respectively, wherein each REG area in the multiple REG areas includes one or more subcarriers on the frequency domain, and includes one or more OFDM symbols on the time domain; a sixth determining component 539, configured to determine an ePHICH REG of each REG area in the multiple REG areas respectively, wherein the ePHICH REG comprises Nx time-domain adjacent or frequency-domain adjacent sixth eREGs; a sixteenth dividing component 540, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, M is less than Np, both M and Np are integers more than 1, and Nx is an integer more than or equal to 1;

a seventh component combination: a seventeenth dividing component 541, configured to divide a part or all of the RE resources, except RE resources occupied by the DMRS, in each PRB pair in the PRB pairs for sending the ePHICH into Np seventh eREGs respectively, wherein M eREGs in the Np seventh eREGs are configured for ePHICH transmission, N REs included in each eREG in the M eREGs are configured for ePHICH transmission, and each eREG in the M eREGs includes Nr REs; a seventh determining component 542, configured to determine an ePHICH REG in each PRB pair respectively, wherein the ePHICH REG comprises Nx time-domain adjacent or frequency-domain adjacent seventh eREGs; an eighteenth dividing component 543, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, M is less than Np, N is less than Nr, all of M, Np, N and Nr are integers more than 1, and Nx is an integer more than or equal to 1;

an eighth component combination: a nineteenth dividing component 544, configured to divide a part or all of the RE resources, except RE resources occupied by the DMRS, in each PRB pair in the PRB pairs for sending the ePHICH into Np eighth eREGs respectively, wherein M eREGs in the Np eighth eREGs are configured for ePHICH transmission, N REs included in each eREG in the M eREGs are configured for ePHICH transmission, and each eREG in the M eREGs includes Nr REs; a twentieth dividing component 545, configured to divide each PRB pair in the PRB pairs for sending the ePHICH into multiple REG areas respectively, wherein each REG area in the multiple REG areas includes one or more subcarriers on the frequency domain, and includes one or more OFDM symbols on the time domain; an eighth determining component 546, configured to determine an ePHICH REG of each REG area in the multiple REG areas respectively, wherein the ePHICH REG comprises Nx time-domain adjacent or frequency-domain adjacent eighth eREGs; and a twenty-first dividing component 547, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, M is less than Np, N is less than Nr, all of M, Np, N and Nr are all integers more than 1, and Nx is an integer more than or equal to 1.

In an optional manner, N_{ePHICH}^{group} is acquired in one of manners as follows: N_{ePHICH}^{group} is preset by a network side and a terminal side; N_{ePHICH}^{group} is notified to the terminal side by the network side through higher-layer signalling; and N_{ePHICH}^{group} is determined through at least one of parameters as follows: a cell ID, the number of PRBs configured to the ePHICH, a sub-frame type, a sub-frame number and a CP length.

In an optional manner, resource configuration information of the PRB pairs for sending the ePHICH is notified to the terminal side through the higher-layer signalling or physical-layer signalling; or the resource configuration information of the PRB pairs for sending the ePHICH is preset on the network side and the terminal side.

In an optional manner, the resource configuration information includes sub-frame resource information on the time domain and/or PRB indexes on the frequency domain.

In an optional manner, the PRB pairs for sending the ePHICH include: a part or all of resources in PRB pairs configured for sending the ePHICH or for ePDCCH blind detection.

In an optional manner, on the PRB pairs for sending the ePHICH, a PDSCH/ePDCCH and the ePHICH are allowed to be multiplexed on the same PRB pairs by a rate matching manner.

In an optional manner, N_{ePHICH}^{seq} is preset by the network side and the terminal side, an index value corresponding to each ePHICH resource in the N_{ePHICH}^{seq} ePHICH resources is n_{ePHICH}^{seq} and n_{ePHICH}^{seq} ε[0, N_{ePHICH}^{seq}−1].

In an optional manner, the N_{ePHICH}^{seq} resources are multiplexed on one group of ePHICH REs through N_{ePHICH}^{seq} different orthogonal sequences, wherein an index of an orthogonal sequence is n_{ePHICH}^{seq} and n_{ePHICH}^{group} ε[0, N_{ePHICH}^{seq}−1]. More preferably, the orthogonal sequences include orthogonal mask sequences.

In an optional manner, the network side notifies the group index n_{ePHICH}^{group} and the intra-group sequence index n_{ePHICH}^{seq} corresponding to the ePHICH resource to the terminal side through a system message or a higher-layer signalling; or

the network side indicates the group index n_{ePHICH}^{group} corresponding to the ePHICH resource to the terminal side through the system message or the higher-layer signalling, and indicates the intra-group sequence index n_{ePHICH}^{seq} to the terminal side through the physical-layer signalling; or

the network side notifies the group index n_{ePHICH}^{group} and the intra-group sequence index n_{ePHICH}^{seq} to the terminal side through the physical-layer signalling; or

the network side configures values of multiple sets of the group index n_{ePHICH}^{group} and the intra-group sequence index n_{ePHICH}^{group} to the terminal side through the higher-layer signalling, and notifies one or more preset sets to the terminal side for ePHICH transmission through the physical-layer signalling.

In an optional manner, the network side determines the values of the group index n_{ePHICH}^{group} and the intra-group sequence index n_{ePHICH}^{seq} of the ePHICH resource according to one or more of parameters as follows: a lowest PRB index of a PUSCH responded by the ePHICH, a DRMS domain value in uplink authorization information of a PDCCH corresponding to the PUSCH responded by the ePHICH and a sub-frame where the PUSCH responded by the ePHICH is located.

In an optional manner, the third dividing component, the sixth dividing component, the eighth dividing component, the eleventh dividing component, the thirteenth dividing component, the sixteenth dividing component, the eighteenth dividing component and the twenty-first dividing component are configured to divide all of the ePHICH REGs of the PRB pairs for sending the ePHICH into the N_{ePHICH}^{group} groups of ePHICH Res in one of manners as follows:

taking each ePHICH REG as one group of ePHICH REs;

grouping every Ny REGs at preset locations in each ePHICH PRB pair in all the ePHICH REGs into one group of ePHICH REs; and

grouping every Ny REGs belonging to multiple ePHICH PRB pairs at preset locations in all the ePHICH REGs into one group of ePHICH REs.

More preferably, the value of Np is 16 or an integral multiple of 16, and the value of Nx is 2 or 4.

In an optional manner, the value of N and the selection of the N REs are preset by the network side and the terminal side, or are determined according to at least one of parameters as follows: a sub-frame type, a CP length, the number of CRS ports and the number of PDCCH symbols.

In another embodiment, a software for sending an ePHICH is further provided, which is configured to execute the technical solutions described in the abovementioned embodiment and the example embodiment.

In another embodiment, a storage medium is further provided, in which the abovementioned software for sending the ePHICH is stored, the storage medium including, but not limited to: a compact disc, floppy disk, a hard disk, an erasable memory and the like.

A device for receiving an ePHICH is provided in the embodiment of the present disclosure. The device for receiving the ePHICH may be configured to implement the method for receiving the ePHICH and the preferred implementation modes, that what has been described will not be repeated here, and components involved in the receiving device for the ePHICH are described below. For example, a term “component”, used below, is a combination of software and/or hardware capable of realizing preset functions. The system and method described in the following embodiment are preferably implemented by software, but implementation with hardware or the combination of software and hardware is also possible and conceived.

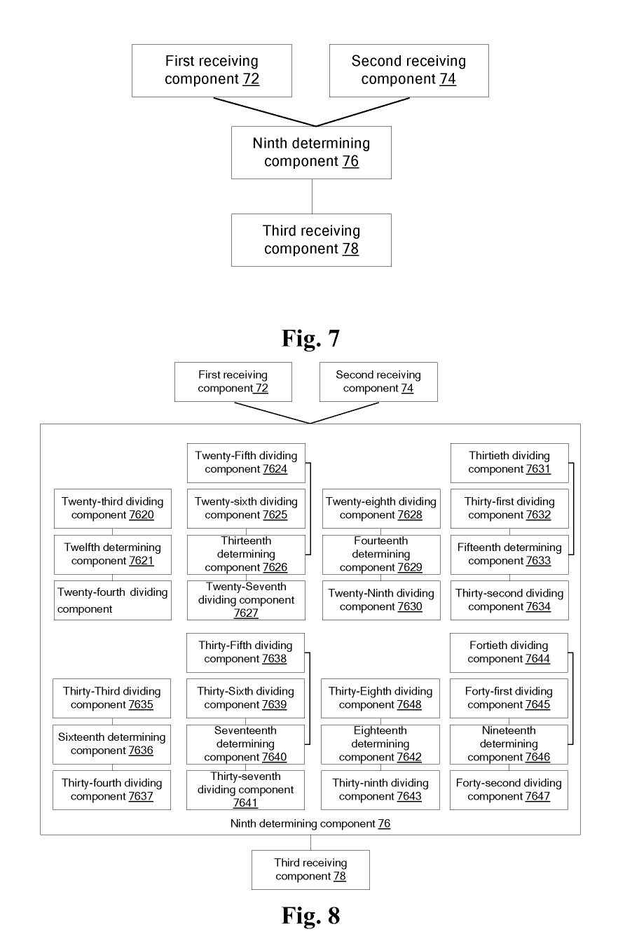

FIG. 7 is a structure diagram of a device for receiving an ePHICH according to an embodiment of the present disclosure, and as shown in FIG. 7, the device includes: a first receiving component 72, a second receiving component 74, a ninth determining component 76 and a third receiving component 78. The structure is described below in detail.

The first receiving component 72 is configured to receive resource indication information, configured by a network side, of PRB pairs for sending the ePHICH, wherein a part or all of REs of the PRB pairs for sending the ePHICH are divided into N_{ePHICH}^{group} groups of ePHICH REs, each group of ePHICH REs in the N_{ePHICH}^{group} groups of ePHICH REs includes N_{ePHICH}^{seq} resources, and both N_{ePHICH}^{group} and N_{ePHICH}^{seq} are positive integers more than or equal to 1; the second receiving component 74 is configured to receive group indexes and intra-group indexes, configured by the network side, of the ePHICH resources; or receive information for determining the group indexes and intra-group indexes of the ePHICH resources; the ninth determining component 76 is connected to the first receiving component 72 and the second receiving component 74, and is configured to determine, according to the group indexes and the intra-group indexes, the ePHICH resources for sending the ePHICH on resources indicated by the resource indication information; and the third receiving component 78 is connected to the ninth determining component 76, and is configured to receive the ePHICH on the ePHICH resources.

FIG. 8 is an example structure diagram of the device for receiving the ePHICH according to an embodiment of the present disclosure, and as shown in FIG. 8, the structure is described below in detail.

The ninth determining component 76 includes: a twenty-second dividing component 762, configured to divide a part or all of the REs of the PRB pairs for sending the ePHICH into the N_{ePHICH}^{group} groups of ePHICH REs according to the resource indication information; a tenth determining component 764, configured to determine, according to the resource indication information, that each group of ePHICH REs in the N_{ePHICH}^{group} groups of ePHICH REs includes N_{ePHICH}^{seq} ePHICH resources; and an eleventh determining component 766, configured to determine the ePHICH resources for sending the ePHICH on the N_{ePHICH}^{group} groups of ePHICH REs according to the group indexes and the intra-group indexes.

In an example manner, the twenty-second dividing component 762 includes one of component combinations as follows:

a first component combination: a twenty-third dividing component 7620, configured to divide a part or all of the RE resources, except RE resources occupied by DMRS, in each PRB pair in the PRB pairs for sending the ePHICH into Np first eREGs respectively; a twelfth determining component 7621, configured to determine an ePHICH REG in each PRB pair respectively, wherein the ePHICH REG comprises Nx time-domain adjacent or frequency-domain adjacent first eREGs; a twenty-fourth dividing component 7623, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, Np is an integer more than 1, and Nx is an integer more than or equal to 1;

a second component combination: a twenty-fifth dividing component 7624, configured to divide a part or all of the RE resources, except RE resources occupied by the DMRS, in each PRB pair in the PRB pairs for sending the ePHICH into Np second eREGs respectively; a twenty-sixth dividing component 7625, configured to divide each PRB pair in the PRB pairs for sending the ePHICH into multiple REG areas respectively, wherein each REG area in the multiple REG areas includes one or more subcarriers on the frequency domain, and includes one or more OFDM symbols on the time domain; a thirteenth determining component 7626, configured to determine an ePHICH REG of each REG area in the multiple REG areas respectively, wherein the ePHICH REG comprises Nx time-domain adjacent or frequency-domain adjacent second eREGs; a twenty-seventh dividing component 7627, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, Np is an integer more than 1, and Nx is an integer more than or equal to 1;

a third component combination: a twenty-eighth dividing component 7628, configured to divide a part or all of the RE resources, except RE resources occupied by the DMRS, in each PRB pair in the PRB pairs for sending the ePHICH into Np third eREGs respectively, wherein each eREG in the Np third eREGs includes Nr REs, and N REs in each eREG are configured for ePHICH transmission; a fourteenth determining component 7629, configured to determine an ePHICH REG in each PRB pair respectively, wherein the ePHICH REG comprises Nx time-domain adjacent or frequency-domain adjacent third eREGs; a twenty-ninth dividing component 7630, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, N is less than or equal to Nr, all of Np, Nr and N are integers more than 1, and Nx is an integer more than or equal to 1;

a fourth component combination: a thirtieth dividing component 7631, configured to divide a part or all of the RE resources, except RE resources occupied by the DMRS, in each PRB pair in the PRB pairs for sending the ePHICH into Np fourth eREGs respectively, wherein each eREG in the Np fourth eREGs includes Nr REs, and N REs in each eREG are configured for ePHICH transmission; a thirty-first dividing component 7632, configured to divide each PRB pair in the PRB pairs for sending the ePHICH into multiple REG areas respectively, wherein each REG area in the multiple REG areas includes one or more subcarriers on the frequency domain, and includes one or more OFDM symbols on the time domain; a fifteenth determining component 7633, configured to determine an ePHICH REG of each REG area in the multiple REG areas respectively, wherein the ePHICH REG comprises Nx time-domain adjacent or frequency-domain adjacent fourth eREGs; a thirty-second dividing component 7634, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, N is less than or equal to Nr, all of Np, Nr and N are integers more than 1, and Nx is an integer more than or equal to 1;

a fifth component combination: a thirty-third dividing component 7635, configured to divide a part or all of the RE resources, except RE resources occupied by the DMRS, in each PRB pair in the PRB pairs for sending the ePHICH into Np fifth eREGs respectively, wherein M eREGs in the Np fifth eREGs are configured for ePHICH transmission; a sixteenth determining component 7636, configured to determine an ePHICH REG in each PRB pair respectively, wherein the ePHICH REG comprises Nx time-domain adjacent or frequency-domain adjacent fifth eREGs; a thirty-fourth dividing component 7637, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, M is less than Np, both M and Np are integers more than 1, and Nx is an integer more than or equal to 1;

a sixth component combination: a thirty-fifth dividing component 7638, configured to divide a part or all of the RE resources, except RE resources occupied by the DMRS, in each PRB pair in the PRB pairs for sending the ePHICH into Np sixth eREGs respectively, wherein M eREGs in the Np sixth eREGs are configured for ePHICH transmission; a thirty-sixth dividing component 7639, configured to divide each PRB pair in the PRB pairs for sending the ePHICH into multiple REG areas respectively, wherein each REG area in the multiple REG areas includes one or more subcarriers on the frequency domain, and includes one or more OFDM symbols on the time domain; a seventeenth determining component 7640, configured to determine an ePHICH REG of each REG area in the multiple REG areas respectively, wherein the ePHICH REG comprises Nx time-domain adjacent or frequency-domain adjacent sixth eREGs; a thirty-seventh dividing component 7641, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, M is less than Np, both M and Np are integers more than 1, and Nx is an integer more than or equal to 1;

a seventh component combination: a thirty-eighth dividing component 7648, configured to divide a part or all of the RE resources, except RE resources occupied by the DMRS, in each PRB pair in the PRB pairs for sending the ePHICH into Np seventh eREGs respectively, wherein M eREGs in the Np seventh eREGs are configured for ePHICH transmission, N REs included in each eREG in the M eREGs are configured for ePHICH transmission, and each eREG in the M eREGs includes Nr REs; an eighteenth determining component 7642, configured to determine an ePHICH REG in each PRB pair respectively, wherein the ePHICH REG comprises Nx time-domain adjacent or frequency-domain adjacent seventh eREGs; a thirty-ninth dividing component 7643, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, M is less than Np, N is less than Nr, all of M, Np, N and Nr are integers more than 1, and Nx is an integer more than or equal to 1;

an eighth component combination: a fortieth dividing component 7644, configured to divide a part or all of the RE resources, except RE resources occupied by the DMRS, in each PRB pair in the PRB pairs for sending the ePHICH into Np eighth eREGs respectively, wherein M eREGs in the Np eighth eREGs are configured for ePHICH transmission, N REs included in each eREG in the M eREGs are configured for ePHICH transmission, and each eREG in the M eREGs includes Nr REs; a forty-first dividing component 7645, configured to divide each PRB pair in the PRB pairs for sending the ePHICH into multiple REG areas respectively, wherein each REG area in the multiple REG areas includes one or more subcarriers on the frequency domain, and includes one or more OFDM symbols on the time domain; a nineteenth determining component 7646, configured to determine an ePHICH REG of each REG area in the multiple REG areas respectively, wherein the ePHICH REG comprises Nx time-domain adjacent or frequency-domain adjacent eighth eREGs; and a forty-second dividing component 7647, configured to divide all the ePHICH REGs of the PRB pairs for sending the ePHICH into the N_{ePHICH}^{group} groups of ePHICH REs, wherein each group of ePHICH REs in the N_{ePHICH}^{group} groups of ePHICH REs includes one or more ePHICH REGs, M is less than Np, N is less than Nr, all of M, Np, N and Nr are integers more than 1, and Nx is an integer more than or equal to 1.

In an optional manner, N_{ePHICH}^{group} is acquired in one of manners as follows:

N_{ePHICH}^{group} ePHICH is preset by the network side and a terminal side;

N_{ePHICH}^{group} is notified to the terminal side by the network side through higher-layer signalling; and

N_{ePHICH}^{group} is determined through at least one of parameters as follows: a cell ID, the number of PRBs configured to the ePHICH, a sub-frame type, a sub-frame number and a CP length.

In an optional manner, resource configuration information of the PRB pairs for sending the ePHICH is notified to the terminal side through the higher-layer signalling or physical-layer signalling; or

the resource configuration information of the PRB pairs for sending the ePHICH is preset on the network side and the terminal side.

In an optional manner, the resource configuration information includes sub-frame resource information on the time domain and/or PRB indexes on the frequency domain.

In an optional manner, the PRB pairs for sending the ePHICH include: a part or all of resources in the PRB pairs configured for sending the ePHICH or for ePDCCH blind detection; and

In an optional manner, on the PRB pairs for sending the ePHICH, a PDSCH/ePDCCH and the ePHICH are allowed to be multiplexed on the same PRB pairs by a rate matching manner.

In an optional manner, N_{ePHICH}^{seq} is preset by the network side and the terminal side, an index value corresponding to each ePHICH resource in the N_{ePHICH}^{seq} ePHICH resources is n_{ePHICH}^{seq} and n_{ePHICH}^{seq} ε[0, N_{ePHICH}^{seq}−1].

In an optional manner, the N_{ePHICH}^{seq} resources are multiplexed on one group of ePHICH REs through N_{ePHICH}^{seq} different orthogonal sequences, wherein an index of the orthogonal sequence is n_{ePHICH}^{seq}, and n_{ePHICH}^{seq} ε[0, N_{ePHICH}^{seq}−1].

In an optional manner, the orthogonal sequences include orthogonal mask sequences.

In an optional manner, the network side notifies the group index n_{ePHICH}^{group} and the intra-group sequence index n_{ePHICH}^{seq} corresponding to the ePHICH resource to the terminal side through a system message or a higher-layer signalling; or

the network side indicates the group index n_{ePHICH}^{group} corresponding to the ePHICH resource to the terminal side through the system message or the higher-layer signalling, and indicates the intra-group sequence index n_{ePHICH}^{seq} to the terminal side through a physical-layer signalling; or

the network side notifies the group index n_{ePHICH}^{group} and the intra-group sequence index n_{ePHICH}^{seq} to the terminal side through the physical-layer signalling; or

the network side configures values of multiple sets of the group index n_{ePHICH}^{group} and the intra-group sequence index n_{ePHICH}^{seq} to the terminal side through the higher-layer signalling, and notifies one or more preset sets to the terminal side for ePHICH transmission through the physical-layer signalling.

In an optional manner, the network side determines the values of the group index n_{ePHICH}^{group} and intra-group sequence index n_{ePHICH}^{seq} of the ePHICH resource according to one or more of parameters as follows: a lowest PRB index of a PUSCH responded by the ePHICH, a DRMS domain value in uplink authorization information of a PDCCH corresponding to the PUSCH responded by the ePHICH and a sub-frame where the PUSCH responded by the ePHICH is located.

In an optional manner, the twenty-fourth dividing component, the twenty-seventh dividing component, the twenty-ninth dividing component, the thirty-second dividing component, the thirty-fourth dividing component, the thirty-seventh dividing component, the thirty-ninth dividing component and the forty-second dividing component are configured to divide all of the ePHICH REGs of the PRB pairs for sending the ePHICH into the N_{ePHICH}^{group} groups of ePHICH REs according to the resource indication information in one of manners as follows:

taking each ePHICH REG as one group of ePHICH REs;

grouping every Ny REGs at preset locations in each ePHICH PRB pair in all the ePHICH REGs into one group of ePHICH REs; and

grouping every Ny REGs belonging to multiple ePHICH PRB pairs at preset locations in all the ePHICH REGs into one group of ePHICH REs.

In an optional manner, the value of Np is 16 or an integral multiple of 16, and the value of Nx is 2 or 4.

In an optional manner, the value of N and the selection of the N REs are preset by the network side and the terminal side, or are determined according to at least one of parameters as follows: a sub-frame type, a CP length, the number of CRS ports and the number of PDCCH symbols.

The present disclosure is described below with reference to example embodiments, and the following preferred embodiments combine the abovementioned embodiments and the example implementation modes.

### Preferred Embodiment 1

A method for defining and instructing an ePHICH resource is provided in the preferred embodiment, so as to solve the problem of interference and insufficient resources of a conventional PHICH. The method includes: the part or all of RE resources of PRB pairs for sending an ePHICH are divided into N_{ePHICH}^{group} groups of ePHICH REs in a predetermined manner, wherein an ePHICH group ePHICH REs includes N_{ePHICH}^{seq} ePHICH REs, an ePHICH RE is defined and indicated by n_{ePHICH}^{group} or an index pair (n_{ePHICH}^{group}, n_{ePHICH}^{seq}), n_{ePHICH}^{group} is an ePHICH group index, n_{ePHICH}^{group} is an ePHICH intra-group orthogonal sequence index, n_{ePHICH}^{group} ε[0, N_{ePHICH}^{group}−1] and n_{ePHICH}^{seq} ε[0, N_{ePHICH}^{seq}−1].

In an example embodiment, the number N_{ePHICH}^{group} of ePHICH group resources is predetermined by a network side and a terminal side or notified to the terminal side through a system message or determined according to one or more of parameters such as a cell ID, the number of PRBs configured to the ePHICH, a sub-frame type, a sub-frame number and a CP length.

In an example embodiment, the resources (including sub-frame resources on the time domain and/or PRB indexes on the frequency domain) of the PRB pairs for sending the ePHICH are notified to the terminal side through the system message or RRC signalling or physical-layer signalling, or are determined by the network side and the terminal side in a predetermined manner.

In an example embodiment, the N_{ePHICH}^{seq} ePHICHs are multiplexed on the same group of ePHICH REs through different orthogonal sequences.

Preferably, the PRB pairs for sending the ePHICH are a part or all of the resources configured to the PRB pairs for ePDCCH blind detection, or the PRB pairs configured for ePDCCH blind detection are a part or all of the resources configured to the PRB pairs for sending the ePHICH. Wherein, the PRB pair resources include sub-frame locations of the PRB pairs on the time domain and PRB location indexes on the frequency domain.

In an example embodiment, the predetermined manner includes one of eight manners as follows.

Manner 1: a part or all of the RE resources, except RE resources occupied by DMRS, in each PRB pair for sending the ePHICH are divided into Np eREGs; every Nx time-domain adjacent or frequency-domain adjacent eREGs in each ePHICH PRB pair form an ePHICH REG; and one or more continuous/discrete REGs from the same/different ePHICH PRB pairs form a group of ePHICH REs, wherein Np and Nx are both integers more than 1, and preferably, the value of Np is 16 or a multiple of 16, and the value of Nx is 2 or 4.

Manner 2: a part or all of the RE resources, except RE resources occupied by the DMRS, in each PRB pair for sending the ePHICH are divided into Np eREGs; each PRB for sending the ePHICH is simultaneously divided into multiple REG areas, wherein each REG area includes one or more subcarriers on the frequency domain, and includes one or more OFDM symbols on the time domain; every Nx time-domain adjacent or frequency-domain adjacent eREGs in each REG area form an ePHICH REG; and one or more continuous/discrete REGs from the same/different ePHICH PRB pairs form a group of ePHICH REs, wherein Np and Nx are both integers more than 1, and preferably, the value of Np is 16 or a multiple of 16, and the value of Nx is 2 or 4.

Manner 3: a part or all of the RE resources, except RE resources occupied by the DMRS, in each PRB pair for sending the ePHICH are divided into Np eREGs, wherein each eREG′ includes Nr REs, and only N (N is less than or equal to Nr) REs in each eREG are configured for ePHICH transmission; every Nx time-domain adjacent or frequency-domain adjacent eREGs in each ePHICH PRB pair form an ePHICH REG; and one or more continuous/discrete REGs from the same/different ePHICH PRB pairs form a group of ePHICH REs, wherein Np, Nx and N are all integers more than 1, and preferably, the value of Np is 16 or a multiple of 16, and the value of Nx is 2 or 4.

Manner 4: a part or all of the RE resources, except RE resources occupied by the DMRS, in each PRB pair for sending the ePHICH are divided into Np eREGs, wherein each eREG includes Nr REs, and only N (N is less than or equal to Nr) REs in each eREG are configured for ePHICH transmission; each PRB pair for sending the ePHICH is simultaneously divided into multiple REG areas, wherein each REG area includes one or more subcarriers on the frequency domain, and includes one or more OFDM symbols on the time domain; every Nx time-domain adjacent or frequency-domain adjacent eREGs in each REG area form an ePHICH REG; and one or more continuous/discrete REGs from the same/different ePHICH PRB pairs form a group of ePHICH REs, wherein Np, Nx and N are all integers more than 1, and preferably, the value of Np is 16 or a multiple of 16, and the value of Nx is 2 or 4.

Manner 5: a part or all of the RE resources, except RE resources occupied by the DMRS, in each PRB pair for sending the ePHICH are divided into Np eREGs, wherein only M (M is less than Np) eREGs may be configured for ePHICH transmission; every Nx time-domain adjacent or frequency-domain adjacent available eREG's in each ePHICH PRB pair form an ePHICH REG; and one or more continuous/discrete REGs from the same/different ePHICH PRB pairs form a group of ePHICH REs, wherein Np and Nx are both integers more than 1, and preferably, the value of Np is 16 or a multiple of 16, and the value of Nx is 2 or 4.

Manner 6: a part or all of the RE resources, except RE resources occupied by the DMRS, in each PRB pair for sending the ePHICH are divided into Np eREGs, wherein only M (M is less than Np) eREGs may be configured for ePHICH transmission; each PRB pair for sending the ePHICH is simultaneously divided into multiple REG areas, wherein each REG area includes one or more subcarriers on the frequency domain, and includes one or more OFDM symbols on the time domain; every Nx time-domain adjacent or frequency-domain adjacent available eREGs in each REG area form an ePHICH REG; and one or more continuous/discrete REGs from the same/different ePHICH PRB pairs form a group of ePHICH REs, wherein Np and Nx are both integers more than 1, and preferably, the value of Np is 16 or a multiple of 16, and the value of Nx is 2 or 4.

Manner 7: a part or all of the RE resources, except RE resources occupied by the DMRS, in each PRB pair for sending the ePHICH are divided into Np eREGs, wherein only M (M is less than Np) eREGs may be configured for ePHICH transmission, and if each available eREG′ includes Nr REs, only N (N is less than or equal to Nr) REs in each available eREG′ may be configured for ePHICH transmission; every Nx time-domain adjacent or frequency-domain adjacent eREGs in each ePHICH PRB pair form an ePHICH REG; and one or more continuous/discrete REGs from the same/different ePHICH PRB pairs form a group of ePHICH REs, wherein Np, Nx and N are all integers more than 1, and preferably, the value of Np is 16 or a multiple of 16, and the value of Nx is 2 or 4. Manner 8: a part or all of the RE resources, except RE resources occupied by the DMRS, in each PRB pair for sending the ePHICH are divided into Np eREGs, wherein only M (M is less than Np) eREGs may be configured for ePHICH transmission, and if each eREG includes Nr REs, only N (N is less than or equal to Nr) REs in each available eREG′ are configured for ePHICH transmission; each PRB pair for sending the ePHICH is simultaneously divided into multiple REG areas, wherein each REG area includes one or more subcarriers on the frequency domain, and includes one or more OFDM symbols on the time domain; every Nx time-domain adjacent or frequency-domain adjacent eREGs in each REG area form an ePHICH REG; and one or more continuous/discrete REGs from the same/different ePHICH PRB pairs form a group of ePHICH REs, wherein Np, Nx and N are all integers more than 1, and preferably, the value of Np is 16 or a multiple of 16, and the value of Nx is 2 or 4.

In an example embodiment, corresponding to the eight example implementation modes, that one or more continuous/discrete REGs from the same/different ePHICH PRB pairs form a group of ePHICH REs includes that: every Nx frequency-domain or time-domain adjacent eREG's form an REG, and each REG forms an ePHICH group resource.

In an example embodiment, corresponding to the eight example implementation modes, that one or more continuous/discrete REGs from the same/different ePHICH PRB pairs form a group of ePHICH REs includes that: every Nx frequency-domain or time-domain adjacent eREGs form an REG, and every Ny continuous REGs from one ePHICH PRB pair form an ePHICH group resource.

In an example embodiment, corresponding to the eight example implementation modes, that one or more continuous/discrete REGs from the same/different ePHICH PRB pairs form a group of ePHICH REs includes that: every Nx frequency-domain or time-domain adjacent eREGs form an REG, every Ny discrete REGs from one ePHICH PRB pair form an ePHICH group resource, and preferably, an average distance of locations of the Ny discrete REGs in the ePHICH PRB pair is as long as possible, and the Ny discrete REGs in the ePHICH PRB pair are uniformly distributed.

In an example embodiment, corresponding to the eight example implementation modes, that one or more continuous/discrete REGs from the same/different ePHICH PRB pairs form a group of ePHICH REs includes that: every Nx frequency-domain or time-domain adjacent eREGs form an REG, every Ny discrete REGs from multiple ePHICH PRB pairs form an ePHICH group resource, and preferably, an average distance of locations of the Ny discrete REGs from the multiple ePHICH PRB pairs is as long as possible, and the Ny discrete REGs from the multiple ePHICH PRB pairs are uniformly distributed.

In an example embodiment, corresponding to the eight example implementation modes, the value of N and selection of the N REs in the eREGs/available eREGs are predetermined by the network side and the terminal side or determined according to one or more of parameters such as a sub-frame type, a CP length, the number of CRS ports and a PDCCH symbol number.

In an example embodiment, on the PRB pairs for sending the ePHICH, a PDSCH/ePDCCH is allowed to multiplexed the same PRB pairs with the ePHICH in a rate matching manner.

In an example embodiment, the number ePHICH of the orthogonal sequences is predetermined by the network side and the terminal side, each orthogonal sequence corresponds to a fixed index value n_{ePHICH}^{seq}, and preferably, orthogonal mask sequences are adopted as the orthogonal sequences.

In an example embodiment, the network side directly notifies the group index group seq n_{ePHICH}^{group} and the intra-group sequence index n_{ePHICH}^{seq} to the terminal side through a system message or higher-layer signalling.

In an example embodiment, the network side indicates the group index n_{ePHICH}^{group} to the terminal side through the system message or the higher-layer signalling, and indicates the intra-group sequence index n_{ePHICH}^{seq} to the terminal side through the physical-layer signalling.

In an example embodiment, the network side notifies the group index (ePHICH and the intra-group sequence index n_{ePHICH}^{seq} to the terminal side through the physical-layer signalling.

In an example embodiment, the network side configures values of multiple sets group seq of (n_{ePHICH}^{group}, n_{ePHICH}^{seq}) to the terminal side through the higher-layer signalling, and notifies one or more preset sets in the multiple sets to the terminal side for ePHICH transmission through the physical-layer signalling.

In an example embodiment, the network side determines the value of (n_{ePHICH}^{group}, n_{ePHICH}^{seq}) of the ePHICH resources according to one or more of parameters such as a lowest PRB index of a PUSCH responded to the ePHICH, a DRMS domain value in uplink authorization information of a PDCCH corresponding to the PUSCH responded to the ePHICH and a sub-frame where the PUSCH responded to the ePHICH is located.

### Preferred Embodiment 2

An method for defining and indicating an ePHICH resource is provided in the example embodiment, and the method includes the following Step 502 to Step 508.

Step 502: a network side configures PRB pairs for sending an ePHICH to a terminal side, and notifies resource information to the terminal side.

Step 504: the network side divides the PRB pairs for sending the ePHICH into N_{ePHICH}^{group} groups of ePHICH REs (also called ePHICH group resources hereinafter) in a predetermined manner.

Step 506: the network side configures group indexes and intra-group orthogonal sequence indexes to the terminal side, and notifies the information to the terminal side.

Step 508: the terminal side receives the resource indication information in Step 502 and Step 506, finds its ePHICH resource locations on the ePHICH PRB pairs configured to the terminal side under the indication according to the group indexes and the intra-group sequence indexes in a predetermined manner, and receives the ePHICH.

In an example manner, for Step 502, the PRB pair resources for sending the ePHICH are notified to the terminal side through a system message or RRC signalling, or are determined by the network side and the terminal side in a predetermined manner. Preferably, the PRB pair resources, configured to the terminal side by the network side, for sending the ePHICH are a part or all of the RE resources of the PRB pairs, configured to the terminal side, for ePDCCH blind detection, or the PRB pair resources, configured to the terminal side by the network side, for ePDCCH blind detection are a part or all of the RE resources of the PRB pairs, configured to the terminal side, for sending the ePHICH. Wherein, the PRB pair resources include sub-frame locations of the PRB pairs on the time domain and PRB location indexes on the frequency domain.

Each PRB pair comprises two PRBs on a sub-frame, wherein the two PRBs may comprise the same frequency-domain subcarriers, and may also comprise different frequency-domain subcarriers, for example, one PRB comprises subcarrier 0 to subcarrier 11 and the other PRB comprises subcarrier 24 to subcarrier 35.

In an example embodiment, for Step 504, the PRB pair resources for sending the ePHICH are divided into the N_{ePHICH}^{group} groups of ePHICH REs (also called ePHICH group resources hereinafter), wherein N_{ePHICH}^{seq} ePHICHs are multiplexed on the same group of ePHICH REs through different orthogonal sequences; an ePHICH resource is defined by an index pair (n_{ePHICH}^{group}, n_{ePHICH}^{seq}), n_{ePHICH}^{seq} is an ePHICH group index, n_{ePHICH}^{seq} is an ePHICH intra-group orthogonal sequence index, n_{ePHICH}^{group} and n_{ePHICH}^{seq} ε[0, N_{ePHICH}^{seq}−1].

Wherein, ePHICH is predetermined by the network side and the terminal side or notified to the terminal side through the system message or indirectly determined according to one or more of parameters such as a cell ID, the number of PRBs configured to the ePHICH, a sub-frame type, a sub-frame number and a CP length, and the value of N_{ePHICH}^{seq} is related to the adopted orthogonal sequence.

A part or all of the REs in each ePHICH PRB pair are divided into multiple ePHICH REGs, and ePHICH REGs from the same/different ePHICH PRB pairs form an ePHICH group resource. All the ePHICH group resources are ranked and indexed according to a certain rule, and each ePHICH group resource corresponds a fixed index value n_{ePHICH}^{group}.

In addition, a part or all of the REs, except RE resources occupied by DMRS, in each PRB pair for sending the ePHICH are divided into Np eREGs, wherein the number of valid REs included in each eREG is dependent on factors such as a sub-frame type, a CP length, the number of CRS ports and a PDCCH symbol number; and Np is an integer more than 1, and preferably, a value of Np is 16 or an integral multiple of 16.

In order to unify the REG division manner, it is supposed that the number of the REs in each eREG is Nr, but only fixed N (N is less than or equal to Nr) REs in the Nr REs are used for the ePHICH. When N is less than Nr, the N REs may be the first N REs or the later N REs or N equally-spaced REs or the first N non-CRS and/or PDCCH and/or CSI-RS REs or the later N non-CRS and/or PDCCH and/or CSI-RS REs or the like of each eREG. Wherein, the value of N and the selection of the N REs are predetermined by the network side and the terminal side, or are indirectly determined according to at least one of parameters such as a sub-frame type, a CP length, the number of CRS ports and a PDCCH symbol number.

Every Nx frequency-domain or time-domain adjacent eREGs form an REG, and one or more REGs from the same/different sources form an ePHICH group resource; or

every Nx adjacent eREGs in each REG area form a REG, and one or more REGs from the same/different sources form an ePHICH group resource.

Wherein, the REG areas are divided for each ePHICH PRB pair.

Specifically, the following may be included:

every Nx frequency-domain or time-domain adjacent eREGs form an REG, and each REG is an ePHICH group resource; or,

every Nx frequency-domain or time-domain adjacent eREGs form an REG, and every Ny continuous REGs from one ePHICH PRB pair form an ePHICH group resource; or,

every Nx frequency-domain or time-domain adjacent eREGs form an REG, every Ny discrete REGs from one ePHICH PRB pair form an ePHICH group resource, and preferably, an average distance of locations of the Ny discrete REGs in the ePHICH PRB pair is as long as possible, and the Ny discrete REGs in the ePHICH PRB pair are uniformly distributed; or,

every Nx frequency-domain or time-domain adjacent eREGs form an REG, every Ny discrete REGs from multiple ePHICH PRB pairs form an ePHICH group resource, and preferably, an average distance of locations of the Ny discrete REGs in the multiple ePHICH PRB pairs is as long as possible, and the Ny discrete REGs in the multiple ePHICH PRB pairs are uniformly distributed; or,

every Nx adjacent eREGs in each REG area form an REG, and every Ny continuous REGs from one ePHICH PRB pair form an ePHICH group resource; or,

every Nx adjacent eREGs in each REG area form an REG, every Ny discrete REGs from one ePHICH PRB pair form an ePHICH group resource, and preferably, an average distance of locations of the Ny discrete REGs in the ePHICH PRB pair is as long as possible, and the Ny discrete REGs in the ePHICH PRB pair are uniformly distributed; or,

every Nx adjacent eREGs in each REB area form an REG, every Ny discrete REGs from multiple ePHICH PRB pairs form an ePHICH group resource, and preferably, an average distance of locations of the Ny discrete REGs in the multiple ePHICH PRB pairs is as long as possible, and the Ny discrete REGs in the multiple ePHICH PRB pairs are uniformly distributed.

Wherein, Nx and Ny are both integers more than or equal to 1, and preferably, a value of Nx is 2 or 4. If the number of ePHICH PRB pairs configured to a specific terminal by the network side is N_{PRB}, each PRB pair is divided into N_{REC} REGs, each ePHICH is form of N_{C} REGs, and the N_{C} REGs are located in the same or different PRB pairs, the number of ePHICH group resources is

$${N}_{ePHICH}^{group} = \frac{{N}_{PRB} \cdot {N}_{REC}}{{N}_{C}} .$$

If there are totally N_{ePHICH}^{seq} different orthogonal sequences, and each orthogonal sequence corresponds to a unique index n_{ePHICH}^{seq}, maximally N_{ePHICH}^{seq} ePHICHs may be multiplexed on an ePHICH resource. Preferably, different orthogonal sequences adopt different orthogonal masks. For example: an orthogonal mask with a length of 2 totally corresponds to four different orthogonal values, as shown in Table 6, and then maximally four ePHICHs may be multiplexed on one ePHICH group resource. An orthogonal mask with a length of 4 totally corresponds to eight different orthogonal values, as shown in Table 7, and then maximally eight ePHICHs may be multiplexed on one ePHICH group resource.

TABLE 6
Orthogonal Mask with Length of 2

| n_{ePHICH}^{seq} | The value of orthogonal mask |
|---|---|
| 0 | [+1 +1] |
| 1 | [+1 −1] |
| 2 | [+j +j] |
| 3 | [+j −j] |

TABLE 7
Orthogonal Mask with Length of 4

| n_{ePHICH}^{seq} | The value of orthogonal mask |
|---|---|
| 0 | [+1 +1 +1 +1] |
| 1 | [+1 −1 +1 −1] |
| 2 | [+1 +1 −1 −1] |
| 3 | [+1 −1 −1 +1] |
| 4 | [+j +j +j +j] |
| 5 | [+j −j +j −j] |
| 6 | [+j +j −j −j] |
| 7 | [+j −j −j +j] |

Preferably, for Step 506, the network side allocates the ePHICH resources to the terminal side, and indicates the ePHICH resources to the terminal side, and indication manners include at least one of:

Manner 1: the network side directly notifies the group index n_{ePHICH}^{group} and the intra-group sequence index n_{ePHICH}^{seq} to the terminal side through the system message or the higher-layer signalling;

Manner 2: the network side indicates the group index n_{ePHICH}^{group} to the terminal side through the system message or the higher-layer signalling, and indicates the intra-group sequence index n_{ePHICH}^{seq} to the terminal side through the physical-layer signalling;

Manner 3: the network side notifies the group index n_{ePHICH}^{group} and the intra-group sequence index n_{ePHICH}^{group} to the terminal side through the physical-layer signalling;

Manner 4: the network side configures values of multiple sets of (n_{ePHICH}^{group}, n_{ePHICH}^{seq}) to the terminal side through the higher-layer signalling, and notifies one or more preset sets in the multiple sets to the terminal side for ePHICH transmission through the physical-layer signalling; and

Manner 5: the network side determines the value of (n_{ePHICH}^{group}, n_{ePHICH}^{seq}) of the ePHICH resources according to one or more of parameters such as a lowest PRB index of a PUSCH responded by the ePHICH, a DRMS domain value in uplink authorization information of a PDCCH corresponding to the PUSCH responded by the ePHICH and a sub-frame where the PUSCH responded by the ePHICH is located.

For example:

n_{ePHICH}^{group}=(I_{PRB}_{_{—}}_{RA}+n_{DMRS})mod N_{ePHICH}^{group}

n_{ePHICH}^{seq}=(└I_{PRB}_{_{—}}_{RA}/N_{ePHICH}^{group}┘+n_{DMRS})mod N_{ePHICH}^{seq}

or:

n_{ePHICH}^{group}=(I_{PRB}_{_{—}}_{RA}+n_{DMRS})mod N_{ePHICH}^{group}+I_{ePHICH}N_{ePHICH}^{group}

n_{ePHICH}^{seq}=(└I_{PRB}_{_{—}}_{RA}/N_{ePHICH}^{group}┘+n_{DMRS})mod N_{ePHICH}^{seq}

or:

n_{ePHICH}^{group}=(I_{PRB}_{_{—}}_{RA}+n_{DMRS}+└nₛ/2┘)mod N_{ePHICH}^{group}

n_{ePHICH}^{seq}=(└I_{PRB}_{_{—}}_{RA}/N_{ePHICH}^{group}┘+n_{DMRS}+└nₛ/2┘)mod N_{ePHICH}^{seq}

Wherein, I_{PRB}_{_{—}}_{RA} is the lowest PRB index of the responded PUSCH or sum of the lowest PRB index and 1, n_{DMRS} is the DMRS domain value in the uplink authorization information of the PDCCH corresponding to the PUSCH, nₛ is the sub-frame where the PUSCH is located, and I_{ePHICH} is equal to 0 or 1.

The modes for defining the ePHICH resource are described in the following preferred embodiment 3 to preferred embodiment 11.

### Preferred Embodiment 3

In the embodiment, it is supposed that there are totally N_{PRB} PRB pairs for sending an ePHICH, wherein the number and locations of the ePHICH PRB pairs are notified to a terminal side by a network side through a system message or higher-layer signalling or determined by the network side and the terminal side in a predetermined manner. Wherein, N_{PRB} is a non-negative integer, and is preferably equal to 1, 2, 4, 8 or 16.

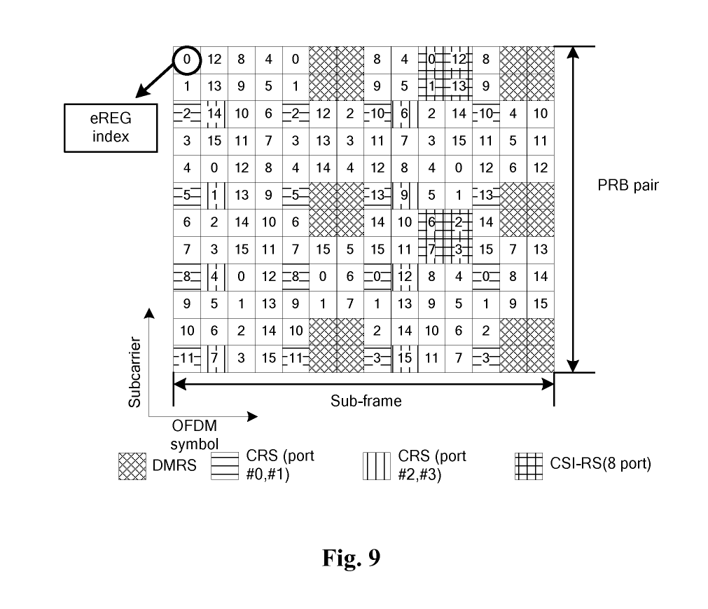

The method includes: the REs, except RE resources occupied by DMRS, in each PRB pair for sending the ePHICH are divided into 16 eREG's ('added here mainly for distinguishing from eREGs in an ePDCCH), and the REs in each PRB pair are sequentially allocated to each eREG in a manner of first time domain after frequency domain, for example, as shown in FIG. 9.

A PRB pair for sending the ePHICH includes multiple ePHICH REGs. In each ePHICH PRB pair, every two frequency-domain adjacent eREGs form an ePHICH REG, as shown in Table 8:

TABLE 8
Manner for Forming the ePHICH REG

| ePHICH REG# | eREG# |
|---|---|
| 0 | {0, 1} |
| 1 | {2, 3} |
| 2 | {4, 5} |
| 3 | {6, 7} |
| 4 | {8, 9} |
| 5 | {10, 11} |
| 6 | {12, 13} |
| 7 | {14, 15} |

Wherein, the first column “ePHICH REG#” in Table 8 represents the index of the ePHICH REG, and the second column “eREG#” represents the index of the eREG.

Multiple REGs forming an ePHICH group resource are from the same or different ePHICH PRB pairs. It is supposed that an ePHICH group resource consists of N_{REC} REGs, wherein N_{REC} is an integer more than or equal to 1. Preferably, N_{REC} is equal to 1, 2 or 4.

Manners for dividing the ePHICH group resources under the conditions of N_{PRB}, N_{REC} ε{1,2,4} are described below in detail respectively, and the same rules may be applied to the conditions that N_{PRB} and N_{REC} are equal to other values.

Under the condition that N_{PRB} is equal to 1: N_{REC} REGs included in an ePHICH group resource are located in the same PRB pair, and Table 9 shows an ePHICH group resource division condition when each ePHICH includes one REG (N_{REC}=1):

TABLE 9
N_{PRB} = 1, N_{REC} = 1

| ePHICH | PPRB#0 |
|---|---|
| group# | REG# |
| 0 | 0 |
| 1 | 1 |
| 2 | 2 |
| 3 | 3 |
| 4 | 4 |
| 5 | 5 |
| 6 | 6 |
| 7 | 7 |

When N_{REC} is more than 1, there may be two conditions for the formation of the ePHICH group resource:

1) N_{REC} continuous REGs form an ePHICH group resource, and its forming manner may be shown in Tables 10˜11:

TABLE 10
N_{PRB} = 1 and N_{REC} = 2, Continuous REGs

| ePHICH | PRB#0 |
|---|---|
| group# | REG# |
| 0 | {0, 1} |
| 1 | {2, 3} |
| 2 | {4, 5} |
| 3 | {6, 7} |

TABLE 11
N_{PRB} = 1 and N_{REC} = 4, Continuous REGs

| ePHICH | PRB#0 |
|---|---|
| group# | REG# |
| 0 | {0, 1, 2, 3} |
| 1 | {4, 5, 6, 7} |

Wherein, “ePHICH group#” represents the index of the ePHICH group resource.

2) An ePHICH group resource consists of N_{REC} discrete REGs in a PRB pair, distances of the REG indexes are preferably as long as possible and equal, and its forming manner is typically shown in Tables 12˜13:

TABLE 12
N_{PRB} = 1 and N_{REC} = 2, Discrete REGs

| ePHICH | PRB#0 |
|---|---|
| group# | REG# |
| 0 | {0, 4} |
| 1 | {1, 5} |
| 2 | {2, 6} |
| 3 | {3, 7} |

TABLE 13
N_{PRB} = 1 and N_{REC} = 4, Discrete REGs

| ePHICH | PRB#0 |
|---|---|
| group# | REG# |
| 0 | {0, 2, 4, 6} |
| 1 | {1, 3, 5, 7} |

Under the condition that N_{PRB} is equal to 2:

N_{REC} REGs included in an ePHICH group resource are located in the same or different PRB pairs, and Table 14 shows an ePHICH group resource division condition when each ePHICH includes one REG (N_{REC}=1):

TABLE 14
N_{PRB} = 1, N_{REC} = 1

| ePHICH | PRB#0 | PRB#1 |
|---|---|---|
| group# | REG# | REG# |
| 0 | 0 | |
| 1 | 1 | |
| 2 | 2 | |
| 3 | 3 | |
| 4 | 4 | |
| 5 | 5 | |
| 6 | 6 | |
| 7 | 7 | |
| 8 | | 0 |
| 9 | | 1 |
| 10 | | 2 |
| 11 | | 3 |
| 12 | | 4 |
| 13 | | 5 |
| 14 | | 6 |
| 15 | | 7 |

When N_{REC} is more than 1, there may be two conditions for the formation of the ePHICH group resource:

1) N_{REC} continuous REGs form an ePHICH group resource, and its forming manner is typically shown in Tables 15˜16:

TABLE 15
N_{PRB} = 2, N_{REC} = 2, Continuous REGs

| ePHICH | PRB#0 | PRB#1 |
|---|---|---|
| group# | REG# | REG# |
| 0 | {0, 1} | |
| 1 | {2, 3} | |
| 2 | {4, 5} | |
| 3 | {6, 7} | |
| 4 | | {0, 1} |
| 5 | | {2, 3} |
| 6 | | {4, 5} |
| 7 | | {6, 7} |

TABLE 16
N_{PRB} = 2, N_{REC} = 4, Continuous REGs

| ePHICH | PRB#0 | PRB#1 |
|---|---|---|
| group# | REG# | REG# |
| 0 | {0, 1, 2, 3} | |
| 1 | {4, 5, 6, 7} | |
| 4 | | {0, 1, 2, 3} |
| 5 | | {4, 5, 6, 7} |

2) An ePHICH group resource consists of N_{REC} discrete REGs in a PRB pair, distances of the discrete REG indexes are preferably as long as possible and equal, and its forming manner is typically shown in Tables 17˜18:

TABLE 17
N_{PRB} = 2, N_{REC} = 2, Discrete REGs

| ePHICH | PRB#0 | PRB#1 |
|---|---|---|
| group# | REG# | REG# |
| 0 | 0 | 4 |
| 1 | 1 | 5 |
| 2 | 2 | 6 |
| 3 | 3 | 7 |
| 4 | 4 | 0 |
| 5 | 5 | 1 |
| 6 | 6 | 2 |
| 7 | 7 | 3 |

TABLE 18
N_{PRB} = 2, N_{REC} = 4, Discrete REGs

| ePHICH | PRB#0 | PRB#1 |
|---|---|---|
| group# | REG# | REG# |
| 0 | {0, 4} | {2, 6} |
| 1 | {1, 5} | {3, 7} |
| 2 | {2, 6} | {4, 0} |
| 3 | {3, 7} | {5, 1} |

Under the condition that N_{PRB} is equal to 4:

N_{REC} REGs included in an ePHICH group resource are located in the same PRB pair, and Table 19 shows an ePHICH group resource division condition when each ePHICH includes one REG (N_{REC}=1):

TABLE 19
N_{PRB} = 4, N_{REC} = 1

| ePHICH | PRB#0 | PRB#1 | PRB#2 | PRB#3 |
|---|---|---|---|---|
| group# | REG# | REG# | REG# | REG# |
| 0 | 0 | | | |
| 1 | 1 | | | |
| 2 | 2 | | | |
| 3 | 3 | | | |
| 4 | 4 | | | |
| 5 | 5 | | | |
| 6 | 6 | | | |
| 7 | 7 | | | |
| 8 | | 0 | | |
| 9 | | 1 | | |
| 10 | | 2 | | |
| 11 | | 3 | | |
| 12 | | 4 | | |
| 13 | | 5 | | |
| 14 | | 6 | | |
| 15 | | 7 | | |
| 16 | | | 0 | |
| 17 | | | 1 | |
| 18 | | | 2 | |
| 19 | | | 3 | |
| 20 | | | 4 | |
| 21 | | | 5 | |
| 22 | | | 6 | |
| 23 | | | 7 | |
| 24 | | | | 0 |
| 25 | | | | 1 |
| 26 | | | | 2 |
| 27 | | | | 3 |
| 28 | | | | 4 |
| 29 | | | | 5 |
| 30 | | | | 6 |
| 31 | | | | 7 |

When N_{REC} is more than 1, there may be two conditions for the formation of the ePHICH group resource:

1) N_{REC} continuous REGs form an ePHICH group resource, and its forming manner is typically shown in Tables 20˜21:

TABLE 20
N_{PRB} = 4, N_{REC} = 2, Continuous REGs

| ePHICH | PRB#0 | PRB#1 | PRB#2 | PRB#3 |
|---|---|---|---|---|
| group# | REG# | REG# | REG# | REG# |
| 0 | {0, 1} | | | |
| 1 | {2, 3} | | | |
| 2 | {4, 5} | | | |
| 3 | {6, 7} | | | |
| 4 | | {0, 1} | | |
| 5 | | {2, 3} | | |
| 6 | | {4, 5} | | |
| 7 | | {6, 7} | | |
| 8 | | | {0, 1} | |
| 9 | | | {2, 3} | |
| 10 | | | {4, 5} | |
| 11 | | | {6, 7} | |
| 12 | | | | {0, 1} |
| 13 | | | | {2, 3} |
| 14 | | | | {4, 5} |
| 15 | | | | {6, 7} |

TABLE 21
N_{PRB} = 4, N_{REC} = 4, Continuous REGs

| ePHICH | PRB#0 | PRB#1 | PRB#2 | PRB#3 |
|---|---|---|---|---|
| group# | REG# | REG# | REG# | REG# |
| 0 | {0, 1, 2, 3} | | | |
| 1 | {4, 5, 6, 7} | | | |
| 4 | | {0, 1, 2, 3} | | |
| 6 | | {4, 5, 6, 7} | | |
| 8 | | | {0, 1, 2, 3} | |
| 9 | | | {4, 5, 6, 7} | |
| 12 | | | | {0, 1, 2, 3} |
| 13 | | | | {4, 5, 6, 7} |

2) An ePHICH group resource consists of N_{REC} discrete REGs in a PRB pair, distances of the discrete REG indexes are preferably as long as possible and equal, and its forming manner is typically shown in Tables 22˜23:

TABLE 22
N_{PRB} = 4, N_{REC} = 2, Discrete REGs (Manner 1)

| ePHICH | PRB#0 | PRB#1 | PRB#2 | PRB#3 |
|---|---|---|---|---|
| group# | REG# | REG# | REG# | REG# |
| 0 | 0 | | 4 | |
| 1 | | 2 | | 6 |
| 2 | 6 | | 2 | |
| 3 | | 0 | | 4 |
| 4 | 4 | | 0 | |
| 5 | | 6 | | 2 |
| 6 | 2 | | 6 | |
| 7 | | 4 | | 0 |
| 8 | 1 | | 5 | |
| 9 | | 3 | | 7 |
| 10 | 7 | | 3 | |
| 11 | | 1 | | 5 |
| 12 | 5 | | 1 | |
| 13 | | 7 | | 3 |
| 14 | 3 | | 7 | |
| 15 | | 5 | | 1 |

TABLE 23
N_{PRB} = 4, N_{REC} = 2, Discrete REGs (Manner 2)

| ePHICH | PRB#0 | PRB#1 | PRB#2 | PRB#3 |
|---|---|---|---|---|
| group# | REG# | REG# | REG# | REG# |
| 0 | 0 | | 4 | |
| 1 | | 1 | | 5 |
| 2 | 2 | | 6 | |
| 3 | | 3 | | 7 |
| 4 | 4 | | 0 | |
| 5 | | 5 | | 1 |
| 6 | 6 | | 2 | |
| 7 | | 7 | | 3 |
| 8 | 1 | | 5 | |
| 9 | | 0 | | 4 |
| 10 | 3 | | 7 | |
| 11 | | 2 | | 6 |
| 12 | 5 | | 1 | |
| 13 | | 4 | | 0 |
| 14 | 7 | | 3 | |
| 15 | | 6 | | 2 |

TABLE 24
N_{PRB} = 4, N_{REC} = 2, Discrete REGs (Manner 3)

| ePHICH | PRB#0 | PRB#1 | PRB#2 | PRB#3 |
|---|---|---|---|---|
| group# | REG# | REG# | REG# | REG# |
| 0 | 0 | | 4 | |
| 1 | | 0 | | 4 |
| 2 | 1 | | 5 | |
| 3 | | 1 | | 5 |
| 4 | 2 | | 6 | |
| 5 | | 2 | | 6 |
| 6 | 3 | | 7 | |
| 7 | | 3 | | 7 |
| 8 | 4 | | 0 | |
| 9 | | 4 | | 0 |
| 10 | 5 | | 1 | |
| 11 | | 5 | | 1 |
| 12 | 6 | | 2 | |
| 13 | | 6 | | 2 |
| 14 | 7 | | 3 | |
| 15 | | 7 | | 3 |

TABLE 25
N_{PRB} = 4, N_{REC} = 2, Discrete REGs (Manner 4)

| ePHICH | PRB#0 | PRB#1 | PRB#2 | PRB#3 |
|---|---|---|---|---|
| group# | REG# | REG# | REG# | REG# |
| 0 | 0 | | 4 | |
| 1 | | 0 | | 4 |
| 2 | 2 | | 6 | |
| 3 | | 2 | | 6 |
| 4 | 4 | | 0 | |
| 5 | | 4 | | 0 |
| 6 | 6 | | 2 | |
| 7 | | 6 | | 2 |
| 8 | 1 | | 5 | |
| 9 | | 1 | | 5 |
| 10 | 3 | | 7 | |
| 11 | | 3 | | 7 |
| 12 | 5 | | 1 | |
| 13 | | 5 | | 1 |
| 14 | 7 | | 3 | |
| 15 | | 7 | | 3 |

TABLE 26
N_{PRB} = 4, N_{REC} = 4, Discrete REGs (Manner 1)

| ePHICH | PRB#0 | PRB#1 | PRB#2 | PRB#3 |
|---|---|---|---|---|
| group# | REG# | REG# | REG# | REG# |
| 0 | 0 | 2 | 4 | 6 |
| 1 | 2 | 4 | 6 | 0 |
| 2 | 4 | 6 | 0 | 2 |
| 3 | 6 | 0 | 2 | 4 |
| 4 | 1 | 3 | 5 | 7 |
| 5 | 3 | 5 | 7 | 1 |
| 6 | 5 | 7 | 1 | 3 |
| 7 | 7 | 1 | 3 | 5 |

TABLE 27
N_{PRB} = 4, N_{REC} = 4, Discrete REG (Manner 2)

| ePHICH | PRB#0 | PRB#1 | PRB#2 | PRB#3 |
|---|---|---|---|---|
| group# | REG# | REG# | REG# | REG# |
| 0 | 0 | 2 | 4 | 6 |
| 1 | 1 | 5 | 3 | 7 |
| 2 | 2 | 4 | 6 | 0 |
| 3 | 3 | 5 | 7 | 1 |
| 4 | 4 | 6 | 0 | 2 |
| 5 | 5 | 7 | 1 | 3 |
| 6 | 6 | 0 | 2 | 4 |
| 7 | 7 | 1 | 3 | 5 |

It is important to note that the REGs forming the ePHICH groups in Tables 6˜27 are shown in Tables 6˜27, but ePHICH group indexes may be randomly arranged, not limited to sequences described in Tables 6˜22, and in Tables 6˜27, only one possible arrangement sequence of the ePHICH groups is presented in order to facilitate description. For example, the arrangement sequence in Table 8 may further be shown in Table 28:

TABLE 28
Manner for Forming ePHICH REGs

| ePHICH REG# | eREG# |
|---|---|
| 0 | {0, 1} |
| 1 | {4, 5} |
| 2 | {8, 9} |
| 3 | {12, 13} |
| 4 | {2, 3} |
| 5 | {6, 7} |
| 6 | {10, 11} |
| 7 | {14, 15} |

### Preferred Embodiment 4

In the embodiment, it is supposed that there are totally N_{PRB} PRB pairs for sending an ePHICH, wherein the number and locations of the ePHICH PRB pairs are notified to a terminal side by a network side through a system message or higher-layer signalling or determined by the network side and the terminal side in a predetermined manner. Wherein, N_{PRB} is a non-negative integer.

REs, except RE resources occupied by DMRS, in each PRB pair for sending the ePHICH are divided into 16 eREG's, and the REs in each PRB pair are sequentially allocated to each eREG′ in a manner of first time domain after frequency domain, for example, as shown in FIG. 3.

A PRB pair for sending the ePHICH includes multiple ePHICH REGs. In each ePHICH PRB pair, every two time-domain adjacent eREG's form an ePHICH REG, as shown in Table 29:

TABLE 29
Manner for forming the ePHICH REGs

| ePHICH REG# | eREG# |
|---|---|
| 0 | {0, 12} |
| 1 | {1, 13} |
| 2 | {2, 14} |
| 3 | {3, 15} |
| 4 | {4, 8} |
| 5 | {5, 9} |
| 6 | {6, 10} |
| 7 | {7, 11} |

Wherein, the first column “ePHICH REG#” in Table 29 represents the index of the ePHICH REG, and the second column “eREG#” represents the index of the eREG.

It is important to note that the division manner for the ePHICH REGs under a conventional CP condition of a Frequency Division Duplex (FDD) system is described in Table 29, and similar methods may be applied to an extended CP condition and a special sub-frame condition of a Time Division Duplex (TDD) system. Similarly, similar to Tables 6˜25, ePHICH REG indexes in Table 27 may be arranged in other sequences.

Multiple ePHICHs are mapped onto the same group of ePHICH REs through different orthogonal sequences. Wherein, each group of ePHICH REs consists of multiple ePHICH REGs, and the multiple ePHICH REGs may be from the same PRB pair or different PRB pairs. When the multiple REGs are from the same PRB pair, localized ePHICH transmission is often formed, and when the multiple REGs are from different PRB pairs, distributed ePHICH transmission is often formed.

Specifically, the definition of ePHICH REGs to ePHICH group resources may refer to the method described in preferred embodiment 3, and will not be repeated here.

### Preferred Embodiment 5

In the embodiment, it is supposed that there are totally N_{PRB} PRB pairs for sending an ePHICH, wherein the number and locations of the ePHICH PRB pairs are notified to a terminal side by a network side through a system message or higher-layer signalling or determined by the network side and the terminal side in a predetermined manner. Wherein, N_{PRB} is a non-negative integer. Preferably, the number/locations of the PRB pairs for sending the ePHICH are the same as the number/locations of PRB pairs configured to an ePDCCH by the network side, or the number/locations of the ePHICH PRB pairs is a subset of the number/locations of the ePDCCH PRB pairs, or the number/locations of the ePDCCH PRB pairs is a subset of the number/locations of the ePHICH PRB pairs. Wherein, the locations of the PRB pairs include sub-frame locations of the PRB pairs on the time domain and PRB index locations of the PRB pairs on the frequency domain.

REs, except RE resources occupied by DMRS, in each PRB pair for sending the ePHICH are divided into 16 eREGs, and its specific division manner is the same as a division and arrangement manner for eREGs in the ePDCCH PRB pairs.

A PRB pair for sending the ePHICH includes multiple ePHICH REGs. In each ePHICH PRB pair, every two or four frequency-domain adjacent eREGs form an ePHICH REG.

Multiple ePHICHs are mapped onto the same group of ePHICH REs through different orthogonal sequences. Wherein, each group of ePHICH REs consists of multiple ePHICH REGs, and the multiple REGs may be from the same PRB pair or different PRB pairs. When the multiple REGs are from the same PRB pair, localized ePHICH transmission is often formed, and when the multiple REGs are from different PRB pairs, distributed ePHICH transmission is often formed.

The ePHICH and the ePDCCH/PDSCH are allowed to multiplexed one the same PRB pair, and the ePDCCH/PDSCH avoids a resource collision with the ePHICH in a rate matching manner.

Specifically, the definition of ePHICH REGs to ePHICH group resources may refer to the method described in preferred embodiment 3, and will not be repeated here.

### Preferred Embodiment 6

In the embodiment, it is supposed that there are totally N_{PRB} PRB pairs for sending an ePHICH, wherein the number and locations of the ePHICH PRB pairs are notified to a terminal side by a network side through a system message or higher-layer signalling or determined by the network side and the terminal side in a predetermined manner. Wherein, N_{PRB} is a non-negative integer. Preferably, the number/locations of the PRB pairs for sending the ePHICH are the same as the number/locations of PRB pairs configured to an ePDCCH by the network side, or the number/locations of the ePHICH PRB pairs is a subset of the number/locations of the ePDCCH PRB pairs, or the number/locations of the ePDCCH PRB pairs is a subset of the number/locations of the ePHICH PRB pairs. Wherein, the locations of the PRB pairs include sub-frame locations of the PRB pairs on the time domain and PRB index locations of the PRB pairs on the frequency domain.

REs, except RE resources occupied by DMRS, in each PRB pair for sending the ePHICH are divided into 16 eREG's, and its specific division manner is the same as a division and arrangement manner for eREGs in the ePDCCH PRB pairs.

A PRB pair for sending the ePHICH includes multiple ePHICH REGs. In each ePHICH PRB pair, every two or four time-domain adjacent eREG's form an ePHICH REG.

Multiple ePHICHs are mapped onto the same group of ePHICH REs through different orthogonal sequences. Wherein, each group of ePHICH REs consists of multiple ePHICH REGs, and the multiple ePHICH REGs may be from the same PRB pair or different PRB pairs. When the multiple REGs are from the same PRB pair, localized ePHICH transmission is often formed, and when the multiple REGs are from different PRB pairs, distributed ePHICH transmission is often formed.

The ePHICH and the ePDCCH/PDSCH are allowed to multiplexed on the same PRB pair, and the ePDCCH/PDSCH avoids a resource collision with the ePHICH in a rate matching manner.

Specifically, the definition of ePHICH REGs to ePHICH group resources may refer to the method described in preferred embodiment 3, and will not be repeated here.

### Preferred Embodiment 7

In the embodiment, it is supposed that there are totally N_{PRB} PRB pairs for sending an ePHICH, wherein the number and locations of the ePHICH PRB pairs are notified to a terminal side by a network side through a system message or higher-layer signalling or determined by the network side and the terminal side in a predetermined manner. Wherein, N_{PRB} is a non-negative integer, and is preferably equal to 1, 2, 4, 8 or 16.

REs, except RE resources occupied by DMRS, in each PRB pair for sending the ePHICH are divided into 16 eREGs, and the REs in each PRB pair are sequentially allocated to each eREG in a manner of first time domain after frequency domain, for example, as shown in FIG. 9.

An ePHICH PRB pair is divided into N1 REG areas by taking a time-domain symbol or a frequency-domain subcarrier as a unit. Wherein, N1 is a non-negative integer, and preferably, the value of N1 is 2 or 4. Every two frequency-domain adjacent eREGs located in each REG area form an ePHICH REG. Tables 30˜35 show some typical manners for dividing the REG areas according to the abovementioned method:

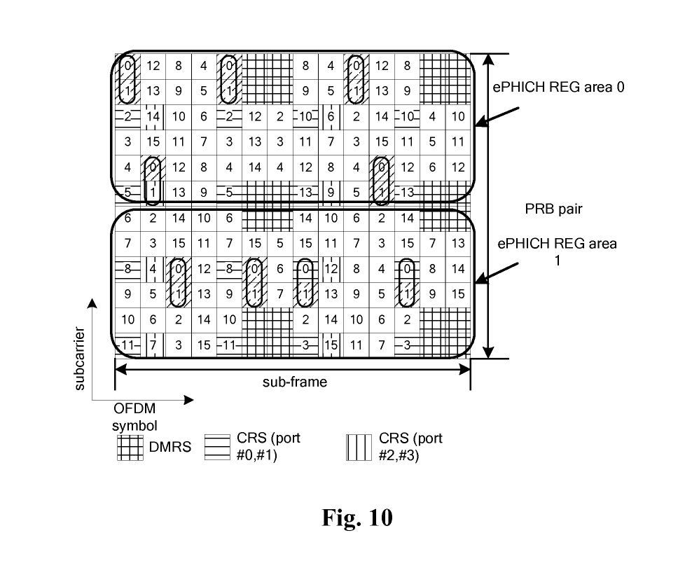

TABLE 30
N1 = 2, Frequency-Domain Division
Manner 1 (as shown in FIG. 10)

| ePHICH REG area # | Subcarrier# |
|---|---|
| 0 | {0, 1, 2, 3, 4, 5} |
| 1 | {6, 7, 8, 9, 10, 11} |

TABLE 31
N1 = 2, Frequency-Domain Division Manner 2

| ePHICH REG area # | Subcarrier# |
|---|---|
| 0 | {0, 1, 4, 5, 8, 9} |
| 1 | {2, 3, 6, 7, 10, 11} |

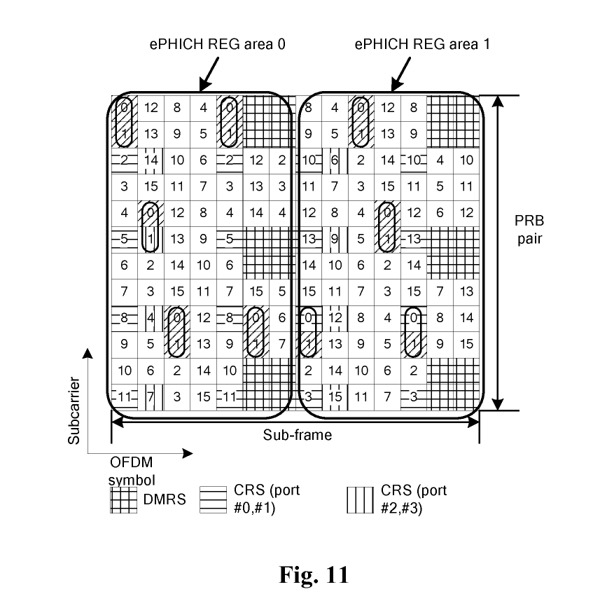

TABLE 32
N1 = 2, Time-Domain Division Manner 1 (as shown in FIG. 11)

| ePHICH REG area # | Symbol# |
|---|---|
| 0 | {0, 1, 2, 3, 4, 5, 6} |
| 1 | {7, 8, 9, 10, 11, 12, 13} |

TABLE 33
N1 = 2, Time-Domain Division Manner 2

| ePHICH REG area # | Symbol# |
|---|---|
| 0 | {0, 2, 4, 6, 8, 10, 12} |
| 1 | {1, 3, 5, 7, 9, 11, 13} |

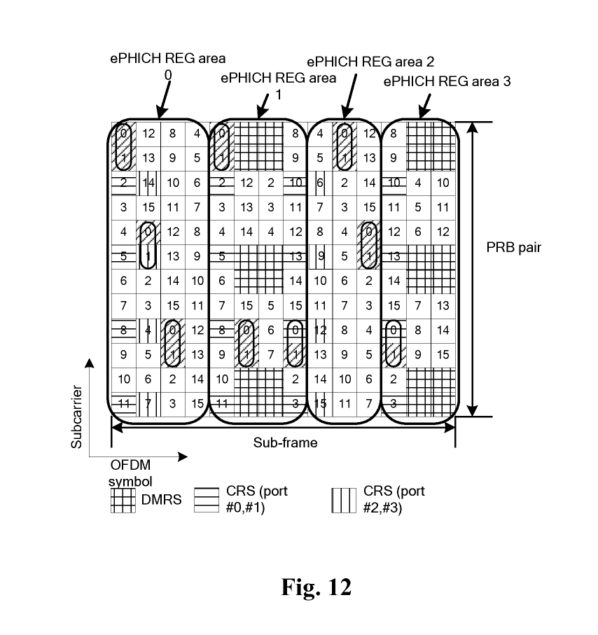

TABLE 34
N1 = 4, Time-Domain Division Manner 1 (as shown in FIG. 12)

| ePHICH REG area # | Subcarrier# |
|---|---|
| 0 | {0, 1, 2, 3} |
| 1 | {4, 5, 6, 7} |
| 2 | {8, 9, 10} |
| 3 | {11, 12, 13} |

TABLE 35
N1 = 4, Time-Domain Division Manner 2

| ePHICH REG area # | Subcarrier# |
|---|---|
| 0 | {0, 4, 8, 12} |
| 1 | {1, 5, 9, 13} |
| 2 | {2, 6, 10} |
| 3 | {3, 7, 11} |

Wherein, the first column “ePHICH REG area #” in Tables 30˜35 represents the index of ePHICH REG areas in each PRB pair, the second column “subcarrier#” represents the index of the subcarrier, and “symbol#” represents the index of the symbol.

The formation of an ePHICH group resource is described below by taking an ePHICH REG area division manner described in Table 34, and the same method may be applied to other REG area division manners. According to the above description, the division of REGs in each ePHICH PRB pair is shown in Table 36:

TABLE 36

PRB#

| ePHICH REG# | eREG′# | REG area# |
|---|---|---|
| 0 | {0, 1} | 0 |
| 1 | {2, 3} | 0 |
| 2 | {4, 5} | 0 |
| 3 | {6, 7} | 0 |
| 4 | {8, 9} | 0 |
| 5 | {10, 11} | 0 |
| 6 | {12, 13} | 0 |
| 7 | {14, 15} | 0 |
| 8 | {0, 1} | 1 |
| 9 | {2, 3} | 1 |
| 10 | {4, 5} | 1 |
| 11 | {6, 7} | 1 |
| 12 | {8, 9} | 1 |
| 13 | {10, 11} | 1 |
| 14 | {12, 13} | 1 |
| 15 | {14, 15} | 1 |
| 16 | {0, 1} | 2 |
| 17 | {2, 3} | 2 |
| 18 | {4, 5} | 2 |
| 19 | {6, 7} | 2 |
| 20 | {8, 9} | 2 |
| 21 | {10, 11} | 2 |
| 22 | {12, 13} | 2 |
| 23 | {14, 15} | 2 |
| 24 | {0, 1} | 3 |
| 25 | {2, 3} | 3 |
| 26 | {4, 5} | 3 |
| 27 | {6, 7} | 3 |
| 28 | {8, 9} | 3 |
| 29 | {10, 11} | 3 |
| 30 | {12, 13} | 3 |
| 31 | {14, 15} | 3 |

Multiple REGs forming an ePHICH group resource are from the same or different ePHICH PRB pairs. It is supposed that an ePHICH group resource consists of N_{REC} REGs, wherein N_{REC} is an integer more than or equal to 1. Preferably, N_{REC} is a multiple of N1.

Manners for dividing the ePHICH group resources under the conditions of N_{PRB} ε{1,2,4} and N_{REC}=4 are described below in detail respectively, and the same rules may be applied to the conditions that N_{PRB} and N_{REC} are equal to other values.

Under the condition that N_{PRB} is equal to 1:

there may be two conditions for the division of the ePHICH group resources:

1) four REGs included in an ePHICH group resource are located in the same PRB pair, and resource locations of the four REGs are continuous, for example, as shown in Table 37:

TABLE 37
N_{PRB} = 1, N_{REC} = 4, Continuous REGs

| ePHICH | PRB#0 |
|---|---|
| group# | REG# |
| 0 | {0, 1, 2, 3} |
| 1 | {4, 5, 6, 7} |
| 2 | {8, 9, 10, 11} |
| 3 | {12, 13, 14, 15} |
| 4 | {16, 17, 18, 19} |
| 5 | {20, 21, 22, 23} |
| 6 | {24, 25, 26, 27} |
| 7 | {28, 29, 30, 31} |

2) Four REGs included in an ePHICH group resource are located in the same PRB pair, but resource locations of the four REGs are discrete, for example, as shown in Table 38:

TABLE 38
N_{PRB} = 1, N_{REC} = 4, Discrete REGs

| ePHICH | PRB#0 |
|---|---|
| group# | REG# |
| 0 | {0, 8, 16, 24} |
| 1 | {1, 9, 17, 25} |
| 2 | {2, 10, 18, 26} |
| 3 | {3, 11, 19, 27} |
| 4 | {4, 12, 20, 28} |
| 5 | {5, 13, 21, 29} |
| 6 | {6, 14, 22, 30} |
| 7 | {7, 15, 23, 31} |

Under the condition that N_{PRB} is equal to 2:

There may be two conditions for the division of the ePHICH group resources:

1) four REGs included in an ePHICH group resource are located in the same PRB pair, and resource locations of the four REGs are continuous, for example, as shown in Table 39:

TABLE 39
N_{PRB} = 2, N_{REC} = 4, Continuous REGs

| ePHICH | PRB#0 | PRB#1 |
|---|---|---|
| group# | REG# | REG# |
| 0 | {0, 1, 2, 3} | |
| 1 | {4, 5, 6, 7} | |
| 2 | {8, 9, 10, 11} | |
| 3 | {12, 13, 14, 15} | |
| 4 | {16, 17, 18, 19} | |
| 5 | {20, 21, 22, 23} | |
| 6 | {24, 25, 26, 27} | |
| 7 | {28, 29, 30, 31} | |
| 8 | | {0, 1, 2, 3} |
| 9 | | {4, 5, 6, 7} |
| 10 | | {8, 9, 10, 11} |
| 11 | | {12, 13, 14, 15} |
| 12 | | {16, 17, 18, 19} |
| 13 | | {20, 21, 22, 23} |
| 14 | | {24, 25, 26, 27} |
| 15 | | {28, 29, 30, 31} |

2) Four REGs included in an ePHICH group resource are located in the different PRB pair, but resource locations of the four REGs are discrete, for example, as shown in Table 40:

TABLE 40
N_{PRB} = 2, N_{REC} = 4, Discrete REGs

| ePHICH | PRB#0 | PRB#1 |
|---|---|---|
| group# | REG# | REG# |
| 0 | {0, 8} | {16, 24} |
| 1 | {1, 9} | {17, 25} |
| 2 | {2, 10} | {18, 26} |
| 3 | {3, 11} | {19, 27} |
| 4 | {4, 12} | {20, 28} |
| 5 | {5, 13} | {21, 29} |
| 6 | {6, 14} | {22, 30} |
| 7 | {7, 15} | {23, 31} |
| 8 | {16, 24} | {0, 8} |
| 9 | {17, 25} | {1, 9} |
| 10 | {18, 26} | {2, 10} |
| 11 | {19, 27} | {3, 11} |
| 12 | {20, 28} | {4, 12} |
| 13 | {21, 29} | {5, 13} |
| 14 | {22, 30} | {6, 14} |
| 15 | {23, 31} | {7, 15} |

Under the condition that N_{PRB} is equal to 4:

There may be two conditions for the division of the ePHICH group resources:

1) four REGs included in an ePHICH group resource are located in the same PRB pairs, and resource locations of the four REGs are continuous, for example, as shown in Table 41:

TABLE 41
N_{PRB} = 4, N_{REC} = 4, Continuous REGs

| ePHICH | PRB#0 | PRB#1 | PRB#2 | PRB#3 |
|---|---|---|---|---|
| group# | REG# | REG# | REG# | REG# |
| 0 | {0, 1, 2, 3} | | | |
| 1 | {4, 5, 6, 7} | | | |
| 2 | {8, 9, 10, 11} | | | |
| 3 | {12, 13, 14, 15} | | | |
| 4 | {16, 17, 18, 19} | | | |
| 5 | {20, 21, 22, 23} | | | |
| 6 | {24, 25, 26, 27} | | | |
| 7 | {28, 29, 30, 31} | | | |
| 8 | | {0, 1, 2, 3} | | |
| 9 | | {4, 5, 6, 7} | | |
| 10 | | {8, 9, 10, 11} | | |
| 11 | | {12, 13, 14, 15} | | |
| 12 | | {16, 17, 18, 19} | | |
| 13 | | {20, 21, 22, 23} | | |
| 14 | | {24, 25, 26, 27} | | |
| 15 | | {28, 29, 30, 31} | | |
| 16 | | | {0, 1, 2, 3} | |
| 17 | | | {4, 5, 6, 7} | |
| 18 | | | {8, 9, 10, 11} | |
| 19 | | | {12, 13, 14, 15} | |
| 20 | | | {16, 17, 18, 19} | |
| 21 | | | {20, 21, 22, 23} | |
| 22 | | | {24, 25, 26, 27} | |
| 23 | | | {28, 29, 30, 31} | |
| 24 | | | | {0, 1, 2, 3} |
| 25 | | | | {4, 5, 6, 7} |
| 26 | | | | {8, 9, 10, 11} |
| 27 | | | | {12, 13, 14, 15} |
| 28 | | | | {16, 17, 18, 19} |
| 29 | | | | {20, 21, 22, 23} |
| 30 | | | | {24, 25, 26, 27} |
| 31 | | | | {28, 29, 30, 31} |

2) Four REGs included in an ePHICH group resource are located in the different PRB pairs, but resource locations of the four REGs are discrete, for example, as shown in Table 42:

TABLE 42
N_{PRB} = 4, N_{REC} = 4, Discrete REGs

| ePHICH | PRB#0 | PRB#1 | PRB#2 | PRB#3 |
|---|---|---|---|---|
| group# | REG# | REG# | REG# | REG# |
| 0 | 0 | 8 | 16 | 24 |
| 1 | 1 | 9 | 17 | 25 |
| 2 | 2 | 10 | 18 | 26 |
| 3 | 3 | 11 | 19 | 27 |
| 4 | 4 | 12 | 20 | 28 |
| 5 | 5 | 13 | 21 | 29 |
| 6 | 6 | 14 | 22 | 30 |
| 7 | 7 | 15 | 23 | 31 |
| 8 | 8 | 16 | 24 | 0 |
| 9 | 9 | 17 | 25 | 1 |
| 10 | 10 | 18 | 26 | 2 |
| 11 | 11 | 19 | 27 | 3 |
| 12 | 12 | 20 | 28 | 4 |
| 13 | 13 | 21 | 29 | 5 |
| 14 | 14 | 22 | 30 | 6 |
| 15 | 15 | 23 | 31 | 7 |
| 16 | 16 | 24 | 0 | 8 |
| 17 | 17 | 25 | 1 | 9 |
| 18 | 18 | 26 | 2 | 10 |
| 19 | 19 | 27 | 3 | 11 |
| 20 | 20 | 28 | 4 | 12 |
| 21 | 21 | 29 | 5 | 13 |
| 22 | 22 | 30 | 6 | 14 |
| 23 | 23 | 31 | 7 | 15 |
| 24 | 24 | 0 | 8 | 16 |
| 25 | 25 | 1 | 9 | 17 |
| 26 | 26 | 2 | 10 | 18 |
| 27 | 27 | 3 | 11 | 19 |
| 28 | 28 | 4 | 12 | 20 |
| 29 | 29 | 5 | 13 | 21 |
| 30 | 30 | 6 | 14 | 22 |
| 31 | 31 | 7 | 15 | 23 |

It is important to note that the REGs forming the ePHICH groups in Tables 30˜42 are shown in Tables 30˜42, but ePHICH group indexes may be randomly arranged, not limited to sequences described in Tables 32˜42, and in Tables 30˜42, only one possible arrangement sequence of the ePHICH groups is presented in order to facilitate description.

### Preferred Embodiment 8

In the embodiment, it is supposed that there are totally N_{PRB} PRB pairs for sending an ePHICH, wherein the number and locations of the ePHICH PRB pairs are notified to a terminal side by a network side through a system message or higher-layer signalling or determined by the network side and the terminal side in a predetermined manner. Wherein, N_{PRB} is a non-negative integer, and is preferably equal to 1, 2, 4, 8 or 16.

REs, except RE resources occupied by DMRS, in each PRB pair for sending the ePHICH are divided into 16 eREGs, and the REs in each PRB pair are sequentially allocated to each eREG in a manner of first time domain after frequency domain, for example, as shown in FIG. 9.

An ePHICH PRB pair is divided into N1 REG areas by taking a time-domain symbol or a frequency-domain subcarrier as a unit. Wherein, N1 is a non-negative integer, and preferably, a value of N1 is 2 or 4. Every two time-domain adjacent eREGs located in each REG area form an ePHICH REG. Tables 30˜35 and Tables 43˜44 show some typical manners for dividing the REG areas according to the abovementioned method:

TABLE 43
N1 = 4, Frequency-Domain Division Manner 1

| ePHICH REG area# | Subcarrier# |
|---|---|
| 0 | {0, 1, 2} |
| 1 | {3, 4, 5} |
| 2 | {6, 7, 8} |
| 3 | {9, 10, 11} |

TABLE 44
N1 = 4, Frequency-Domain Division Manner 2

| ePHICH REG area# | Subcarrier# |
|---|---|
| 0 | {0, 4, 8} |
| 1 | {1, 5, 9} |
| 2 | {2, 6, 10} |
| 3 | {3, 7, 11} |

Multiple ePHICHs are mapped onto the same group of ePHICH REs through different orthogonal sequences. Wherein, each group of ePHICH REs consists of multiple ePHICH REGs, and the multiple ePHICH REGs may be from the same PRB pair or different PRB pairs. When the multiple REGs are from the same PRB pair, localized ePHICH transmission is often formed, and when the multiple REGs are from different PRB pairs, distributed ePHICH transmission is often formed.

Specifically, the definition of ePHICH REGs to ePHICH group resources may refer to the method described in preferred embodiment 7, and will not be repeated here.

### Preferred Embodiment 9

In the embodiment, it is supposed that there are totally N_{PRB} PRB pairs for sending an ePHICH, wherein the number and locations of the ePHICH PRB pairs are notified to a terminal side by a network side through a system message or higher-layer signalling or determined by the network side and the terminal side in a predetermined manner. Wherein, N_{PRB} is a non-negative integer. Preferably, the number/locations of the PRB pairs for sending the ePHICH are the same as the number/locations of PRB pairs configured to an ePDCCH by the network side, or the number/locations of the ePHICH PRB pairs is a subset of the number/locations of the ePDCCH PRB pairs, or the number/locations of the ePDCCH PRB pairs is a subset of the number/locations of the ePHICH PRB pairs. Wherein, the locations of the PRB pairs include sub-frame locations of the PRB pairs on the time domain and PRB index locations of the PRB pairs on the frequency domain.

REs, except RE resources occupied by DMRS, in each PRB pair for sending the ePHICH are divided into 16 eREGs, and its specific division manner is the same as a division and arrangement manner for eREGs in the ePDCCH PRB pairs.

An ePHICH PRB pair is divided into N1 REG areas by taking a time-domain symbol or a frequency-domain subcarrier as a unit. Wherein, N1 is a non-negative integer. Every two or four frequency-domain adjacent eREG's located in each REG area form an ePHICH REG.

Multiple ePHICHs are mapped onto the same group of ePHICH REs through different orthogonal sequences. Wherein, each group of ePHICH REs consists of multiple ePHICH REGs, and the multiple REGs may be from the same PRB pair or different PRB pairs. When the multiple REGs are from the same PRB pair, localized ePHICH transmission is often formed, and when the multiple REGs are from different PRB pairs, distributed ePHICH transmission is often formed.

The ePHICH and the ePDCCH/PDSCH are allowed to multiplex on the same PRB pair, and the ePDCCH/PDSCH avoids a resource collision with the ePHICH in a rate matching manner.

Wherein, the definition of ePHICH REGs to ePHICH group resources may refer to the method described in preferred embodiment 7, and will not be repeated here.

### Preferred Embodiment 10

In the embodiment, it is supposed that there are totally N_{PRB} PRB pairs for sending an ePHICH, wherein the number and locations of the ePHICH PRB pairs are notified to a terminal side by a network side through a system message or higher-layer signalling or determined by the network side and the terminal side in a predetermined manner. Wherein, N_{PRB} is a non-negative integer. Preferably, the number/locations of the PRB pairs for sending the ePHICH are the same as the number/locations of PRB pairs configured to an ePDCCH by the network side, or the number/locations of the ePHICH PRB pairs is a subset of the number/locations of the ePDCCH PRB pairs, or the number/locations of the ePDCCH PRB pairs form a subset of the number/locations of the ePHICH PRB pairs. Wherein, the locations of the PRB pairs include sub-frame locations of the PRB pairs on the time domain and PRB index locations of the PRB pairs on the frequency domain.

REs, except RE resources occupied by DMRS, in each PRB pair for sending the ePHICH are divided into 16 eREGs, and its specific division manner is the same as a division and arrangement manner for eREGs in the ePDCCH PRB pairs.

An ePHICH PRB pair is divided into N1 REG areas by taking a time-domain symbol or a frequency-domain subcarrier as a unit. Wherein, N1 is a non-negative integer. Every two or four time-domain adjacent eREG's located in each REG area form an ePHICH REG.

Multiple ePHICHs are mapped onto the same group of ePHICH REs through different orthogonal sequences. Wherein, each group of ePHICH REs consists of multiple ePHICH REGs, and the multiple REGs may be from the same PRB pair or different PRB pairs. When the multiple REGs are from the same PRB pair, localized ePHICH transmission is often formed, and when the multiple REGs are from different PRB pairs, distributed ePHICH transmission is often formed.

The ePHICH and the ePDCCH/PDSCH are allowed to multiplex on the same PRB pair, and the ePDCCH/PDSCH avoids a resource collision with the ePHICH in a rate matching manner.

Wherein, the definition of ePHICH REGs to ePHICH group resources may refer to the method described in preferred embodiment 7, and will not be repeated here.

### Preferred Embodiment 11

Only a part of resources in PRB pairs is allowed for ePHICH transmission, for example, only certain specific subcarriers or certain specific OFDM symbols or certain specific eREGs on the ePHICH PRB pairs are configured for ePHICH transmission.

The condition that only certain specific eREGs in each ePHICH PRB pair are configured for ePHICH transmission is described below in detail:

REs, except RE resources occupied by DMRS, in each PRB pair for sending the ePHICH are divided into 16 eREGs, and the REs in each PRB pair are sequentially allocated to each eREG in a manner of first time domain after frequency domain (for example, as shown in FIG. 9), or the eREGs are divided and arranged in a manner the same as that for eREGs in ePDCCH PRB pairs.

A PRB pair for sending the ePHICH includes multiple ePHICH REGs. In each ePHICH PRB pair, every two or four frequency-domain adjacent eREGs or a part of resources of the eREGs form an ePHICH REG, as shown in Tables 45˜46:

TABLE 45
Manner for forming the ePHICH REGs

| ePHICH REG# | eREG# |
|---|---|
| 0 | {0, 1} |
| 1 | {4, 5} |
| 2 | {8, 9} |
| 3 | {12, 13} |

TABLE 46
Each PRB pair with 4 REG areas

PRB#

| ePHICH REG# | eREG# | REG area# |
|---|---|---|
| 0 | {0, 1} | 0 |
| 1 | {4, 5} | 0 |
| 2 | {8, 9} | 0 |
| 3 | {12, 13} | 0 |
| 4 | {0, 1} | 1 |
| 5 | {4, 5} | 1 |
| 6 | {8, 9} | 1 |
| 7 | {12, 13} | 1 |
| 8 | {0, 1} | 2 |
| 9 | {4, 5} | 2 |
| 10 | {8, 9} | 2 |
| 11 | {12, 13} | 2 |
| 12 | {0, 1} | 3 |
| 13 | {4, 5} | 3 |
| 14 | {8, 9} | 3 |
| 15 | {12, 13} | 3 |

Wherein, the first column “ePHICH REG#” in Tables 45˜46 represents the index of the ePHICH REG, the second column “eREG#” represents the index of the eREG, and “REG area#” represents the index of the REG area.

The other resources not for ePHICH transmission in each PRB pair may be configured for PDSCH or ePDCCH transmission.

Wherein, the definition of ePHICH REGs to ePHICH group resources may refer to the methods described in preferred embodiment 3 and the preferred embodiment 7, and will not be repeated here.

It is important to note that one or more ePHICH REGs included in each group of ePHICH REs in the N_{ePHICH}^{group} groups of ePHICH REs may be continuous, and may also be discrete.

It is important to note that the eREGs in the embodiments may be eREGs divided according to a method in the related art, and may also be eREGs divided according to a subsequent improved method.

According to the embodiments, the method and device for sending the ePHICH and method and device for receiving the ePHICH are provided. The part or all of the REs of the PRB pairs for sending the ePHICH are divided into the ePHICH groups of ePHICH REs, wherein each ePHICH REs in the N_{ePHICH}^{group} groups of ePHICH REs includes N_{ePHICH}^{seq} resources; and then the ePHICH is transmitted on the ePHICH resources. Therefore, the problem of poorer transmission performance of a PHICH in the related art is solved, and the effect of improving uplink ACK/NACK information transmission performance is further achieved. It is important to note that the technical effects are not peculiar to all the abovementioned implementation modes, and some technical effects may be achieved by some preferred implementation modes.

Obviously, those skilled in the art should know that each component or step of the present disclosure may be implemented by a universal computing device, and the components or steps may be concentrated on a single computing device or distributed on a network formed by multiple computing devices, and may optionally be implemented by programmable codes executable for the computing devices, so that the components or steps may be stored in a storage device for execution with the computing devices, or may form each integrated circuit component, or multiple components or steps therein may form a single integrated circuit component for implementation. As a consequence, the present disclosure is not limited to any specific hardware and software combination.

The above is only the preferred embodiment of the present disclosure and not intended to limit the present disclosure, and for the those skilled in the art, the present disclosure may have various modifications and variations. Any modifications, equivalent replacements, improvements and the like within the spirit and principle of the present disclosure shall fall within the scope of protection of the present disclosure.

### INDUSTRIAL PRACTICABILITY

By the technical solutions provided by the present disclosure, a capacity problem and interference problem of a conventional PHICH and the problem of inapplicability in a NCT and a low cost MTC scenario are solved, an ePHICH is simultaneously taken into consideration, and uplink ACK/NACK information transmission performance is improved.

1. A method for sending an enhanced Physical Hybrid Automatic Repeat Request (ARQ) Indicator Channel (ePHICH), comprising:
dividing a part or all of Resource Elements (RE) of Physical Resource Block (PRB) pairs for sending the ePHICH into N_{ePHICH}^{group} groups of ePHICH REs, wherein each group of ePHICH REs in the N_{ePHICH}^{group} groups of ePHICH REs comprises n_{ePHICH}^{seq} ePHICH resources, and both N_{ePHICH}^{group} and N_{ePHICH}^{seq} are positive integers more than or equal to 1; and
sending the ePHICH on the ePHICH resources.

2. The method according to claim 1, wherein dividing the part or all of the REs of the PRB pairs for sending the ePHICH into the N_{ePHICH}^{group} groups of ePHICH REs comprises one of the following:
dividing a part or all of RE resources, except RE resources occupied by Demodulation Reference Signals (DMRS), in each PRB pair in the PRB pairs for sending the ePHICH into Np first enhanced Resource Element Groups (eREG) respectively;
determining an ePHICH Resource Element Group (REG) in each PRB pair respectively, wherein the ePHICH REG comprises Nx time-domain adjacent or frequency-domain adjacent first eREGs; and
dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs,
Np is an integer more than 1, and Nx is an integer more than or equal to 1;
dividing a part or all of RE resources, except RE resources occupied by DMRS, in each PRB pair in the PRB pairs for sending the ePHICH into Np second eREGs respectively; dividing each PRB pair in the PRB pairs for sending the ePHICH into multiple REG areas respectively, wherein each REG area in the multiple REG areas comprises one or more subcarriers on the frequency domain, and comprises one or more Orthogonal Frequency Division Multiplexing (OFDM) symbols on the time domain; determining an ePHICH REG of each REG area in the multiple REG areas respectively, wherein the ePHICH REG comprises Nx time-domain adjacent or frequency-domain adjacent second eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1;
dividing a part or all of RE resources, except RE resources occupied by the DMRS, in each PRB pair in the PRB pairs for sending the ePHICH into Np third eREGs respectively, wherein each eREG in the Np third eREGs comprises Nr REs, and N REs in each eREG are configured for ePHICH transmission; determining an ePHICH REG in each PRB pair respectively, wherein the ePHICH REG comprises Nx time-domain adjacent or frequency-domain adjacent third eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1;
dividing a part or all of RE resources, except RE resources occupied by DMRS, in each PRB pair in the PRB pairs for sending the ePHICH into Np fourth eREGs respectively, wherein each eREG in the Np fourth eREGs comprises Nr REs, and N REs in each eREG are configured for ePHICH transmission; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent fourth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1;
dividing a part or all of RE resources, except RE resources occupied by DMRS, in each PRB pair in the PRB pairs for sending the ePHICH into Np fifth eREGs respectively, wherein M eREGs in the Np fifth eREGs are configured for ePHICH transmission; determining an ePHICH REG in each PRB pair respectively, wherein the ePHICH REG comprises Nx time-domain adjacent or frequency-domain adjacent fifth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1;
dividing a part or all of RE resources, except RE resources occupied by the DMRS, in each PRB pair in the PRB pairs for sending the ePHICH into Np sixth eREGs respectively, wherein M eREGs in the Np sixth eREGs are configured for ePHICH transmission; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent sixth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1;
dividing a part or all of RE resources, except RE resources occupied by DMRS, in each PRB pair in the PRB pairs for sending the ePHICH into Np seventh eREGs respectively, wherein M eREGs in the Np seventh eREGs are configured for ePHICH transmission, N REs comprised in each eREG in the M eREGs are configured for ePHICH transmission and each eREG in the M eREGs comprises Nr REs; determining an ePHICH REG in each PRB pair respectively, wherein the ePHICH REG comprises Nx time-domain adjacent or frequency-domain adjacent seventh eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1;
dividing a part or all of RE resources, except RE resources occupied by DMRS, in each PRB pair in the PRB pairs for sending the ePHICH into Np eighth eREGs respectively, wherein M eREGs in the Np eighth eREGs are configured for ePHICH transmission, N REs comprised in each eREG in the M eREGs are configured for ePHICH transmission, and each eREG in the M eREGs comprises Nr REs; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent eighth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1.

3. (canceled)

4. (canceled)

5. (canceled)

6. (canceled)

7. (canceled)

8. (canceled)

9. (canceled)

10. The method according to claim 1, wherein
N_{ePHICH}^{group} is acquired in one of manners as follows:
N_{ePHICH}^{group} is preset by a network side and a terminal side;
N_{ePHICH}^{group} is notified to the terminal side by the network side through higher-layer signalling; and
N_{ePHICH}^{group} is determined through at least one of parameters as follows: a cell Identity (ID), the number of PRBs configured to the ePHICH, a sub-frame type, a sub-frame number and a Cyclic Prefix (CP) length; or,
the N_{ePHICH}^{seq} is preset by a network side and a terminal side, an index value corresponding to each ePHICH resource in the N_{ePHICH}^{seq} ePHICH resources is n_{ePHICH}^{seq}, and n_{ePHICH}^{seq} ε[0, N_{ePHICH}^{seq}−1]; or,
the N_{ePHICH}^{seq} ePHICH resources are multiplexed on one group of ePHICH REs through N_{ePHICH}^{seq} different orthogonal sequences, wherein an index of an orthogonal sequence is n_{ePHICH}^{seq}, and n_{ePHICH}^{seq} ε[0, N_{ePHICH}^{seq}−1], wherein the orthogonal sequences comprise orthogonal mask sequences.

11. The method according to claim 1, wherein
resource configuration information of the PRB pairs for sending the ePHICH is notified to a terminal side through higher-layer signalling or physical-layer signalling; or the resource configuration information of the PRB pairs for sending the ePHICH is preset on a network side and a terminal side, wherein the resource configuration information comprises sub-frame resource information on the time domain and/or PRB indexes on the frequency domain; or,
the PRB pairs for sending the ePHICH comprise: a part or all of resources in PRB pairs configured for sending the ePHICH or for enhanced Physical Downlink Control Channel (ePDCCH) blind detection; or,
on the PRB pairs for sending the ePHICH, a Physical Downlink Shared Channel (PDSCH)/ePDCCH and the ePHICH are allowed to be multiplexed on the same PRB pairs by a rate matching manner.

12. (canceled)

13. (canceled)

14. (canceled)

15. (canceled)

16. (canceled)

17. (canceled)

18. The method according to claim 1, wherein
a network side notifies a group index n_{ePHICH}^{group} and an intra-group sequence index n_{ePHICH}^{seq} corresponding to an ePHICH resource to a terminal side through a system message or a higher-layer signalling; or
the network side indicates the group index n_{ePHICH}^{group} corresponding to the ePHICH resource to the terminal side through the system message or the higher-layer signalling, and indicates the intra-group sequence index n_{ePHICH}^{seq} to the terminal side through a physical-layer signalling; or
the network side notifies the group index n_{ePHICH}^{group} and the intra-group sequence index n_{ePHICH}^{seq} to the terminal side through the physical-layer signalling; or
the network side configures values of multiple sets of group index n_{ePHICH}^{group} and intra-group sequence index n_{ePHICH}^{seq} to the terminal side through the higher-layer signalling, and notifies one or more preset sets to the terminal side for ePHICH transmission through the physical-layer signalling; or
a network side determines values of a group index n_{ePHICH}^{group} and an intra-group sequence index n_{ePHICH}^{seq} of an ePHICH resource according to one or more of parameters as follows: a lowest PRB index of a Physical Uplink Shared Channel (PUSCH) responded by the ePHICH, a DRMS domain value in uplink authorization information of a Physical Downlink Control Channel (PDCCH) corresponding to the PUSCH responded by the ePHICH and a sub-frame where the PUSCH responded by the ePHICH is located.

19. (canceled)

20. The method according to claim 2, wherein
dividing all the ePHICH REGs of the PRB pairs for sending the ePHICH into the N_{ePHICH}^{group} groups of ePHICH REs comprises one of:
taking each ePHICH REG as one group of ePHICH REs;
grouping every Ny REGs at preset positions in each ePHICH PRB pair in all the ePHICH REGs into one group of ePHICH REs; and
grouping every Ny REGs belonging to multiple ePHICH PRB pairs at preset positions in all the ePHICH REGs into one group of ePHICH Res;
a value of Np is 16 or an integral multiple of 16, and a value of Nx is 2 or 4; or
a value of N and a selection of the N REs are preset by a network side and a terminal side, or are determined according to at least one of parameters as follows: a sub-frame type, a CP length, the number of Common Reference Signal (CRS) ports and the number of PDCCH symbols.

21. (canceled)

22. (canceled)

23. A method for receiving an enhanced Physical Hybrid Automatic Repeat Request (ARQ) Indicator Channel (ePHICH), comprising:
receiving resource indication information, configured by a network side, of Physical Resource Block (PRB) pairs for sending the ePHICH, wherein a part or all of Resource Elements (RE) of the PRB pairs for sending the ePHICH are divided into N_{ePHICH}^{group} groups of ePHICH REs, each group of ePHICH REs in the N_{ePHICH}^{group} groups of ePHICH REs comprises N_{ePHICH}^{seq} ePHICH resources, and both N_{ePHICH}^{group} and N_{ePHICH}^{seq} are positive integers more than or equal to 1;
receiving group indexes and intra-group indexes, configured by the network side, of the ePHICH resources; or receiving information for determining the group indexes and the intra-group indexes of the ePHICH resources;
determining, according to the group indexes and the intra-group indexes, the ePHICH resources for sending the ePHICH on resources indicated by the resource indication information; and
receiving the ePHICH on the ePHICH resources.

24. The method according to claim 23, wherein determining, according to the group indexes and the intra-group indexes, the ePHICH resources for sending the ePHICH on the resources indicated by the resource indication information comprises:
dividing a part or all of the REs of the PRB pairs for sending the ePHICH into the N_{ePHICH}^{group} groups of ePHICH REs according to the resource indication information; wherein each group of ePHICH REs in the N_{ePHICH}^{group} groups of ePHICH REs determined according to the resource indication information comprises N_{ePHICH}^{seq} resources; and
determining the ePHICH resources for sending the ePHICH on the N_{ePHICH}^{group} groups of ePHICH REs according to the group indexes and the intra-group indexes.

25. The method according to claim 24, wherein dividing the part or all of the REs of the PRB pairs for sending the ePHICH into the N_{ePHICH}^{group} groups of ePHICH REs according to the resource indication information comprises one of the following:
dividing a part or all of RE resources, except RE resources occupied by Demodulation Reference Signals (DMRS), in each PRB pair in the PRB pairs for sending the ePHICH into Np first enhanced Resource Element Groups (eREG) respectively;
determining an ePHICH Resource Element Group (REG) in each PRB pair respectively, wherein the ePHICH REG comprises Nx time-domain adjacent or frequency-domain adjacent first eREGs; and
dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs,
Np is an integer more than 1, and Nx is an integer more than or equal to 1; or
dividing a part or all of RE resources, except RE resources occupied by DMRS, in each PRB pair in the PRB pairs for sending the ePHICH into Np second eREGs respectively; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent second eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1;
dividing a part or all of RE resources, except RE resources occupied by DMRS, in each PRB pair in the PRB pairs for sending the ePHICH into Np third eREGs respectively, wherein each eREG in the Np third eREGs comprises Nr REs, and N REs in each eREG are configured for ePHICH transmission; determining an ePHICH REG in each PRB pair respectively, wherein the ePHICH REG comprises Nx time-domain adjacent or frequency-domain adjacent third eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1;
dividing a part or all of RE resources, except RE resources occupied by DMRS, in each PRB pair in the PRB pairs for sending the ePHICH into Np fourth eREGs respectively, wherein each eREG in the Np fourth eREGs comprises Nr REs, and N REs in each eREG are configured for ePHICH transmission; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent fourth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1;
dividing a part or all of RE resources, except RE resources occupied by DMRS, in each PRB pair in the PRB pairs for sending the ePHICH into Np fifth eREGs respectively, wherein M eREGs in the Np fifth eREGs are configured for ePHICH transmission; determining an ePHICH REG in each PRB pair respectively, wherein the ePHICH REG comprises Nx time-domain adjacent or frequency-domain adjacent fifth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1;
dividing a part or all of RE resources, except RE resources occupied by DMRS, in each PRB pair in the PRB pairs for sending the ePHICH into Np sixth eREGs respectively, wherein M eREGs in the Np sixth eREGs are configured for ePHICH transmission; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; determining an ePHICH REG of each REG area in the multiple REG areas respectively, wherein the ePHICH REG comprises Nx time-domain adjacent or frequency-domain adjacent sixth eREGs; and dividing all ePHICH REGs of the PRB pairs for sending the ePHICH into the N_{ePHICH}^{group} groups of ePHICH REs wherein each group of ePHICH REs in the N_{ePHICH}^{group} groups of ePHICH REs comprises one or more ePHICH REGs, M is less than Np, both M and Np are integers more than 1 and Nx is an integer more than or equal to 1;
dividing a part or all of RE resources, except RE resources occupied by DMRS, in each PRB pair in the PRB pairs for sending the ePHICH into Np seventh eREGs respectively, wherein M eREGs in the Np seventh eREGs are configured for ePHICH transmission, N REs comprised in each eREG in the M eREGs are configured for ePHICH transmission, and each eREG in the M eREGs comprises Nr REs; determining an ePHICH REG in each PRB pair respectively, wherein the ePHICH REG comprises Nx time-domain adjacent or frequency-domain adjacent seventh eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1;
dividing a part or all of RE resources, except RE resources occupied by DMRS, in each PRB pair in the PRB pairs for sending the ePHICH into Np eighth eREGs respectively, wherein M eREGs in the Np eighth eREGs are configured for ePHICH transmission, N REs comprised in each eREG in the M eREGs are configured for ePHICH transmission, and each eREG in the M eREGs comprises Nr REs; dividing each PRB pair in the PRB pairs for sending the ePHICH into multiple REG areas respectively, wherein each REG area in the multiple REG areas comprises one or more subcarriers on the frequency domain, and comprises one or more OFDM symbols on the time domain;
determining an ePHICH REG of each REG area in the multiple REG areas respectively, wherein the ePHICH REG comprises Nx time-domain adjacent or frequency-domain adjacent eighth eREGs; and dividing all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1 and Nx is an integer more than or equal to 1.

26. (canceled)

27. (canceled)

28. (canceled)

29. (canceled)

30. (canceled)

31. (canceled)

32. (canceled)

33. The method according to claim 23, wherein
N_{ePHICH}^{group} is acquired in one of manners as follows:
N_{ePHICH}^{group} is preset by the network side and a terminal side;
N_{ePHICH}^{group} is notified to the terminal side by the network side through higher-layer signalling; and
N_{ePHICH}^{group} is determined through at least one of parameters as follows: a cell Identity (ID), the number of PRBs configured to the ePHICH, a sub-frame type, a sub-frame number and a Cyclic Prefix (CP) length; or
N_{ePHICH}^{seq} is preset by a network side and a terminal side, an index value corresponding to each ePHICH resource in the N_{ePHICH}^{seq} ePHICH resources is n_{ePHICH}^{seq}, and n_{ePHICH}^{seq} ε[0, N_{ePHICH}^{seq}−1]; or
the N_{ePHICH}^{seq} ePHICH resources are multiplexed on one group of ePHICH REs through N_{ePHICH}^{seq} different orthogonal sequences, wherein an index of an orthogonal sequence is n_{ePHICH}^{seq}, and n_{ePHICH}^{seq} ε[0, N_{ePHICH}^{seq}−1], wherein the orthogonal sequences comprise orthogonal mask sequences.

34. The method according to claim 23, wherein
resource configuration information of the PRB pairs for sending the ePHICH is notified to a terminal side through higher-layer signalling or physical-layer signalling; or the resource configuration information of the PRB pairs for sending the ePHICH is preset on a network side and a terminal side, wherein the resource configuration information comprises sub-frame resource information on the time domain and/or PRB indexes on the frequency domain; or,
the PRB pairs for sending the ePHICH comprise: a part or all of resources in PRB pairs configured for sending the ePHICH or for enhanced Physical Downlink Control Channel (ePDCCH) blind detection;
on the PRB pairs for sending the ePHICH, a Physical Downlink Shared Channel (PDSCH)/ePDCCH and the ePHICH are allowed to be multiplexed on the same PRB pairs by a rate matching manner.

35. (canceled)

36. (canceled)

37. (canceled)

38. (canceled)

39. (canceled)

40. (canceled)

41. The method according to claim 23, wherein
a network side notifies a group index n_{ePHICH}^{group} and an intra-group sequence index N_{ePHICH}^{seq} corresponding to an ePHICH resource to a terminal side through a system message or a higher-layer signalling; or
the network side indicates the group index n_{ePHICH}^{group} to the ePHICH corresponding resource to the terminal side through the system message or the higher-layer signalling, and indicates the intra-group sequence index n_{ePHICH}^{seq} to the terminal side through a physical-layer signalling; or
the network side notifies the group index n_{ePHICH}^{group} and the intra-group sequence index n_{ePHICH}^{seq} to the terminal side through the physical-layer signalling; or
the network side configures values of multiple sets of group index n_{ePHICH}^{group} and intra-group sequence index n_{ePHICH}^{seq} to the terminal side through the higher-layer signalling, and notifies one or more preset sets to the terminal side for ePHICH transmission through the physical-layer signalling; or
a network side determines the values of a group index n_{ePHICH}^{group} and an intra-group sequence index n_{ePHICH}^{seq} of an ePHICH resource according to one or more of parameters as follows: a lowest PRB index of a Physical Uplink Shared Channel (PUSCH) responded by the ePHICH, a DRMS domain value in uplink authorization information of a Physical Downlink Control Channel (PDCCH) corresponding to the PUSCH responded by the ePHICH and a sub-frame where the PUSCH responded by the ePHICH is located.

42. (canceled)

43. The method according to claim 25, wherein
dividing all the ePHICH REGs of the PRB pairs for sending the ePHICH into the N_{ePHICH}^{group} groups of ePHICH REs according to the resource indication information comprises one of:
taking each ePHICH REG as one group of ePHICH REs;
grouping every Ny REGs at preset positions in each ePHICH PRB pair in all the ePHICH REGs into one group of ePHICH REs; and
grouping every Ny REGs belonging to multiple ePHICH PRB pairs at preset positions in all the ePHICH REGs into one group of ePHICH Res; or
a value of Np is 16 or an integral multiple of 16, and a value of Nx is 2 or 4; or,
a value of N and a selection of the N REs are preset by a network side and a terminal side, or are determined according to at least one of parameters as follows: a sub-frame type, a CP length, the number of Common Reference Signal (CRS) ports and the number of PDCCH symbols.

44. (canceled)

45. (canceled)

46. A device for sending an enhanced Physical Hybrid Automatic Repeat Request (ARQ) Indicator Channel (ePHICH), comprising:
a first dividing component, configured to divide a part or all of Resource Elements (RE) of Physical Resource Block (PRB) pairs for sending the ePHICH into N_{ePHICH}^{group} groups of ePHICH REs, wherein each group of ePHICH REs in the N_{ePHICH}^{group} groups of ePHICH REs comprises N_{ePHICH}^{seq} ePHICH resources, and both N_{ePHICH}^{group} and N_{ePHICH}^{group} are positive integers more than or equal to 1; and
a sending component, configured to send the ePHICH on the ePHICH resources.

47. The device according to claim 46, wherein the first dividing component comprises one of component combinations as follows:
a first component combination: a second dividing component, configured to divide a part or all of RE resources, except RE resources occupied by Demodulation Reference Signals (DMRS), in each PRB pair in the PRB pairs for sending the ePHICH into Np first enhanced Resource Element Groups (eREG) respectively; a first determining component, configured to determine an ePHICH Resource Element Group (REG) in each PRB pair respectively, wherein the ePHICH REG comprises Nx time-domain adjacent or frequency-domain adjacent first eREGs; a third dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1;
a second component combination: a fourth dividing component, configured to divide a part or all of RE resources, except RE resources occupied by DMRS, in each PRB pair in the PRB pairs for sending the ePHICH into Np second eREGs respectively; a fifth dividing component, configured to divide each PRB pair in the PRB pairs for sending the ePHICH into multiple REG areas respectively, wherein each REG area in the multiple REG areas comprises one or more subcarriers on the frequency domain, and comprises one or more Orthogonal Frequency Division Multiplexing (OFDM) symbols on the time domain; a second determining component, configured to determine an ePHICH REG of each REG area in the multiple REG areas respectively, wherein the ePHICH REG comprises Nx time-domain adjacent or frequency-domain adjacent second eREGs; a sixth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1;
a third component combination: a seventh dividing component, configured to divide a part or all of RE resources, except RE resources occupied by DMRS, in each PRB pair in the PRB pairs for sending the ePHICH into Np third eREGs respectively, wherein each eREG in the Np third eREGs comprises Nr REs, and N REs in each eREG are configured for ePHICH transmission; a third determining component, configured to determine an ePHICH REG in each PRB pair respectively, wherein the ePHICH REG comprises Nx time-domain adjacent or frequency-domain adjacent third eREGs; an eighth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1;
a fourth component combination: a ninth dividing component, configured to divide a part or all of RE resources, except RE resources occupied by DMRS, in each PRB pair in the PRB pairs for sending the ePHICH into Np fourth eREGs respectively, wherein each eREG in the Np fourth eREGs comprises Nr REs, and N REs in each eREG are configured for ePHICH transmission; a tenth dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a fourth determining component, configured to determine an ePHICH REG of each REG area in the multiple REG areas respectively, wherein the ePHICH REG comprises Nx time-domain adjacent or frequency-domain adjacent fourth eREGs; an eleventh dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1;
a fifth component combination: a twelfth dividing component, configured to divide a part or all of RE resources, except RE resources occupied by DMRS, in each PRB pair in the PRB pairs for sending the ePHICH into Np fifth eREGs respectively, wherein M eREGs in the Np fifth eREGs are configured for ePHICH transmission; a fifth determining component, configured to determine an ePHICH REG in each PRB pair respectively, wherein the ePHICH REG comprises Nx time-domain adjacent or frequency-domain adjacent fifth eREGs; a thirteenth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1;
a sixth component combination: a fourteenth dividing component, configured to divide a part or all of RE resources, except RE resources occupied by DMRS, in each PRB pair in the PRB pairs for sending the ePHICH into Np sixth eREGs respectively, wherein M eREGs in the Np sixth eREGs are configured for ePHICH transmission; a fifteenth dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a sixth determining component, configured to determine an ePHICH REG of each REG area in the multiple REG areas respectively, wherein the ePHICH REG comprises Nx time-domain adjacent or frequency-domain adjacent sixth eREGs; a sixteenth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1;
a seventh component combination: a seventeenth dividing component, configured to divide a part or all of RE resources, except RE resources occupied by DMRS, in each PRB pair in the PRB pairs for sending the ePHICH into Np seventh eREGs respectively, wherein M eREGs in the Np seventh eREGs are configured for ePHICH transmission, N REs comprised in each eREG in the M eREGs are configured for ePHICH transmission, and each eREG in the M eREGs comprises Nr REs; a seventh determining component, configured to determine an ePHICH REG in each PRB pair respectively, wherein the ePHICH REG comprises Nx time-domain adjacent or frequency-domain adjacent seventh eREGs; an eighteenth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1;
an eighth component combination: a nineteenth dividing component, configured to divide a part or all of RE resources, except RE resources occupied by DMRS, in each PRB pair in the PRB pairs for sending the ePHICH into Np eighth eREGs respectively, wherein M eREGs in the Np eighth eREGs are configured for ePHICH transmission, N REs comprised in each eREG in the M eREGs are configured for ePHICH transmission, and each eREG in the M eREGs comprises Nr REs; a twentieth dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; an eighth determining component, configured to determine an ePHICH REG of each REG area in the multiple REG areas respectively, wherein the ePHICH REG comprises Nx time-domain adjacent or frequency-domain adjacent eighth eREGs; and a twenty-first dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1.

48. The device according to claim 46, wherein
N_{ePHICH}^{group} is acquired in one of manners as follows:
N_{ePHICH}^{group} is preset by a network side and a terminal side;
N_{ePHICH}^{group} is notified to the terminal side by the network side through higher-layer signalling; and
N_{ePHICH}^{group} ePHICH is determined through at least one of parameters as follows: a cell Identity (ID), the number of PRBs configured to the ePHICH, a sub-frame type, a sub-frame number and a Cyclic Prefix (CP) length; or
N_{ePHICH}^{seq} is preset by a network side and a terminal side, an index value corresponding to each ePHICH resource in the N_{ePHICH}^{seq} resources is n_{ePHICH}^{seq}, and n_{ePHICH}^{seq} ε[0, N_{ePHICH}^{seq}−1]; or
the N_{ePHICH}^{seq} resources are multiplexed on one group of ePHICH REs through N_{ePHICH}^{seq} different orthogonal sequences wherein an index of an orthogonal sequence is n_{ePHICH}^{seq}, and n_{ePHICH}^{seq} ε[0, N_{ePHICH}^{seq}−1], wherein the orthogonal sequences comprise orthogonal mask sequences.

49. The device according to claim 46, wherein
resource configuration information of the PRB pairs for sending the ePHICH is notified to a terminal side through higher-layer signalling or physical-layer signalling; or the resource configuration information of the PRB pairs for sending the ePHICH is preset on a network side and a terminal side, wherein the resource configuration information comprises sub-frame resource information on the time domain and/or PRB indexes on the frequency domain; or
the PRB pairs for sending the ePHICH comprise: a part or all of resources in PRB pairs configured for sending the ePHICH or for enhanced Physical Downlink Control Channel (ePDCCH) blind detection;
on the PRB pairs for sending the ePHICH, a Physical Downlink Shared Channel (PDSCH)/ePDCCH and the ePHICH are allowed to be multiplexed on the same PRB pairs by a rate matching manner.

50. (canceled)

51. (canceled)

52. (canceled)

53. (canceled)

54. (canceled)

55. (canceled)

56. The device according to claim 46, wherein
a network side notifies a group index n_{ePHICH}^{group} and an intra-group sequence index n_{ePHICH}^{seq} corresponding to an ePHICH resource to a terminal side through a system message or a higher-layer signalling; or
the network side indicates the group index n_{ePHICH}^{group} to the ePHICH corresponding resource to the terminal side through the system message or the higher-layer signalling, and indicates the intra-group sequence index n_{ePHICH}^{seq} to the terminal side through a physical-layer signalling; or
the network side notifies the group index n_{ePHICH}^{group} and the intra-group sequence index n_{ePHICH}^{seq} to the terminal side through the physical-layer signalling; or
the network side configures values of multiple sets of group index group and intra-group sequence index n_{ePHICH}^{seq} to the terminal side through the higher-layer signalling, and notifies one or more preset sets to the terminal side for ePHICH transmission through the physical-layer signalling; or
a network side determines values of a group index n_{ePHICH}^{group} and an intra-group sequence index n_{ePHICH}^{seq} of an ePHICH resource according to one or more of parameters as follows: a lowest PRB index of a Physical Uplink Shared Channel (PUSCH) responded by the ePHICH, a DRMS domain value in uplink authorization information of a Physical Downlink Control Channel (PDCCH) corresponding to the PUSCH responded by the ePHICH and a sub-frame where the PUSCH responded by the ePHICH is located.

57. (canceled)

58. The device according to claim 47, wherein
the third dividing component, the sixth dividing component, the eighth dividing component, the eleventh dividing component, the thirteenth dividing component, the sixteenth dividing component, the eighteenth dividing component and the twenty-first dividing component are configured to divide all the ePHICH REGs of the PRB pairs for sending the ePHICH into the N_{ePHICH}^{group} groups of ePHICH REs by one of:
taking each ePHICH REG as one group of ePHICH REs;
grouping every Ny REGs at preset positions in each ePHICH PRB pair in all the ePHICH REGs into one group of ePHICH REs; and
grouping every Ny REGs belonging to multiple ePHICH PRB pairs at preset positions in all the ePHICH REGs into one group of ePHICH Res; or
a value of Np is 16 or an integral multiple of 16, and a value of Nx is 2 or 4;
a value of N and a selection of the N REs are preset by a network side and a terminal side, or are determined according to at least one of parameters as follows: a sub-frame type, a CP length, the number of Common Reference Signal (CRS) ports and the number of PDCCH symbols.

59. (canceled)

60. (canceled)

61. A device for receiving an enhanced Physical Hybrid Automatic Repeat Request (ARQ) Indicator Channel (ePHICH), comprising:
a first receiving component, configured to receive resource indication information, configured by a network side, of Physical Resource Block (PRB) pairs for sending the ePHICH, wherein a part or all of Resource Elements (RE) of the PRB pairs for sending the ePHICH are divided into N_{ePHICH}^{group} groups of ePHICH REs, each group of ePHICH REs in the N_{ePHICH}^{group} groups of ePHICH REs comprises N_{ePHICH}^{seq} resources, and both N_{ePHICH}^{group} and N_{ePHICH}^{seq} are positive integers more than or equal to 1;
a second receiving component, configured to receive group indexes and intra-group indexes, configured by the network side, of the ePHICH resources; or receive information for determining the group indexes and the intra-group indexes of the ePHICH resources;
a ninth determining component, configured to determine, according to the group indexes and the intra-group indexes, the ePHICH resources for sending the ePHICH on resources indicated by the resource indication information; and
a third receiving component, configured to receive the ePHICH on the ePHICH resources.

62. The device according to claim 61, wherein the ninth determining component comprises:
a twenty-second dividing component, configured to divide a part or all of the REs of the PRB pairs for sending the ePHICH into the N_{ePHICH}^{group} groups of ePHICH REs according to the resource indication information;
a tenth determining component, configured to determine, according to the resource indication information, that each group of ePHICH REs in the N_{ePHICH}^{group} groups of ePHICH REs comprises N_{ePHICH}^{seq} resources; and
an eleventh determining component, configured to determine the ePHICH resources for sending the ePHICH on the N_{ePHICH}^{group} groups of ePHICH REs according to the group indexes and the intra-group indexes.

63. The device according to claim 62, wherein the twenty-second dividing component comprises one of component combinations as follows:
a first component combination: a twenty-third dividing component, configured to divide a part or all of RE resources, except RE resources occupied by Demodulation Reference Signals (DMRS), in each PRB pair in the PRB pairs for sending the ePHICH into Np first enhanced Resource Element Groups (eREG) respectively; a twelfth determining component, configured to determine an ePHICH Resource Element Group (REG) in each PRB pair respectively, wherein the ePHICH REG comprises Nx time-domain adjacent or frequency-domain adjacent first eREGs; a twenty-fourth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1;
a second component combination: a twenty-fifth dividing component, configured to divide a part or all of RE resources, except RE resources occupied by DMRS, in each PRB pair in the PRB pairs for sending the ePHICH into Np second eREGs respectively; a twenty-sixth dividing component, configured to divide each PRB pair in the PRB pairs for sending the ePHICH into multiple REG areas respectively, wherein each REG area in the multiple REG areas comprises one or more subcarriers on the frequency domain, and comprises one or more Orthogonal Frequency Division Multiplexing (OFDM) symbols on the time domain; a thirteenth determining component, configured to determine an ePHICH REG of each REG area in the multiple REG areas respectively, wherein the ePHICH REG comprises Nx time-domain adjacent or frequency-domain adjacent second eREGs; a twenty-seventh dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, Np is an integer more than 1, and Nx is an integer more than or equal to 1;
a third component combination: a twenty-eighth dividing component, configured to divide a part or all of RE resources, except RE resources occupied by DMRS, in each PRB pair in the PRB pairs for sending the ePHICH into Np third eREGs respectively, wherein each eREG in the Np third eREGs comprises Nr REs, and N REs in each eREG are configured for ePHICH transmission; a fourteenth determining component, configured to determine an ePHICH REG in each PRB pair respectively, wherein the ePHICH REG comprises Nx time-domain adjacent or frequency-domain adjacent third eREGs; a twenty-ninth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1;
a fourth component combination: a thirtieth dividing component, configured to divide a part or all of RE resources, except RE resources occupied by DMRS, in each PRB pair in the PRB pairs for sending the ePHICH into Np fourth eREGs respectively, wherein each eREG in the Np fourth eREGs comprises Nr REs, and N REs in each eREG are configured for ePHICH transmission; a thirty-first dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a fifteenth determining component, configured to determine an ePHICH REG of each REG area in the multiple REG areas respectively, wherein the ePHICH REG comprises Nx time-domain adjacent or frequency-domain adjacent fourth eREGs; a thirty-second dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, N is less than or equal to Nr, all of Np, Nr and N are integers more than 1, and Nx is an integer more than or equal to 1;
a fifth component combination: a thirty-third dividing component, configured to divide a part or all of RE resources, except RE resources occupied by DMRS, in each PRB pair in the PRB pairs for sending the ePHICH into Np fifth eREGs respectively, wherein M eREGs in the Np fifth eREGs are configured for ePHICH transmission; a sixteenth determining component, configured to determine an ePHICH REG in each PRB pair respectively, wherein the ePHICH REG comprises Nx time-domain adjacent or frequency-domain adjacent fifth eREGs; a thirty-fourth dividing component, configured to divide all ePHICH REGs of the PRB pairs for sending the ePHICH into the ePHICH groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1;
a sixth component combination: a thirty-fifth dividing component, configured to divide a part or all of RE resources, except RE resources occupied by DMRS, in each PRB pair in the PRB pairs for sending the ePHICH into Np sixth eREGs respectively, wherein M eREGs in the Np sixth eREGs are configured for ePHICH transmission; a thirty-sixth dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a seventeenth determining component, configured to determine an ePHICH REG of each REG area in the multiple REG areas respectively, wherein the ePHICH REG comprises Nx time-domain adjacent or frequency-domain adjacent sixth eREGs; a thirty-seventh dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, both M and Np are integers more than 1, and Nx is an integer more than or equal to 1;
a seventh component combination: a thirty-eighth dividing component, configured to divide a part or all of RE resources, except RE resources occupied by DMRS, in each PRB pair in the PRB pairs for sending the ePHICH into Np seventh eREGs respectively, wherein M eREGs in the Np seventh eREGs are configured for ePHICH transmission, N REs comprised in each eREG in the M eREGs are configured for ePHICH transmission, and each eREG in the M eREGs comprises Nr REs; an eighteenth determining component, configured to determine an ePHICH REG in each PRB pair respectively, wherein the ePHICH REG comprises Nx time-domain adjacent or frequency-domain adjacent seventh eREGs; a thirty-ninth dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1;
an eighth component combination: a fortieth dividing component, configured to divide a part or all of RE resources, except RE resources occupied by DMRS, in each PRB pair in the PRB pairs for sending the ePHICH into Np eighth eREGs respectively, wherein M eREGs in the Np eighth eREGs are configured for ePHICH transmission, N REs comprised in each eREG in the M eREGs are configured for ePHICH transmission, and each eREG in the M eREGs comprises Nr REs; a forty-first dividing component, configured to divide each PRB pair in the PRB pairs for sending the ePHICH into multiple REG areas respectively, wherein each REG area in the multiple REG areas comprises one or more subcarriers on the frequency domain, and comprises one or more OFDM symbols on the time domain; a nineteenth determining component, configured to determine an ePHICH REG of each REG area in the multiple REG areas respectively, wherein the ePHICH REG comprises Nx time-domain adjacent or frequency-domain adjacent eighth eREGs; and a forty-second dividing component, configured to divide all ePHICH REGs of the PRB pairs for sending the ePHICH into the N_{ePHICH}^{group} groups of ePHICH REs, wherein each group of ePHICH REs in the N_{ePHICH}^{group} groups of ePHICH REs comprises one or more ePHICH REGs, M is less than Np, N is less than Nr, all of M, Np, N and Nr are integers more than 1, and Nx is an integer more than or equal to 1.

64. The device according to claim 61, wherein
N_{ePHICH}^{group} is acquired in one of manners as follows:
N_{ePHICH}^{group} is preset by the network side and a terminal side;
N_{ePHICH}^{group} is notified to the terminal side by the network side through higher-layer signalling; and
N_{ePHICH}^{group} is determined through at least one of parameters as follows: a cell Identity (ID), the number of PRBs configured to the ePHICH, a sub-frame type, a sub-frame number and a Cyclic Prefix (CP) length; or
the N_{ePHICH}^{seq} is preset by a network side and a terminal side, an index value corresponding to each ePHICH resource in the N_{ePHICH}^{seq} resources is n_{ePHICH}^{seq}, and n_{ePHICH}^{seq} ε[0, N_{ePHICH}^{seq}−1];
the N_{ePHICH}^{seq} resources are multiplexed on one group of ePHICH REs through N_{ePHICH}^{seq} different orthogonal sequences, wherein an index of an orthogonal sequence is n_{ePHICH}^{seq}, and n_{ePHICH}^{seq} ε[0, N_{ePHICH}^{seq}−1], wherein the orthogonal sequences comprise orthogonal mask sequences.

65. The device according to claim 61, wherein
resource configuration information of the PRB pairs for sending the ePHICH is notified to a terminal side through higher-layer signalling or physical-layer signalling; or the resource configuration information of the PRB pairs for sending the ePHICH is preset on a network side and a terminal side, wherein the resource configuration information comprises sub-frame resource information on the time domain and/or PRB indexes on the frequency domain; or
the PRB pairs for sending the ePHICH comprise: a part or all of resources in PRB pairs configured for sending the ePHICH or for enhanced Physical Downlink Control Channel (ePDCCH) blind detection; or
on the PRB pairs for sending the ePHICH, a Physical Downlink Shared Channel (PDSCH)/ePDCCH and the ePHICH are allowed to be multiplexed on the same PRB pairs by a rate matching manner.

66. (canceled)

67. (canceled)

68. (canceled)

69. (canceled)

70. (canceled)

71. (canceled)

72. The device according to claim 61, wherein
a network side notifies a group index n_{ePHICH}^{group} and an intra-group sequence index n_{ePHICH}^{seq} corresponding to an ePHICH resource to a terminal side through a system message or a higher-layer signalling; or
the network side indicates the group index n_{ePHICH}^{group} corresponding to the ePHICH resource to the terminal side through the system message or the higher-layer signalling, and indicates the intra-group sequence index n_{ePHICH}^{seq} to the terminal side through a physical-layer signalling; or
the network side notifies the group index n_{ePHICH}^{group} and the intra-group sequence index n_{ePHICH}^{seq} to the terminal side through the physical-layer signalling; or
the network side configures values of multiple sets of group index n_{ePHICH}^{group} and intra-group sequence index n_{ePHICH}^{seq} to the terminal side through the higher-layer signalling, and notifies one or more preset sets to the terminal side for ePHICH transmission through the physical-layer signalling; or
a network side determines the values of a group index n_{ePHICH}^{group} and an intra-group sequence index n_{ePHICH}^{seq} of an ePHICH resource according to one or more of parameters as follows: a lowest PRB index of a Physical Uplink Shared Channel (PUSCH) responded by the ePHICH, a DRMS domain value in uplink authorization information of a Physical Downlink Control Channel (PDCCH) corresponding to the PUSCH responded by the ePHICH and a sub-frame where the PUSCH responded by the ePHICH is located.

73. (canceled)

74. The device according to claim 62, wherein
the twenty-fourth dividing component, the twenty-seventh dividing component, the twenty-ninth dividing component, the thirty-second dividing component, the thirty-fourth dividing component, the thirty-seventh dividing component, the thirty-ninth dividing component and the forty-second dividing component are configured to divide all the ePHICH REGs of the PRB pairs for sending the ePHICH into the N_{ePHICH}^{group} groups of ePHICH REs according to the resource indication information by one of:
taking each ePHICH REG as one group of ePHICH REs; grouping every Ny REGs at preset positions in each ePHICH PRB pair in all the ePHICH REGs into one group of ePHICH REs; and
grouping every Ny REGs belonging to multiple ePHICH PRB pairs at preset positions in all the ePHICH REGs into one group of ePHICH REs; or
Np is 16 or an integral multiple of 16, and Nx is 2 or 4; or
a value of N and a selection of the N REs are preset by a network side and a terminal side, or are determined according to at least one of parameters as follows: a sub-frame type, a CP length, the number of Common Reference Signal (CRS) ports and the number of PDCCH symbols.

75. (canceled)

76. (canceled)
